(19) United States
(12) Patent Application Publication
(10) Pub. No.: US 2017/0193017 A1
(43) Pub. Date: Jul. 6, 2017

(54) Common Data Service Providing Semantic Interoperability for IOT-Centric Commerce

(71) Applicant: Douglas T. Migliori, Newport Coast, CA (US)

(72) Inventor: Douglas T. Migliori, Newport Coast, CA (US)

(21) Appl. No.: 15/466,572

(22) Filed: Mar. 22, 2017

Related U.S. Application Data
(63) Continuation-in-part of application No. 15/290,964, filed on Oct. 11, 2016.
Application No. 15/290,964 is a continuation of application No. 14/685,545, filed on Apr. 13, 2015, now Pat. No. 9,495,401.
(60) Provisional application No. 61/978,440, filed on Apr. 11, 2014.
(60) Provisional application No. 62/008,311, filed on Jun. 5, 2014.
(60) Provisional application No. 62/130,330, filed on Mar. 9, 2015.

(51) Int. Cl. G06F 17/30

(52) U.S. Cl. CPC G06F 17/30303; G06F 17/30607; G06F 17/30336; G06F 17/30445; G06F 17/30345

(57) ABSTRACT

Unified management, automation and interoperability of business and machine processes utilizing components of a common data service on any machine and/or across difference machines. In an embodiment, a first agent on a first machine accesses a first message payload which may represent a two-dimensional structure. Each request in the message payload comprises one of a plurality of request types, an identification of a machine, a statement, an identification of a resource to process the statement, and authentication credentials. Each row in the message payload is processed according to the elements in the row. When the identified machine is the first machine, the resource identified in the row is invoked to execute the statement. When the identified machine is not the first machine, the row is sent within a second message payload to the agent of the identified machine for processing.

### CROSS-REFERENCE TO RELATED APPLICATIONS

This application is a continuation-in-part of U.S. patent application Ser. No. 15/290,964, filed on Oct. 11, 2016, which is a continuation of U.S. patent application Ser. No. 14/685,545, filed on Apr. 13, 2015 and issued as U.S. Pat. No. 9,495,401 on Nov. 15, 2016, which claims priority to U.S. Provisional Patent App. Nos. 61/978,440, filed on Apr. 11, 2014, 62/008,311, filed on Jun. 5, 2014, and 62/130,330, filed on Mar. 9, 2015, the entireties of all of which are hereby incorporated herein by reference.

This application is related to U.S. patent application Ser. No. 15/091,488, filed on Apr. 5, 2016, which is a continuation of U.S. patent application Ser. No. 13/830,249, filed on Mar. 14, 2013 and issued as U.S. Pat. No. 9,336,013 on May 10, 2016, which claims priority to U.S. Provisional Patent App. Nos. 61/762,779, filed on Feb. 8, 2013, and 61/783,362, filed on Mar. 14, 2013, the entireties of all of which are hereby incorporated herein by reference.

### BACKGROUND

Field of the Invention

The embodiments described herein are generally directed to unified management, automation and interoperability of business and machine processes, utilizing a common data service on any machine and/or across different machines.

Description of the Related Art

Conventionally, data-centric software applications and application platforms have incorporated one or more software architecture patterns and programming paradigms, including service-oriented, client-server, peer-to-peer, event-driven, and object-oriented architectures, and object-oriented programming, object-relational mapping, and entity-relationship modeling.

Conventionally, machine to machine and human to machine communications are managed through one or more communication protocols (e.g., MQTT, XMPP, DDS, AMQP, CoAP, RESTful HTTP).

None of the existing software architecture patterns or communication protocols have abstraction layers capable of effectively supporting the semantic interoperability requirements of the Internet of Things and Unified Commerce. This leads to fragmented systems with complex and costly integrations between disparate systems.

It would be beneficial to have an architectural pattern and data exchange protocol that eliminates fragmentation and provides normalized layers of abstraction that supports universal, semantic interoperability among machines using a common data service, and enables unified management of machines and business processes related to commerce.

### SUMMARY

Accordingly, systems and methods are disclosed for unified management, automation and interoperability of business and machine processes utilizing a common data service on any machine and/or across different machines, aspects of which include, in at least one or more embodiment:

1) Creating, updating, and deleting digital representations of objects while processing an events dataset;

2) Defining digital representations of objects and the relationships between objects as events within an events dataset;

3) Retrieving a current state of digital representations of objects while processing a queries dataset;

4) Retrieving attribute values representing a current state of a digital representation of an object while processing a queries dataset, wherein one of the retrieved attribute values comprises a second queries dataset that can be processed to retrieve a current state of digital representations of objects.

5) Displaying or printing a formatted view of digital representations of objects while processing a view dataset;

6) Transporting a plurality of semantically interoperable events datasets, queries datasets, and/or view datasets among peer machines and among resources within a machine;

7) Generating an events dataset, queries dataset, and/or view dataset while processing an application, wherein the application comprises digital representations of objects retrieved while processing a queries dataset;

8) Creating, updating, and deleting digital representations of automation triggers while processing an events dataset, wherein processing an events dataset can trigger the automation defined in the automation triggers;

9) Creating, retrieving, updating, deleting, and transporting semantically interoperable digital representations of attributes of digital representations of objects;

10) Creating, retrieving, updating, deleting, and transporting semantically interoperable digital representations of a plurality of alternate identifiers of a digital representation of an object;

11) Creating, retrieving, updating, deleting, and transporting semantically interoperable digital representations of: businesses and persons; trade relationships between businesses and persons; trade items; trade locations; transactions involving trade relationships, trade items, and trade locations; and automation triggers that automate this trade exchange process; and

12) Creating, retrieving, updating, deleting, and transporting semantically interoperable digital representations of: machines as types of trade items; relationships between machines, businesses, and persons; and automation triggers that automate processes within a machine and among related machines.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The details of the present invention, both as to its structure and operation, may be gleaned in part by study of the accompanying drawings. In such drawings:

FIG. 1 illustrates a plurality of machines utilizing components of a common data service (i.e., message payload format, agent, session manager, object event processor, object query processor, rendered view generator, and portable application runtime), and interacting with other resources and data stores, including structured data stores, according to at least one embodiment;

FIG. 2 illustrates examples of request and response payloads based on the message payload format, according to at least one embodiment;

FIG. 3 illustrates a machine utilizing components of a common data service, and interacting with other resources and data stores, including structured data stores, according to at least one embodiment;

FIG. 4 illustrates different embodiments of datasets within data stores, including structured data stores, on a plurality of machines;

FIG. 5 illustrates a processing system on which one or more of the processes described herein may be executed, according to at least one embodiment;

FIGS. 6-41 illustrate different embodiments of related objects within subsets of datasets within structured data stores;

FIG. 42 illustrates an example of a query result sets generated by an object query processor, according to at least one embodiment;

FIGS. 43-44 illustrate an example of a rendered view generated by a rendered view generator, according to at least one embodiment; and

FIG. 45 illustrates different embodiments of datasets within structured data stores.

The above described drawing figures illustrate aspects of the invention in at least one of its exemplary embodiments, which are further defined in detail in the following description.

Features, elements, and aspects of the invention that are referenced by the same numerals in different figures represent the same, equivalent, or similar features, elements, or aspects, in accordance with one or more embodiments. Furthermore,

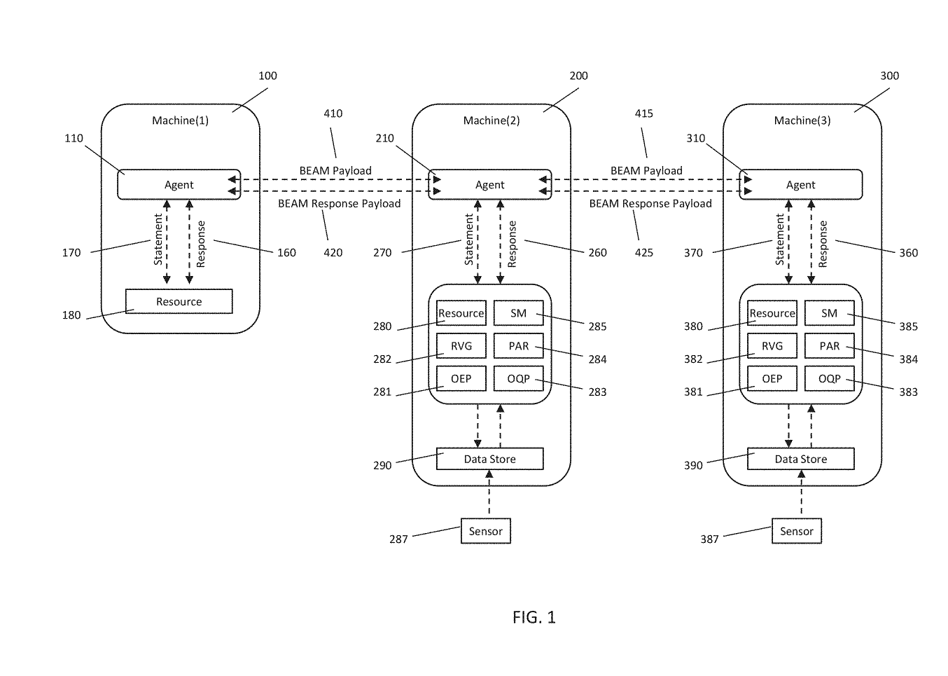

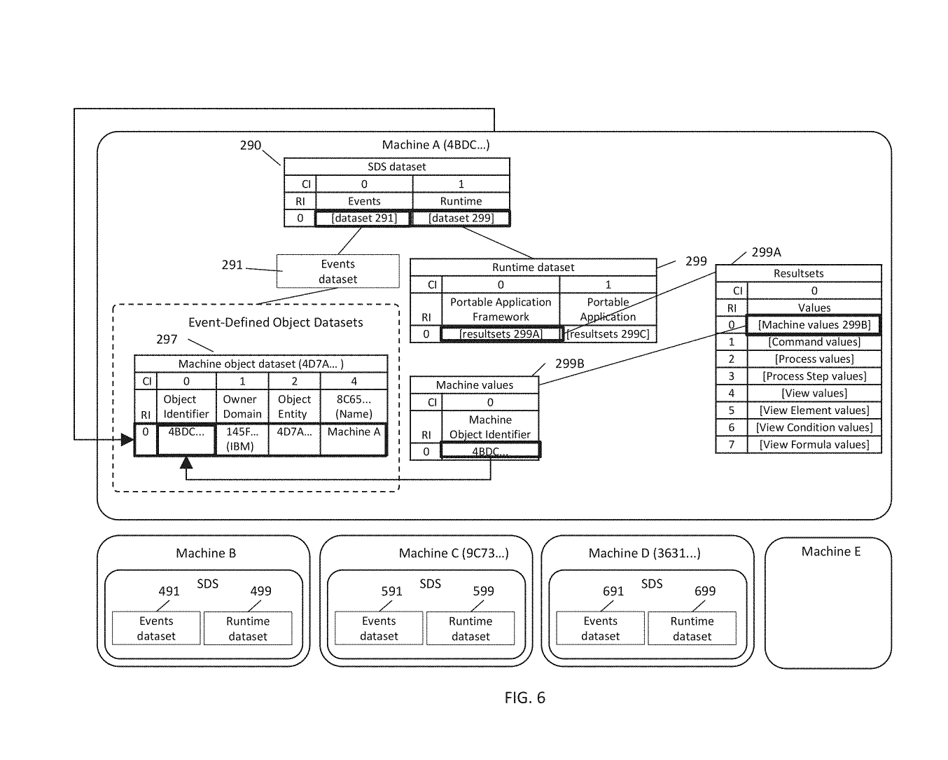

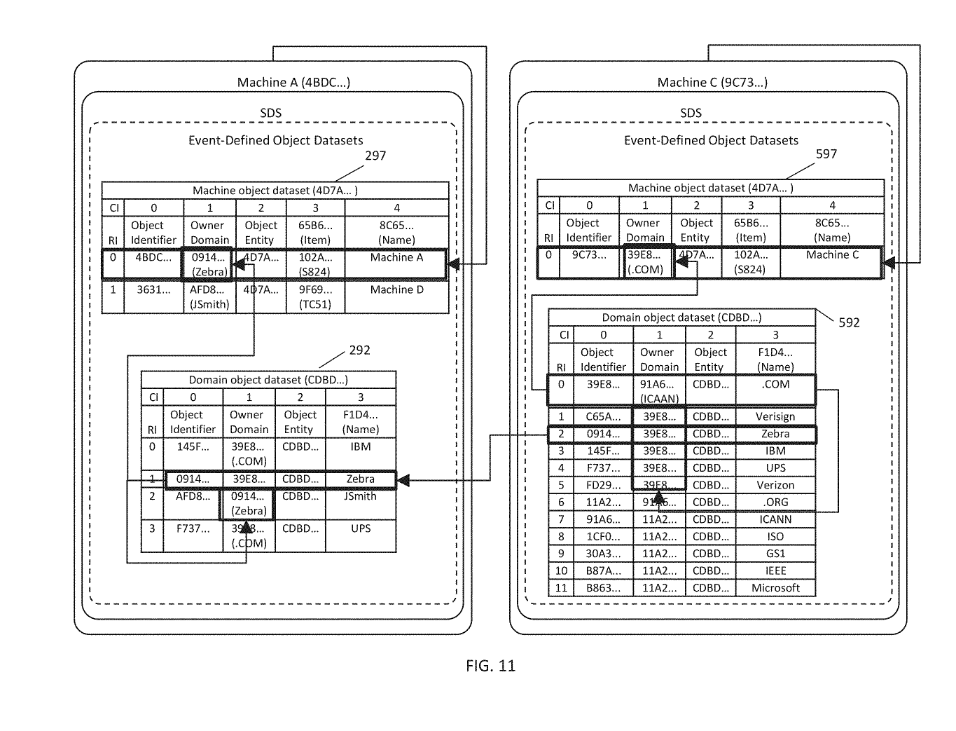

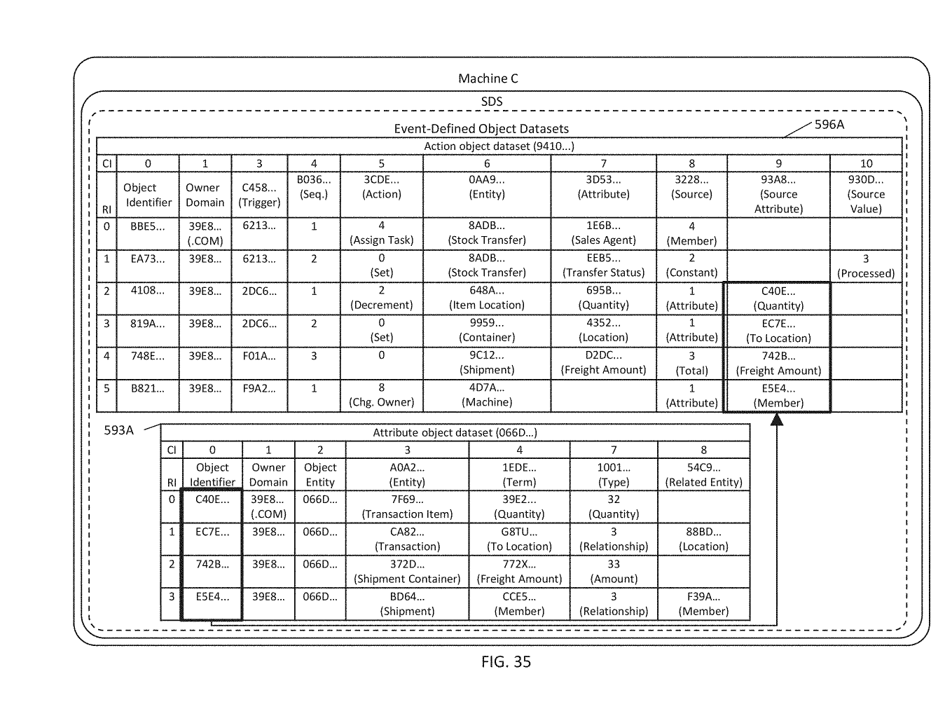

FIGS. 1-45 incorporate a numbering scheme, wherein a numeral identifies an element being illustrated (e.g., “281” in OEP 281 in FIG. 1), and wherein the first digit of the identifying numeral (e.g., “2”) represents a particular machine (e.g., “Machine (2)”). In FIGS. 6-45, the first digit of an identifying numeral for an element comprises one of “2”, “4”, “5”, “6” or “7” which correspond to Machine A, Machine B, Machine C, Machine D, or Machine E, respectively, that contains the identified element. For example, as illustrated in FIG. 11, Domain object dataset 292 is contained in Machine A and Domain object dataset 592 is contained in Machine C. Both Domain object datasets comprise the same structure, but the data content within each structure may vary in at least one embodiment. A purpose of these figures is to simply illustrate how certain data within datasets can be synchronized among machines by transporting and processing data in at least one embodiment. The columns and/or rows within an illustrated dataset may represent only a subset of all the data within the dataset on a machine in at least one embodiment.

### DETAILED DESCRIPTION

A message payload format (BEAM), session manager (SM), object event processor (OEP), object query processor (OQP), rendered view generator (RVG), portable application runtime (PAR), and structured data store (SDS) are disclosed in various embodiments.

### 1. Glossary

For purposes of understanding the present disclosure, the following terms should be understood to include at least the following, illustrative, non-exhaustive definitions:

“Abstraction Layer”: A way of hiding the implementation details of a particular set of functionality, allowing the separation of concerns to facilitate interoperability and platform independence. Software models that use layers of abstraction include the OSI 7-layer model for computer network protocols.

“Agent”: A hardware or software component or module that acts for a user or program in an agency relationship. Examples of agents include, without limitation, a data and/or web service, a central processing unit (CPU), microprocessor, operating system (OS), native application, web browser window, etc.

“Aggregate Object”: A cluster of associated objects, including a parent object and one or more child objects, that are treated as a unit for the purpose of data changes. An example of an aggregate object is a purchase order object with one or more line item objects related to the purchase order object.

“Application”: A set of instructions that applies the power of a particular Application Framework to a particular purpose. Examples of applications include, without limitation, machine control, business and/or accounting software, etc.

“Application Framework”: A set of instructions that form a software framework to implement the standard structure of an Application. A framework can include standard user interface elements and a rendering format. A framework manages and integrates a machine's capabilities, but typically does not directly apply in the performance of tasks that benefit the user or machine. An example of an Application Framework includes, without limitation, the Microsoft .NET Framework.

“Attribute”: A data characteristic of an entity. Every entity has a minimal set of uniquely identifying attributes, including a unique identifier.

“Attribute Value”: The value of an attribute of an object.

“Authentication”: The verification of the credentials of a connection attempt. This process consists of, in at least one embodiment, sending the credentials from one machine to another machine in an either plaintext or encrypted form by using an authentication protocol.

“Communication Protocol”: A system of digital message formats and rules for exchanging messages in or between computing systems (e.g., in telecommunications). Protocols may include signaling, authentication, error detection capabilities, and/or correction capabilities. Each message has an exact meaning intended to provoke a defined response by the receiver. The nature of the communication, the actual data exchanged, and any state-dependent behaviors are defined by a technical specification or communication protocol standard. Examples of conventional communication protocols include, without limitation, HTTP, HTTP Secure (HTTPS), Simple Mail Transfer Protocol (SMTP), Constrained Application Protocol (CoAP), etc.

“Data Store”: A repository for persistently storing and managing collections of data. A data store is a general concept that includes not just repositories like databases, but also simpler store types, such as datasets, flat files, firmware, or port pin collections of a microcontroller.

“Dataset”: A collection of data represented in tabular form. Each column in a dataset may represent a particular variable. Each row in a dataset may correspond to a given member of the dataset in question. A dataset may comprise data for one or more members, corresponding to the number of rows. Example embodiments of a dataset include a table within a database, a file within a file system, a two-dimensional array serialized within a string, and a port pin collection within a microcontroller.

“Dataset Element”: Any value in a dataset. A dataset element can be referenced by a combination of its column position (“column index” or “CI”) and row position (“row index” or “RI”) within the dataset. Elements within a dataset may be referenced using [x][y] notation, where [x] is the row index and [y] is the column index. A dataset element can represent an attribute value of an object. Examples of a dataset element include a field within a database table, an address within a file, an element within a two-dimensional array, and a port pin within a microcontroller.

“Derived Object”: An object of an entity derived from attribute values of an originating object of a different entity but owned by the same domain.

“Domain”: A realm of administrative autonomy, authority, or control within a network. A domain can represent an addressable location on a network or a tenant within a multi-tenancy software architecture.

“Duplicated Object”: An object of an entity derived from attribute values of an originating object of the same entity and owned by the same domain.

“Entity”: A category of like things or objects which are each recognized as being capable of an independent existence and which can be uniquely identified. Non-limiting examples of an entity include physical objects such as houses or cars, events such as house sales or car services, concepts such as customer transactions or orders, personal information such as contacts, messages, events, and tasks, and object schema including entities, reflectively.

“Event-defined Object Dataset”: A dataset of objects that can be compiled from a dataset of object events.

“MAC Address”: A machine address that uniquely identifies a node of a network. It is assigned by the machine's manufacturer and saved to the machine's memory. The first bytes of a MAC Address are known as the Organizationally Unique Identifier (OUI) and represents the machine's manufacturer.

“Machine”: An electronic device capable of performing one or more computing processes, receiving data from one or more other electronic devices (e.g., other machines), and/or sending data to one or more other electronic devices (e.g., other machines). Examples of machines include, without limitation, a server, personal computer (PC), laptop computer, tablet, a media system, an entertainment system, a control system (e.g., an in-vehicle media, entertainment, and/or controls system), smart phone, appliance, mechanical controller, thermostat, etc.

“Metadata”: There are two types of metadata. “Structural metadata” is data about the design and specification of data structures. Structural metadata cannot be data about data, since at design time, the application contains no data. Rather, structural metadata is data about the containers of data. “Descriptive metadata” is data about data content. This data content is the individual instances of application data.

“Mirrored Object”: An object of an entity derived from attribute values of an originating object of an entity with similar characteristics but owned by a different domain.

“Nested Dataset”: A dataset stored or referenced as a dataset element within another dataset. Nested datasets are one-to-many relationships embodied in a single parent dataset memory store.

“Normalization”: The process of reducing data and metadata to a canonical form to facilitate interoperability. For instance, dataset normalization is the process of organizing datasets and dataset elements within a data store to minimize redundancy and dependency.

“Object”: A data representation of a unique instance of an entity. Data characteristics (“attribute values”) of an object can be stored as dataset elements within a row of a dataset.

“Object Dataset”: A structured dataset that includes a column representing a unique object identifier and one or more rows that each represent an object. An object dataset can be defined from Object Events.

“Object Event”: A change in the state of an object, including, for a new object, the change from no state into an initial state. For example, when a consumer purchases a car, the car's state changes from “for sale” to “sold”.

“Object Event Notification”: A type of message (typically asynchronous) that is produced, published, propagated, detected, or consumed, and contains one or more object events. For example, a car dealer's automated system may notify another system of a car object's state change from “for sale” to “sold”.

“Object Identifier”: An identifier mechanism for naming any object with a globally unambiguous persistent name (e.g., a UUID).

“Object Query”: An encapsulated description of the characteristics of related objects used to retrieve a query resultset. Examples include a SQL script and a Queries dataset.

“Originating Object”: The object that originates the attribute values of a derived object, duplicated object, or mirrored object.

“Query Resultset”: One or more datasets generated in response to an object query that includes one or more attribute values from one or more object datasets.

“Rendered View”: An encapsulated description of a fixed-layout flat document, including the text, fonts, graphics, and other information needed to display or print it. Examples include a Portable Document Format (PDF) file and View dataset.

“Remote Agent”: An agent on a remote machine that can be invoked directly by an agent on another machine. For example, two or more machines may be separated by one or more networks, such as the Internet, rendering each of the machines remote from the other. An example of a remote agent includes, without limitation, a web service.

“Request”: A message sent to a resource or remote agent via a communication protocol that is intended to elicit a responding message. An example of a request includes, without limitation, a Hypertext Transfer Protocol (HTTP) request.

“Resource”: A computer program that processes statements written in a high-level scripting language or a lower-level machine language to change the machine's state and/or retrieve data, render display content, etc. Examples of resources include, without limitation, a database engine, microservice, display driver, voice driver, printer driver, actuator driver, device driver, and an agent for a component machine.

“Response”: A message returned from a resource or remote agent via a communication protocol in response to a request (e.g., after processing the request). Examples of responses include, without limitation, an error message, UI event, SQL result set, etc.

“Runtime State”: The current processing state of an application runtime, including in-memory applications, state variables and rendered views.

“Scripting Language”: A programming language that supports the writing of scripts. Scripts are programs written for a software environment that automate the execution of tasks which, alternatively, could be executed one-by-one by a human operator. Environments that can be automated through scripting include, without limitation, software applications, web pages within a web browser, shells of operating systems, and several general purpose and domain-specific languages, such as those for embedded systems. Examples of scripting languages include, without limitation, Structured Query Language (SQL), HTML, Printer Control Language (PCL), eXtensible Markup Language (XML), Computer Numeric Control (CNC), etc.

“Semantic Interoperability”: Exhibited by two or more machines that are able to automatically interpret the information exchanged meaningfully and accurately in order to produce useful results as defined by the end users of the machines. Further, it represents interoperability at the highest level, which is the ability of two or more systems or elements to exchange information and to use the information that has been exchanged. Semantic interoperability takes advantage of both the structuring of the data exchange and the codification of the data including vocabulary so that the receiving information technology systems can interpret the data. This level of interoperability supports the electronic exchange of information among domains via potentially disparate systems.

“Statement”: A structured dataset or string of characters that can be executed, in their entirety, by a compatible resource to perform a computing process. Examples of computing processes which may be performed by executing a statement using a resource include, without limitation, rendering a display or user interface, manipulating and/or retrieving data, printing a document, invoking an application programming interface (API), controlling a mechanism, transmitting an XML message to a web service, changing the state of a machine or resource, etc.

“Synchronization”: The process of establishing consistency among data from a source to a target data store and vice versa and the continuous harmonization of the data over time.

“Syntactic Interoperability”: Exhibited by two or more machines that are capable of communicating with each other using specified data formats, such as XML, SQL or array of arrays.

“Triggered Action”: An action performed in response to an object event that meets a defined condition, rule, or logical test.

“UUID”: A universally unique identifier (UUID) is a unique reference number generated by an algorithm that is used as an identifier in computer software. Non-limiting examples of a UUID include alphanumerical text, a sequence of digits (e.g., decimal or hexadecimal digits), a MAC address and time, and may be stored as a 16-byte (128-bit) number. An example of a UUID is “D9A4F842-AF53-4A49-B752-CE58BE46C72D”.

### 2. Overview

The disclosed components of a common data service (i.e., message payload format, agent, session manager, object event processor, object query processor, rendered view generator, application runtime, and structured data store) facilitate unified management, automation and interoperability of business and machine processes on any machine and/or across different machines. Such machines may range, for example, from a sensor and actuator (e.g., home thermostat) to a computer (e.g., smart phone), and so on. The disclosed embodiments also facilitate the transport of portable applications, runtime state, data, events, queries and views on one machine (e.g., coffee maker) to another machine (e.g., smart phone) via a novel message payload format for communications. The portable applications can be simple (e.g., an on/off switch) or complex (e.g., robotics or business solutions (e.g., enterprise resource planning (ERP), customer relationship management (CRM), etc.)).

For example, the disclosed components of a common data service can facilitate codeless, rapid development and on-demand delivery of data-centric applications on end-user devices, such as smart phones, tablets, PCs, and in-vehicle navigation systems. The data-centric application may be a control panel, web site, business solution, etc.

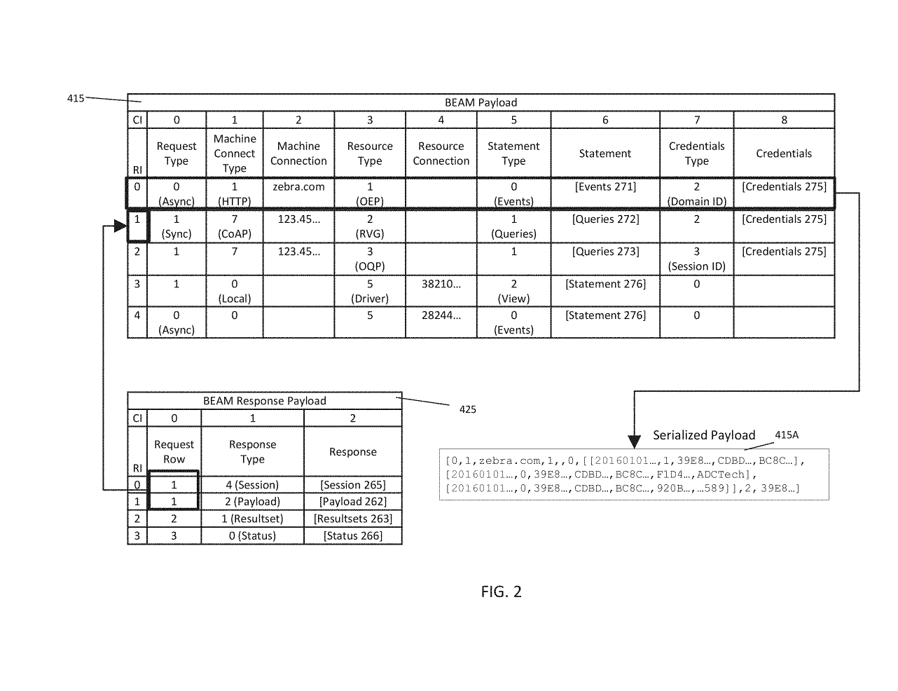

FIG. 2 illustrates the architecture of a message payload format, according to an embodiment.

In an embodiment, the message payload format is an abstraction layer of a communication protocol that defines the data schema (“BEAM Payload”) for sending one or more types of request, and the data schema (“BEAM Response Payload”) for receiving one or more types of response from one machine to another, and/or from one resource to another on a machine.

In an embodiment, each of the one or more rows in the BEAM Payload comprises a request type, an identification of a machine, a statement, an identification of a resource to process the statement, and authentication credentials. In at least one such embodiment, an identification of a machine can comprise a machine connection type and machine connection string. In at least one such embodiment, an identification of a resource can comprise a resource type and resource connection string. In at least one such embodiment, a statement in a row can comprise a statement type and a statement string. In at least one such embodiment, authentication credentials in a row can comprise a credentials type and a credentials string.

In an embodiment, while processing a single statement within a BEAM Payload may only perform a portion of creating, reading, updating, and deleting object datasets within a structured data store (e.g., reading), the combined processing of all statements, within the dataset schema of the BEAM Payload, perform all aspects of creating, reading, updating, and deleting object datasets within a structured data store.

In an embodiment, interoperable data exchange and synchronization among machines is facilitated by processing statements within a plurality of BEAM Payloads transported among machines. FIG. 11 illustrates how the attribute values of an object within an object dataset stored in a first machine (e.g., R [1] within Domain object dataset 292 in Machine A) is synchronized with an object within an object dataset of similar structure stored within a second machine (e.g., R [2] within Domain object dataset 592 in Machine C).

In an embodiment, each of the one or more rows in the BEAM Response Payload comprises an identification of a requesting row in a BEAM Payload, a response type and a response string.

In an embodiment, the message payload format defines the data schema (“Events”) for sending one or more object events as a statement within a BEAM Payload to be processed by a type of resource (i.e., an object event processor) and stored within a structured data store.

In an embodiment, the message payload format defines the data schema (“Queries”) for sending one or more object queries as a statement within a BEAM Payload, to be processed by a type of resource (i.e., an object query processor or a rendered view generator).

In an embodiment, the message payload format defines the data schema (“View”) for sending a rendered view as a statement within a BEAM Payload to be processed by a type of resource (e.g., a printer or display driver).

In an embodiment, the message payload format defines the data schema (“Credentials”) for sending user authentication credentials within a BEAM Payload to be processed by a type of resource (i.e., a session manager).

FIG. 1 illustrates the relationships between a common data service on a plurality of machines with at least some of the machines containing an agent, session manager, object event processor, object query processor, rendered view generator, portable application runtime and structured data store, according to an embodiment. It should be understood that not all of these machines may comprise all of these components, depending on the particular implementation and/or scenario.

The object event processor (e.g., OEP 281) is a type of resource that processes instances of Events. The object event processor can reside on multiple machines (e.g., OEP 281 on machine 200 and OEP 381 on machine 300) and be a resource available to an agent specific to each machine (e.g., agent 210 on machine 200 and agent 310 on machine 300). The object event processor may also be a resource available to a session manager specific to each machine (e.g., SM 285 on machine 200 and SM 385 on machine 300).

The rendered view generator (e.g., RVG 282) is a type of resource that generates rendered views from instances of Queries. The rendered view generator can reside on multiple machines (e.g., RVG 282 on machine 200 and RVG 382 on machine 300) and be a resource available to an agent specific to each machine (e.g., agent 210 on machine 200 and agent 310 on machine 300). The rendered view generator may also be a resource available to an object event processor specific to each machine (e.g., OEP 281 on machine 200 and OEP 381 on machine 300).

The object query processor (e.g., OQP 283) is a type of resource that generates query resultsets from processing instances of Queries. The resultsets are derived from object datasets within a structured data store (e.g., SDS 290 on machine 200). The object query processor can reside on multiple machines (e.g., OQP 283 on machine 200 and OQP 383 on machine 300) and be a resource available to an agent specific to each machine (e.g., agent 210 on machine 200 and agent 310 on machine 300). The object query processor may also be a resource available to an object event processor specific to each machine (e.g., OEP 281 on machine 200 and OEP 381 on machine 300). The object query processor may also be a resource available to a rendered view generator specific to each machine (e.g., RVG 282 on machine 200 and RVG 382 on machine 300). The object query processor may also be a resource available to a session manager specific to each machine (e.g., SM 285 on machine 200 and SM 385 on machine 300).

The portable application runtime (e.g., PAR 284) is a type of resource that processes portable application frameworks and portable applications defined from query resultsets to generate events, queries, and rendered views. The portable application runtime can reside on multiple machines (e.g., PAR 284 on machine 200 and PAR 384 on machine 300) and be a resource available to an agent specific to each machine (e.g., agent 210 on machine 200 and agent 310 on machine 300). The portable application runtime may also be a resource available to an object event processor specific to each machine (e.g., OEP 281 on machine 200 and OEP 381 on machine 300).

The session manager (e.g., SM 285) is a type of resource that validates authentication credentials and generates sessions. The session manager can reside on multiple machines (e.g., SM 285 on machine 200 and SM 385 on machine 300) and be a resource available to an agent specific to each machine (e.g., agent 210 on machine 200 and agent 310 on machine 300).

In an embodiment, the structured data store (e.g., SDS 290) is a type of data store that maintains datasets within a data structure that is compatible with an object event processor, object query processor, and portable application runtime. The structured data store can reside on multiple machines (e.g., SDS 290 on machine 200 and SDS 390 on machine 300) and interact with an object event processor specific to each machine (e.g., OEP 281 on machine 200 and OEP 381 on machine 300), an object query processor specific to each machine (e.g., OQP 283 on machine 200 and OQP 383 on machine 300), and a portable application runtime specific to each machine (e.g., PAR 284 on machine 200 and PAR 384 on machine 300).

In an embodiment, a request within the BEAM Payload may identify the resource needed to process a statement. If the resource identified in the BEAM Payload is on a remote machine (e.g., machine 100), then the BEAM Payload also identifies the remote machine. For example, if agent 210 on machine 200 is processing a BEAM Payload that has a request identifying a needed resource 180 on machine 100, agent 210 may forward the BEAM Payload or a new BEAM Payload (e.g., BEAM Payload 410) to the remote agent (e.g., agent 110) for processing.

If a request in the BEAM Payload identifies a resource on the same machine as the processing agent, the processing agent (e.g., agent 210) sends the statement to the identified machine resource. For example, if agent 210 processes a request to execute a statement pertaining to identified resource 280, agent 210 may send the statement (e.g., statement 270) to resource 280. The executing resource may return a response (e.g., response 260) to the invoking agent. If the request type requires a synchronous response, the invoking agent generates a BEAM Response Payload that includes the response from the executing resource.

(1) If a request in the BEAM Payload identifies an object event processor (e.g., OEP 281) on the same machine as the agent, the agent may send the statement (e.g., events 271) within the request to the object event processor for processing. The object event processor may append the events within the statement to an events dataset within a structured data store (e.g., events dataset 291 within SDS 290). The object event processor may also create, update, or delete one or more object datasets within a structured data store (e.g., SDS 290). The object event processor may submit one or more queries (e.g., queries 256) to a rendered view generator (e.g., RVG 282) to obtain a BEAM Payload (e.g., payload 246) related to the queries. The object event processor may submit one or more queries to an object query processor (e.g., OQP 283) to obtain one or more query resultsets related to the queries. The object event processor may also generate and submit a new BEAM Payload (e.g., payload 261) to the agent.

(2) If a request in the BEAM Payload identifies a rendered view generator (e.g., RVG 282) on the same machine as the agent, the agent may send the statement (e.g., Queries 272) within the request to the rendered view generator for processing. The rendered view generator may generate and submit one or more queries (e.g., Queries 257) to an object query processor (OQP 283) to obtain one or more query resultsets (e.g., Resultsets 247) related to the queries. The rendered view generator may generate and return a new BEAM Payload (e.g., payload 262) comprising a rendered view (e.g., Rendered View 276A) as a response to the invoking agent.

(3) If a request in the BEAM Payload identifies an object query processor (e.g., OQP 283) on the same machine as the agent, the agent may send the statement (e.g., Queries 273) within the request to the object query processor for execution. The object query processor may generate one or more query resultsets (e.g., Resultsets 263) from object datasets within a structured data store (e.g., SDS 290) and return the resultsets as a response to the invoking agent.

(4) If a request in the BEAM Payload identifies a portable application runtime (e.g., PAR 284) on the same machine as the agent, the agent may send the statement within the request to the portable application runtime for processing. The portable application runtime may return a response to the invoking agent that comprises a portable application framework, a portable application, or the processing state of one or more portable applications (i.e., runtime state).

(5) If a request in the BEAM Payload identifies a session manager (e.g., SM 285), the agent may send the credentials (e.g., credentials 275) within the request to the session manager for validation. The session manager may generate and submit Queries (e.g., Queries 258) to an object query processor (e.g., OQP 283) to obtain one or more query resultsets (e.g., Resultsets 248) to determine the validity of the credentials. Based on the validity of the credentials, the session manager may generate and submit Events to an object event processor (e.g., OEP 281) to create a new session object related to the credentials (i.e. current session), and may also generate and return, as a response to the invoking agent, one or more attribute values related to the current session (e.g., session 265) or a status (e.g., status 265) representing an invalid condition of the credentials (e.g., invalid password). In at least one such embodiment, session 265 comprises the object identifier of the current session (i.e., session ID).

(6) If a request in the BEAM Payload identifies a driver, as a resource, (e.g., driver 286), the agent may send the statement (e.g., statement 276) within the request to the driver for processing. The driver may also generate and return a response (e.g., response 266) to the invoking agent. The driver may also generate and submit a new statement (e.g., statement 276) to the agent for processing. The driver may process the statement to generate a resource-compatible script in various scripting languages (e.g., HTML, XML, PCL, ZPL, SQL) which can be executed by a resource to, without limitation, render a display or user interface, print a document (e.g., shipping label), or change the state of a data store (e.g., data store 290B). In an embodiment, the statement within the request comprises a rendered view (e.g., Rendered View 276A) generated by a rendered view generator. In another embodiment, the statement within the request comprises Events generated by an object event processor.

(7) If a request in the BEAM Payload identifies an agent of a component machine within the machine of the processing agent, the processing agent may send the statement within the request to the identified agent for processing.

### 3. Example Embodiments of a BEAM Message Payload Format

3.1. Example BEAM Payload

The following description illustrates a non-limiting embodiment of a message payload format within a machine-to-machine message (BEAM Payload). The BEAM Payload includes syntactically and semantically interoperable data and metadata content that an agent (e.g., agent 210) or remote agent (e.g., agent 110 or agent 310) can interpret and process.

The BEAM Payload may comprise one or more requests, which may be sent from an agent (e.g., agent 210) to a remote agent (e.g., agent 110 or agent 310) using one of a plurality of communication protocols.

In an embodiment, the BEAM Payload is represented by a dataset that comprises the columns illustrated in FIG. 2 and Table 1:

TABLE 1

| CI | Description | Type | Default Value |
|---|---|---|---|
| 0 | Request Type | Number | 0 |
| 1 | Machine Connection Type | Number | 0 |
| 2 | Machine Connection | Text | |
| 3 | Resource Type | Number | 0 |
| 4 | Resource Connection | Text | |
| 5 | Statement Type | Number | 0 |
| 6 | Statement | Text | |
| 7 | Credentials Type | Number | 0 |
| 8 | Credentials | Text | |

Illustrative defined values for specific BEAM Payload dataset columns are illustrated in Table 2:

TABLE 2

| CI | Value | Description |
|---|---|---|
| 0 | 0 | Process Statement Asynchronously |
| 0 | 1 | Process Statement and Respond Synchronously |
| 1 | 0 | None (Local Machine) |
| 1 | 1 | HTTP |
| 1 | 2 | HTTPS |
| 1 | 3 | Web Socket |
| 1 | 4 | TCP/IP |
| 1 | 5 | MQTT |
| 1 | 6 | AMQP |
| 1 | 7 | CoAP |
| 1 | 8 | Bluetooth |
| 1 | 9 | NFC |
| 3 | 0 | Agent |
| 3 | 1 | Object Event Processor |
| 3 | 2 | Rendered View Generator |
| 3 | 3 | Object Query Processor |
| 3 | 4 | Portable Application Runtime |
| 3 | 5 | Driver (e.g., Display, Print, Database) |
| 3 | 6 | Microservice |
| 5 | 0 | Events |
| 5 | 1 | Queries |
| 5 | 2 | View |
| 5 | 3 | Payload |
| 7 | 0 | None (Pre-validated) |
| 7 | 1 | MAC Address |
| 7 | 2 | Domain ID/Password/Machine ID |
| 7 | 3 | Session ID |

In an embodiment, the value of the Statement element in a row within the BEAM Payload dataset comprises an Events dataset when the Statement Type element value (i.e., CI [5]) in the row is 0 (i.e., Events).

In an embodiment, the value of the Statement element in a row within the BEAM Payload comprises a Queries dataset when the Statement Type element value (i.e., CI [5]) in the row is 1 (i.e., Queries).

In an embodiment, the value of the Statement element in a row within the BEAM Payload comprises a View when the Statement Type element value (i.e., CI [5]) in the row is 2 (i.e., View).

In an embodiment, the value of the Statement element in a row within the BEAM Payload comprises a second BEAM Payload when the Statement Type element value (i.e., CI [5]) in the row is 3 (i.e., Payload).

In an embodiment, a BEAM Payload can be converted to a serialized array of arrays for transport from an agent to a remote agent as illustrated in serialized payload 415A in FIG. 2.

3.2. Example BEAM Response Payload

The following description illustrates a non-limiting embodiment of a message payload format within a machine-to-machine message (BEAM Response Payload) in response to one or more requests in a BEAM Payload. The BEAM Response Payload includes syntactically and semantically interoperable data and metadata content that an agent (e.g., agent 210) or remote agent (e.g., agent 110 or agent 310) can interpret and process.

The BEAM Response Payload 425 may comprise one or more responses to one or more requests in a BEAM Payload 415, which may be returned to an agent (e.g., agent 210) from a remote agent (e.g., agent 310) in response to a BEAM Payload 415. In an embodiment, this BEAM Response Payload is represented by a dataset that comprises the columns illustrated in FIG. 2 and Table 3:

TABLE 3

| CI | Description | Type | Default Value |
|---|---|---|---|
| 0 | Request Row | Number | 0 |
| 1 | Response Type | Number | 0 |
| 2 | Response | Text | |

The BEAM Response Payload dataset elements may contain a specific nested dataset. Illustrative defined values for the Response Type dataset element are illustrated in Table 4:

TABLE 4

| CI | Value | Description |
|---|---|---|
| 0 | 0 | Status |
| 0 | 1 | Resultsets |
| 0 | 2 | Payload |
| 0 | 4 | Session |
| 0 | 5 | Runtime State |

In an embodiment, the value of the Request Row element (i.e., CI [0]) in a row in the BEAM Response Payload 425 will contain a row index representing a row in a BEAM Payload that invoked a resource to generate the row in the BEAM Response Payload 425. As illustrated in FIG. 2, RI [0] and RI [1] in BEAM Response Payload 425 were generated by a resource that processed RI [1] in BEAM Payload 415.

In an embodiment, the value of the Response element (i.e., CI [2]) in a row in the BEAM Response Payload 425 will contain a processing status of a request within a BEAM Payload when the Response Type element value (i.e., CI [1]) in the row is 0 (i.e., Status).

In an embodiment, the value of the Response element (i.e., CI [2]) in a row in the BEAM Response Payload 425 will contain one or more query resultsets (e.g., Resultsets 263) when the Response Type element value (i.e., CI [1]) in the row is 1 (i.e., Resultsets).

In an embodiment, the value of the Response element (i.e., CI [2]) in a row in the BEAM Response Payload 425 will contain a BEAM Payload (e.g., BEAM Payload 261) when the Response Type element value (i.e., CI [1]) in the row is 2 (i.e., Payload).

In an embodiment, the value of the Response element (i.e., CI [2]) in a row in the BEAM Response Payload 425 will contain a Session object identifier (e.g., session 265) when the Response Type element value (i.e., CI [1]) in the row is 4 (i.e., Session).

In an embodiment, the value of the Response element (i.e., CI [2]) in a row in the BEAM Response Payload 425 will contain a Runtime State when the Response Type element value (i.e., CI [1]) in the row is 5 (i.e., Runtime State).

In an embodiment, the BEAM Payload 425 may be generated from an agent (e.g., agent 210 or agent 310) or a resource available to the agent (e.g., OEP 281 or OEP 381).

3.3. Example Events in a BEAM Payload

The following description illustrates a non-limiting embodiment of one or more object events within a BEAM Payload (Events). The Events include syntactically and semantically interoperable data and metadata content that an object event processor interfaced with or comprised in any agent or remote agent (e.g., OEP 281 interfaced with or comprised in agent 210, or OEP 381 interfaced with or comprised in agent 310) can interpret and process.

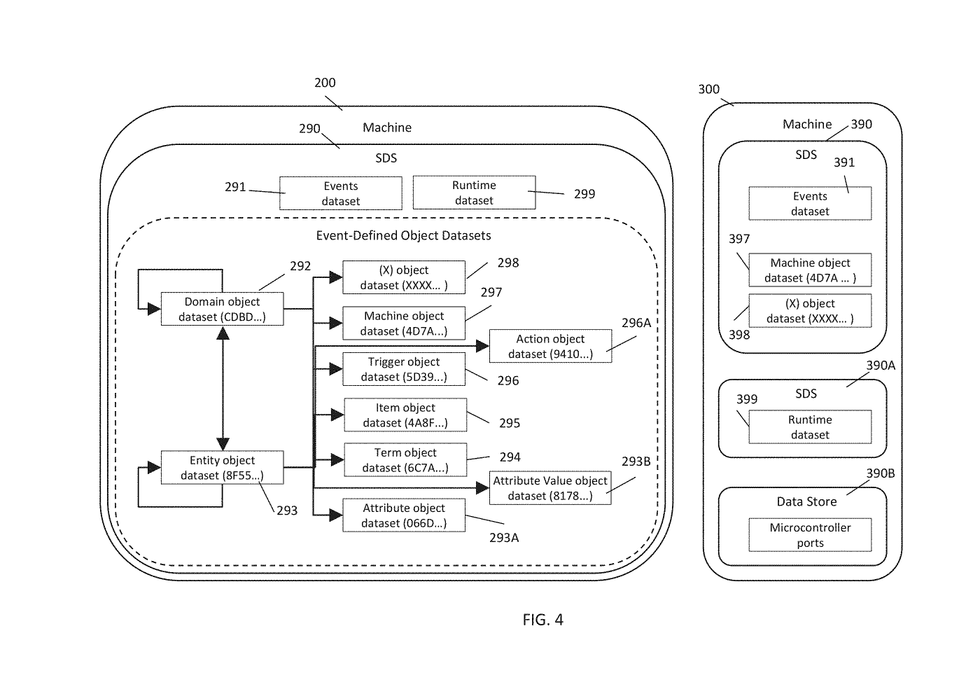

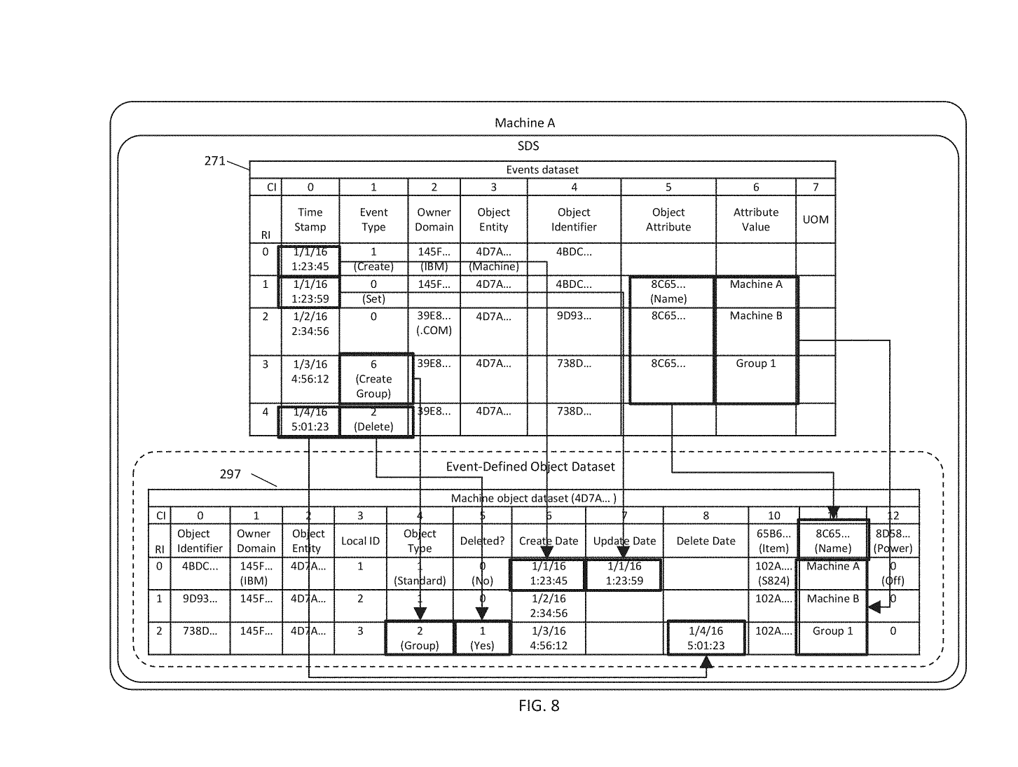

In an embodiment, the Events may be included in a statement within a row of a BEAM Payload dataset. In an embodiment, Events that have been processed by an OEP may be stored in a dataset in a structured data store (e.g., Events dataset 291 in SDS 290) as illustrated in FIG. 4. In an embodiment, the Events may be represented by a multi-row dataset (e.g., Events 271) with the defined columns illustrated in FIG. 8 and Table 5:

TABLE 5

| CI | Name | Type |
|---|---|---|
| 0 | Time Stamp | UTC Date/Time |
| 1 | Event Type | Number |
| 2 | Owner Domain | Identifier |
| 3 | Object Entity | Identifier |
| 4 | Object | Identifier |
| 5 | Object Attribute | Identifier |
| 6 | Attribute Value | Variant |
| 7 | UOM | Identifier |
| 8 | Triggered Action | Identifier |

In an embodiment, the Time Stamp column represents when the event in the row occurred.

In an embodiment, the Triggered Action column identifies the Action object, if applicable, that triggered an OEP to generate the event in the row.

Illustrative defined values for specific Events dataset columns are illustrated in Table 6:

TABLE 6

| CI | Value | Description |
|---|---|---|
| 0 | 0 | Set/Update |
| 0 | 1 | Create |
| 0 | 2 | Delete |
| 0 | 3 | Undelete |
| 0 | 4 | Purge |
| 0 | 5 | Create Duplicate |
| 0 | 6 | Create Group |
| 0 | 8 | Change Owner |

In an embodiment, as illustrated in Table 30, the “Attribute Value” element within a first row of Events (e.g., “6632 . . . ” at index location [4][6] in Events dataset) comprises the identification of an object (“Object Identifier” element) in a second row of Events (e.g., “6632 . . . ” at index location [0][4] in Events dataset). In an embodiment, the “Attribute Value” element value in the first row in Events represents a relationship between the object identified in the first row (e.g., a Purchase Order Item object) and the object identified in a second row (e.g., a Purchase Order object) in Events. In at least one such embodiment, the term “related to” may be used to describe this concept (e.g., a Purchase Order Item object related to a Purchase Order object or a Purchase Order Item object related to a Purchase Order object). In an embodiment, a type of attribute comprises the identification of a related object.

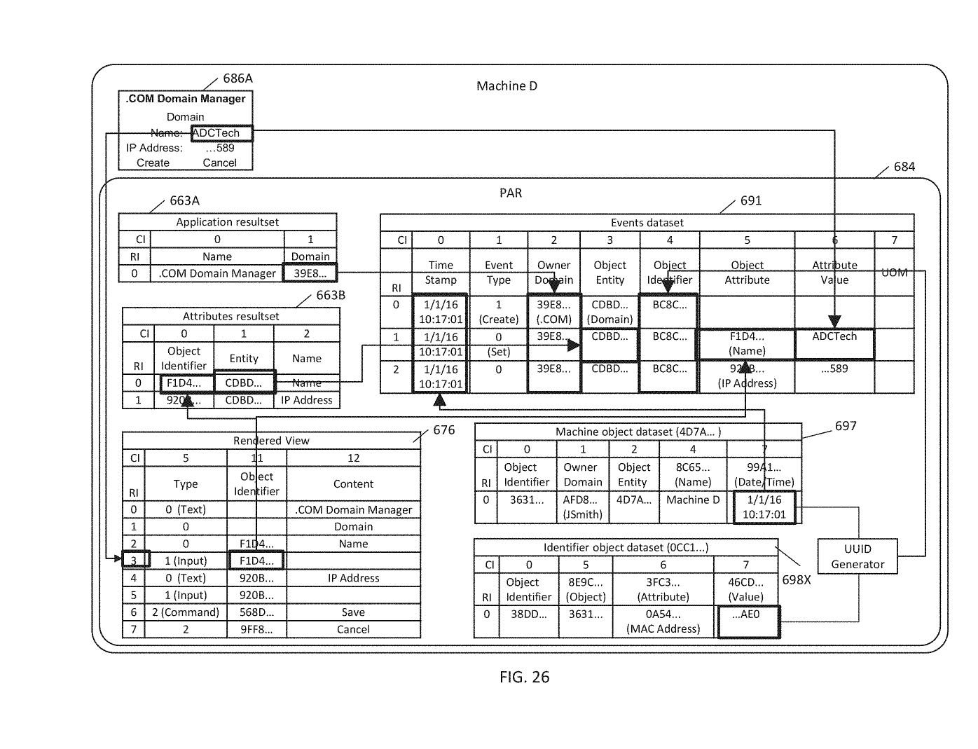

In at least one such embodiment, as illustrated in FIG. 26, the identification of a new object defined in one or more events (e.g., “6632 . . . ” at index location [0][4] in Events dataset in Table 30) can be generated by a resource on the machine that is generating the events that define the new object. In at least one such embodiment, the identification of the new object can be generated, in whole or in part, from one or more attribute values of one or more objects within object datasets in the machine generating the identifier (e.g. index location [0][7] within Machine object dataset 697 and index location [0][7] within Identifier object dataset 698X within Machine D).

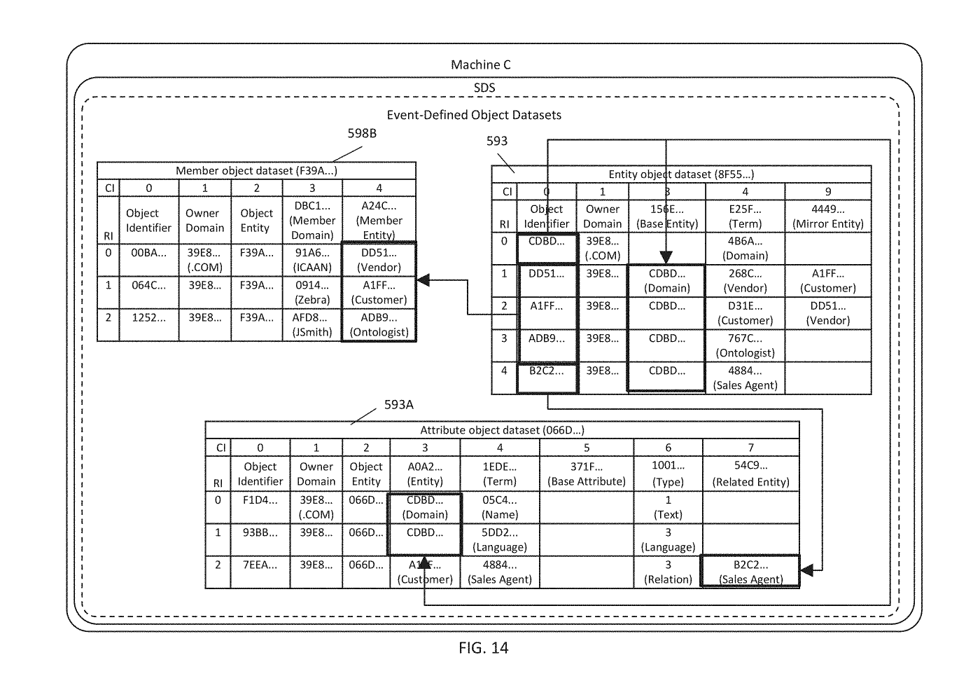

In at least one such embodiment, the “Type” attribute value of an Attribute object that represents an attribute of this type will comprise a “3” as illustrated in index location [2][6] in Attribute object dataset 593A in FIG. 14. In at least one such embodiment, the “Related Entity” attribute value of an Attribute object that represents this type of attribute will identify the entity of the related object as illustrated in index location [2][7] in Attribute object dataset 593A in FIG. 14.

In an embodiment, Events may be structured in a compressed format (i.e., compressed Events) within a BEAM Payload for efficient transportation from one agent to another agent. In an embodiment, an element in a row in compressed Events can be unpopulated if its value is the same as the value of the element in the same column in the preceding row as illustrated in Table 35 and Table 36.

3.4. Example View in a BEAM Payload

The following description illustrates a non-limiting embodiment of a rendered view within a BEAM Payload (View). A View includes syntactically and semantically interoperable data and metadata content that a driver, as a resource, interfaced with or comprised in any agent or remote agent (e.g., driver 286 interfaced with or comprised in agent 210, or driver 786 interfaced with or comprised in agent 710) can interpret and process.

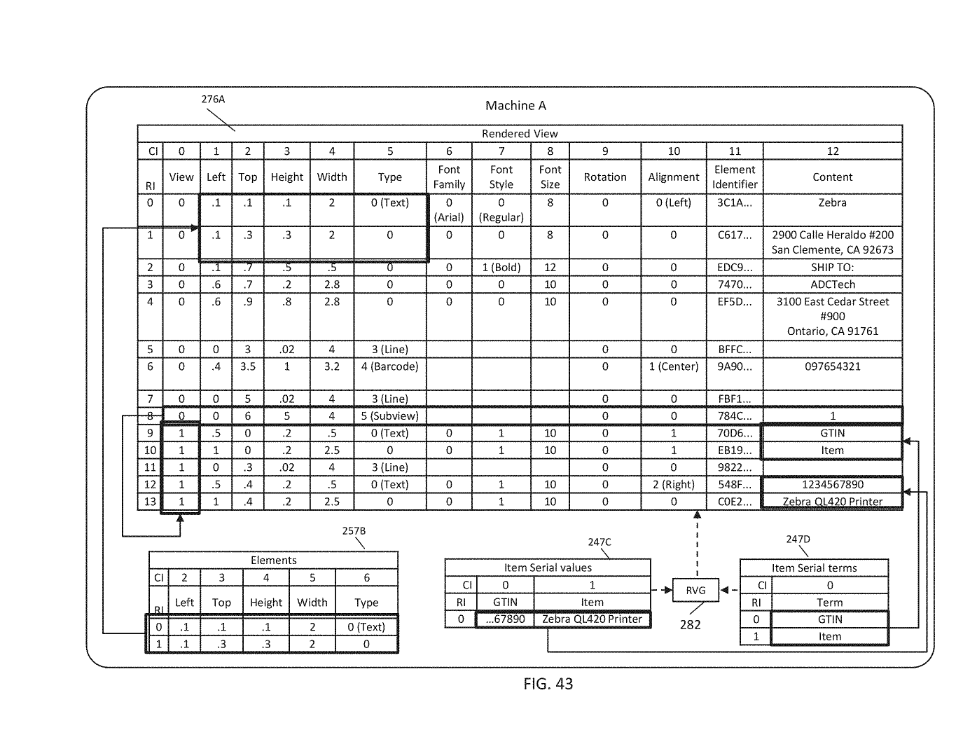

In an embodiment, a View may be included in a statement within a row of a BEAM Payload dataset. In an embodiment, a View may be represented by a multi-row dataset (e.g., Rendered View 276A) with the defined columns illustrated in FIG. 43 and Table 7:

TABLE 7

| CI | Name | Type |
|---|---|---|
| 0 | Parent View | Number |
| 1 | Left Position | Number |
| 2 | Top Position | Number |
| 3 | Height | Number |
| 4 | Width | Number |
| 5 | Type | Number |
| 6 | Font Family | Number |
| 7 | Font Style | Number |
| 8 | Font Size | Number |
| 9 | Rotation | Number |
| 10 | Alignment | Number |
| 11 | Element Identifier | Identifier |
| 12 | Content | Text |

Illustrative defined values for specific View dataset columns are illustrated in Table 8:

TABLE 8

| CI | Value | Description |
|---|---|---|
| 5 | 0 | Text |
| 5 | 1 | Input |
| 5 | 2 | Command |
| 5 | 3 | Line |
| 5 | 4 | Barcode |
| 5 | 5 | Subview |
| 6 | 0 | Arial |
| 6 | 1 | Times New Roman |
| 7 | 0 | Regular |
| 7 | 1 | Bold |
| 10 | 0 | Left |
| 10 | 1 | Center |
| 10 | 2 | Right |

3.5. Example Queries in a BEAM Payload

The following description illustrates a non-limiting embodiment of one or more object queries within a BEAM Payload (Queries). The Queries include syntactically and semantically interoperable data and metadata content that an object query processor interfaced with or comprised in any agent or remote agent (e.g., OQP 283 interfaced with or comprised in agent 210, or OQP 383 interfaced with or comprised in agent 310) can interpret and process.

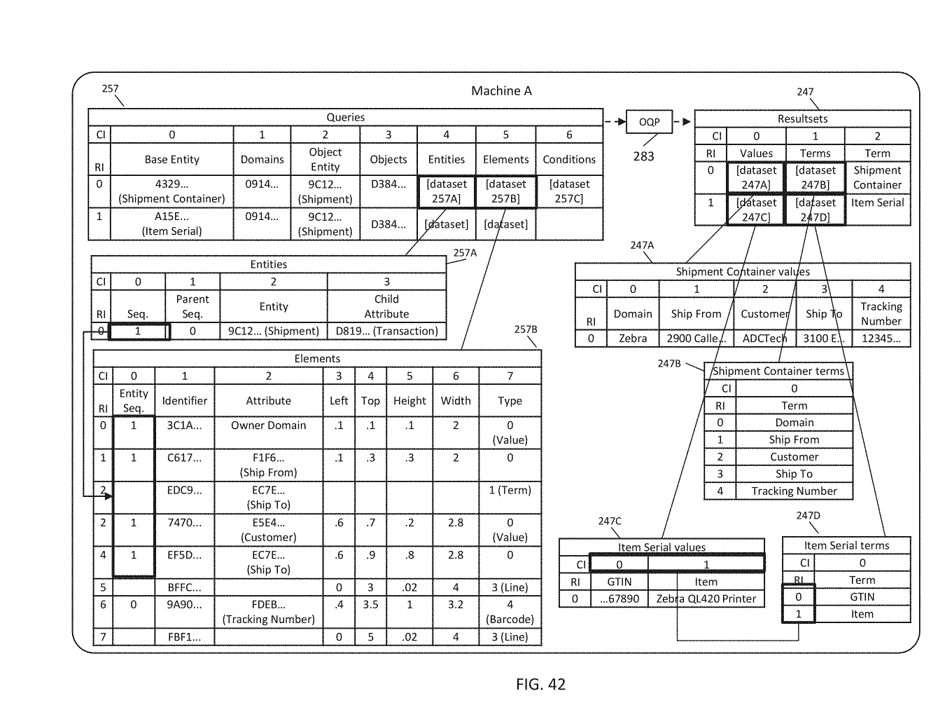

In an embodiment, the Queries may be included in a statement within a row of a BEAM Payload dataset. In an embodiment, the Queries is a multi-row dataset (e.g., Queries 257) with the defined columns illustrated in FIG. 42 and Table 9:

TABLE 9

| CI | Name | Type |
|---|---|---|
| 0 | Base Entity | Identifier |
| 1 | Domains | Identifier Array |
| 2 | Object Entity | Identifier |
| 3 | Objects | Identifier Array |
| 4 | Entities | Dataset |
| 5 | Elements | Dataset |
| 6 | Conditions | Dataset |

In an embodiment, a Queries dataset can comprise additional columns, as illustrated in Table 10, to define a rendered view from query resultsets.

TABLE 10

| CI | Name | Type |
|---|---|---|
| 7 | Parent View | Number |
| 8 | Left Position | Number |
| 9 | Top Position | Number |
| 10 | Height | Number |
| 11 | Width | Number |

In an embodiment, the Entities nested within an element (i.e., CI [4]) in a row in Queries 247 may be represented by a multi-row dataset (e.g., Elements 257A) with the defined columns illustrated in FIG. 42 and Table 11:

TABLE 11

| CI | Name | Type |
|---|---|---|
| 0 | Sequence | Number |
| 1 | Parent Sequence | Number |
| 2 | Entity | Identifier |
| 3 | Child Attribute | Identifier |

In an embodiment, the Elements nested within an element (i.e., CI [5]) in a row in Queries 247 may be represented by a multi-row dataset (e.g., Elements 257B) with the defined columns illustrated in FIG. 42 and Table 12:

TABLE 12

| CI | Name | Type |
|---|---|---|
| 0 | Entity Sequence | Number |
| 1 | Element Identifier | Identifier |
| 2 | Attribute | Identifier |

In an embodiment, an Elements dataset can comprise additional columns, as illustrated in Table 10, to define a rendered view from query resultsets.

TABLE 13

| CI | Name | Type |
|---|---|---|
| 3 | Left Position | Number |
| 4 | Top Position | Number |
| 5 | Height | Number |
| 6 | Width | Number |
| 7 | Type | Number |
| 8 | Font Family | Number |
| 9 | Font Style | Number |
| 10 | Font Size | Number |
| 11 | Rotation | Number |
| 12 | Alignment | Number |

In an embodiment, the Conditions nested within an element (i.e., CI [6]) in a row in Queries 247 may be represented by a multi-row dataset with the defined columns illustrated in Table 14:

TABLE 14

| CI | Name | Type |
|---|---|---|
| 0 | Entity Sequence | Number |
| 1 | Attribute | Identifier |
| 2 | Operator | Number |
| 3 | Value Attribute | Identifier |
| 4 | Value | Variant |

3.6. Example Resultsets in a BEAM Response Payload

The following description illustrates non-limiting embodiments of query resultsets within a BEAM Response Payload (Resultsets). The Resultsets include syntactically and semantically interoperable data and metadata content that a resource interfaced with or comprised in any agent or remote agent (e.g., PAR 284 interfaced with or comprised in agent 210, or PAR 384 interfaced with or comprised in agent 310) can interpret and process.

In an embodiment, the Resultsets may be included in an element within a row of a BEAM Response Payload dataset. In an embodiment, the Resultsets may be represented by a multi-row dataset (e.g., Resultsets 247) with the defined columns illustrated in FIG. 42 and Table 15:

TABLE 15

| CI | Name | Type |
|---|---|---|
| 0 | Values | Dataset |
| 1 | Terms | Dataset |
| 2 | Term | Text |

In an embodiment, the Values nested within an element (i.e., CI [0]) in a row in Resultsets 247 may be represented by a multi-row dataset (e.g., Shipping Container values 247A) with the defined columns illustrated in FIG. 42.

In an embodiment, the Terms nested within an element (i.e., CI [1]) in a row in Resultsets 247 may be represented by a multi-row dataset (e.g., Shipping Container terms 247B) with the defined column illustrated in FIG. 42 and Table 16:

TABLE 16

| CI | Name | Type |
|---|---|---|
| 0 | Term | Text |

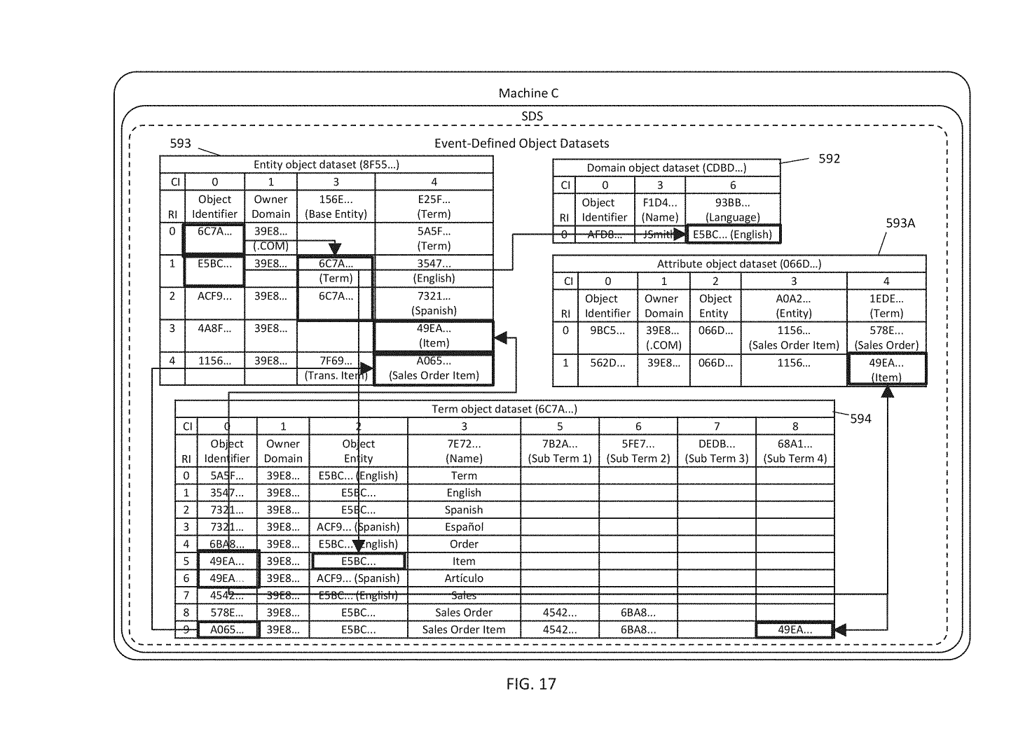

In an embodiment, the value of the Term element (i.e., CI [0]) in a row in the nested Terms dataset (e.g., index location [1][0] in Item Serial terms 247D illustrated in FIG. 42) will contain the “Name” attribute value of the Term object (e.g., “Item” at index location [5][3] in Term object dataset 594 in FIG. 17) related to the Attribute object identified by the Attribute element value (i.e., CI [2]) in the corresponding row of the Elements dataset nested within the Queries dataset. The “Object Entity” attribute value of the Term object (e.g., index location [5][2] in Term object dataset 594 in FIG. 17) will correspond to the “Language” identified in the current session (e.g., “E5BC . . . ” representing “English”).

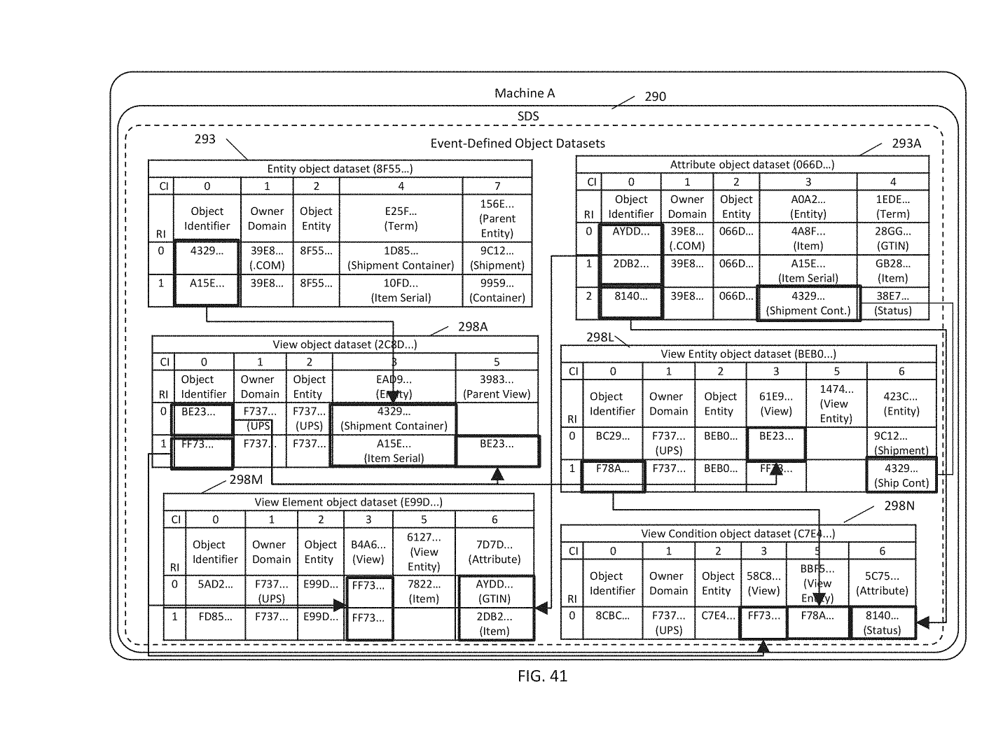

In an embodiment, the value of the Term element in a row in the Resultsets (e.g., index location [0][2] in Resultsets 247 illustrated in FIG. 42) will contain the “Name” attribute value (e.g., “Shipment Container”) of the Term object related to the Entity object (e.g., “1D85 . . . ” at index location [0][4] in Entity object dataset 493 in FIG. 41) identified by the Base Entity element value in the corresponding row of the Queries dataset (e.g., “4329 . . . ” at index location [0][0] in Queries 257 illustrated in FIG. 42). The “Object Entity” attribute value of the Term object will correspond to the “Language” identified in the current session (e.g., “E5BC . . . ” representing “English”).

In an embodiment, the Resultsets represent a portable application that includes syntactically and semantically interoperable data and metadata content that a portable application runtime interfaced with or comprised in any agent or remote agent (e.g., PAR 284 interfaced with or comprised in agent 210, or PAR 384 interfaced with or comprised in agent 310) can interpret and process.

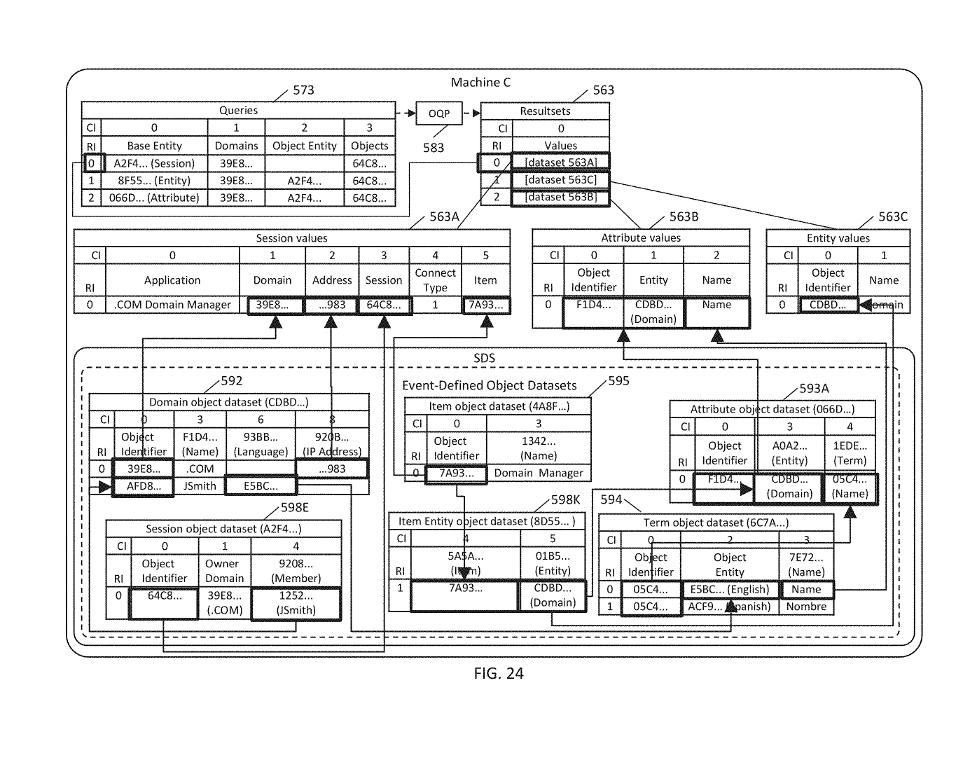

In an embodiment, the Resultsets 563 in FIG. 24 represent a portable application based on entities (i.e., Item Entity objects) included in a subscription service (i.e., Member Service object). Each row in the Resultsets contains a nested Values dataset (e.g., Session values 563A in RI [0], Attribute values 563B in RI [2], and Entity values 563C in RI [1] in Resultsets 563) that can be processed by the PAR. The Values datasets are derived from attribute values of objects within the SDS. As illustrated in FIG. 24, element values in Attributes values dataset 563B are derived from attribute values of objects within Attribute object dataset 593A (e.g., Name) that are related to Entity objects (e.g., Domain) that are related to Item Entity objects that are related to an Item object (e.g., Domain Manager in Item object dataset 595) that is related to the current session (e.g., Session values 563A).

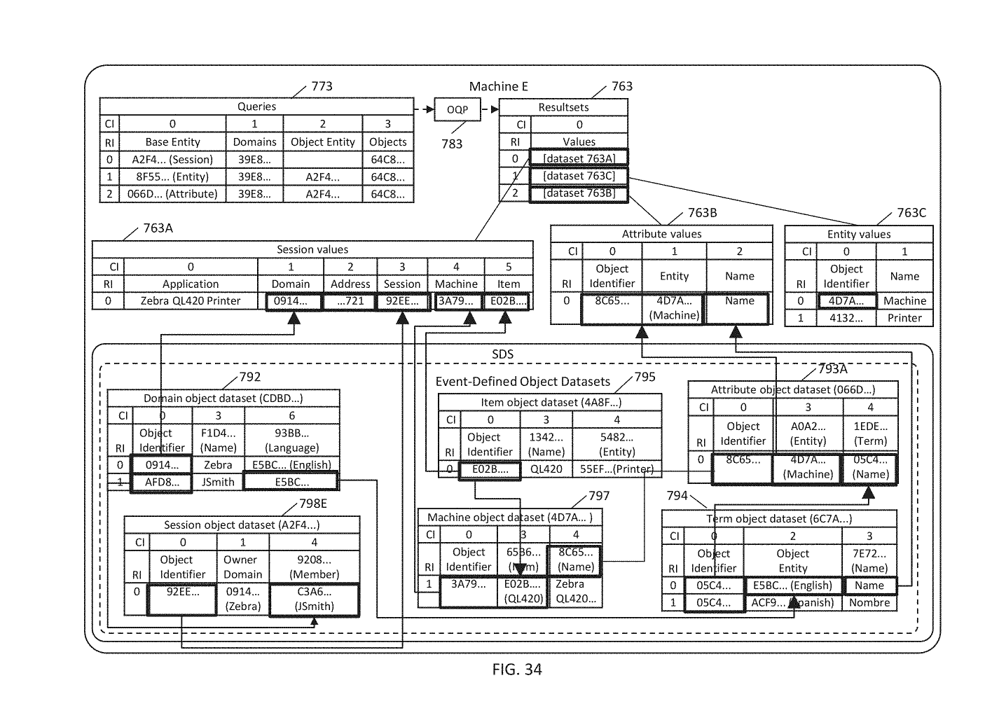

In an embodiment, the Resultsets 763 in FIG. 34 represent a portable application based on a machine (i.e., Machine object). Each row in the Resultsets contains a Values dataset (e.g., Session values 763A in RI [0], Attribute values 763B in RI [2], and Entity values 763C in RI [1] in Resultsets 763) that can be processed by the PAR. The Values datasets are derived from objects within the SDS. As illustrated in FIG. 34, element values in Attributes values dataset 763B are derived from attribute values of objects within Attribute object dataset 793A (e.g., Name) that are related to an Entity object (e.g., Machine or Printer) that is related to an Item object (e.g., Zebra QL420 Printer) that is related to a Machine object (e.g., Zebra QL420 Printer 1 in Machine object dataset 797) that is related to the current session (e.g., Session values 763A).

In an embodiment, the Resultsets represent a portable application framework that includes syntactically and semantically interoperable data and metadata content that a portable application runtime interfaced with or comprised in any agent or remote agent (e.g., PAR 284 interfaced with or comprised in agent 210, or PAR 384 interfaced with or comprised in agent 310) can interpret and process.

In an embodiment, the Resultsets 299A in FIG. 6 represent a portable application framework that is stored in a Runtime dataset 299 within SDS 290. The Machine values dataset 299B in RI [0] of Resultsets 299A includes an Identifier of the Machine object that represents the machine that receives, processes, and stores the portable application framework (e.g., Machine A).

### 4. Example Embodiment of an Agent

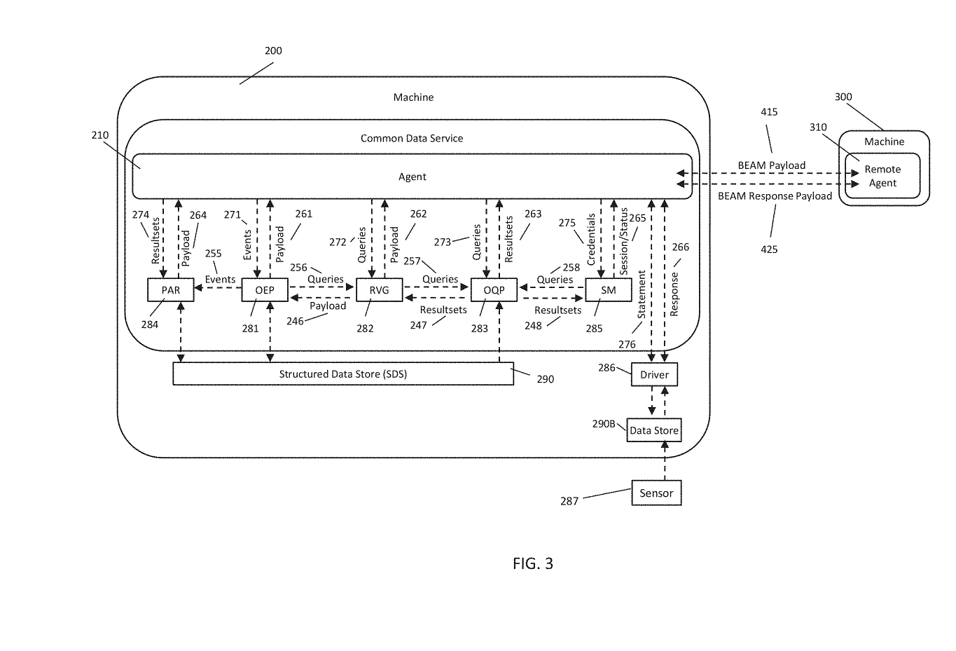

The following description illustrates a non-limiting embodiment of an agent (e.g., agent 110, 210, and/or 310). FIG. 3 illustrates the relationships between an agent 210, a portable application runtime 284, as a type of resource, an object event processor 281, as a type of resource, a rendered view generator 282, as a type of resource, an object query processor 283, as a type of resource, a session manager 285, as a type of resource, a driver 286, as a type of resource, and a remote agent 310 and a remote machine 300, according to an embodiment.

In an embodiment, agent 210 monitors incoming requests from remote machines (e.g., remote agent 310). When a BEAM Payload is received (e.g., BEAM Payload 415), agent 210 may process one or more requests in the BEAM Payload and may generate one or more responses in a BEAM Response Payload (e.g., BEAM Response Payload 425) that is returned to the requesting remote agent.

In an embodiment, a resource (e.g., object event processor 281) of machine 200 may generate one or more requests in a BEAM Payload (e.g., Payload 261) and invokes agent 210 to process the requests.

In an embodiment, a resource (e.g., portable application runtime 284) of machine 200 can process a portable application returned as query resultsets (e.g., Resultsets 274) in a BEAM Response Payload.

In an embodiment, for each request in a BEAM Payload (e.g., BEAM Payload 415), agent 210 may invoke a resource (e.g., resource 280, OEP 281, RVG 282, OQP 283, PAR 284, SM 285, or driver 286) of machine 200 that is identified within the request to process a statement that is contained within the request, which may generate a response. Agent 210 creates a BEAM Response Payload that contains one or more resource responses.

In an embodiment, for one or more rows in a BEAM Response Payload (e.g., BEAM Response Payload 425) returned to agent 310 that contain a BEAM Payload (e.g., Payload 261), agent 310 processes the one or more rows in the BEAM Payload.

In an embodiment, agent 210 returns one or more rows in a BEAM Response Payload (e.g., BEAM Response Payload 425) to a resource that generated the BEAM Payload (e.g., BEAM Payload 415).

In an embodiment, a portable application runtime (e.g., PAR 284) may generate a response in a BEAM Response Payload (e.g., BEAM Response Payload 425) that comprises a portable application framework, a portable application, or the current processing state of one or more portable applications (i.e., runtime state).

In an embodiment, the agent may invoke a second agent, as a resource, on the same machine to process a statement. In at least one such embodiment, the second agent is interfaced to a subsystem of the machine, wherein the subsystem comprises a second set of components of the common data service. In at least one such embodiment, the subsystem within a machine interacts with the agent in a manner similar to a remote machine. In at least one such embodiment, the statement submitted to the second agent by the agent comprises a BEAM Payload and a response returned by the second agent to the agent comprises a BEAM Response Payload.

In an embodiment, a driver (e.g., driver 286) can be invoked by an agent (e.g., agent 210) to convert a statement (e.g., statement 276) comprising a view (e.g., Rendered View 276A) generated by a rendered view generator (e.g., RVG 282) to a format that can be processed by a display engine or print engine to display a user interface (e.g., interface 686A) or print a document (e.g., document 786A).

In an embodiment, a driver (e.g., driver 286) can be invoked by an agent (e.g., agent 210) to convert a statement (e.g., statement 276) comprising Events (e.g., Events 271) generated by an object event processor (e.g., OEP 281) to a format that can be processed by a database engine or microcontroller to change the state of a data store.

In an embodiment, the data store can comprise the current state of a port pin collection of a microcontroller. In at least one such embodiment, a change in the state of the port pins corresponds to a change in the state of a data store, and vice versa.

In an embodiment, a change in the state of a data store can trigger a driver to generate Events that reflect the change. In at least one such embodiment, the driver (e.g., driver 286) can submit the Events as a statement (e.g., statement 276) to an agent (e.g., agent 210) for processing.

In an embodiment, the agent may submit a statement (e.g., statement 276), originating from a driver, to an object event processor (e.g., OEP 281) for processing when the statement comprises events.

In an embodiment, one or more attribute values of one or more objects in an SDS (e.g., SDS 290), defined by the events originating from a driver (e.g., driver 286), reflect the current state of the data store (e.g., data store 2906) interfaced with the driver.

### 5. Example Embodiment of a Structured Data Store

The following description illustrates a non-limiting embodiment of a structured data store (SDS). The SDS includes structured datasets, as illustrated in FIG. 4, that any object event processor (OEP), object query processor (OQP), and/or portable application runtime (PAR) can interpret and process.

In an embodiment, one or more of these datasets may be created by the same resource that created the SDS (e.g., during or after creation of the SDS).

In an embodiment, SDS 290 and SDS 390 contain Events dataset 291 and 391, respectively.

In an embodiment, SDS 290 and SDS 390A also contain Runtime dataset 299 and 399, respectively.

In an embodiment, an SDS (e.g., SDS 290) may be represented by a dataset that comprises nested datasets that represent the Events dataset (e.g., Events dataset 291) and/or Runtime dataset (e.g., Runtime dataset 299), as illustrated in FIG. 4.

In an embodiment, the Runtime dataset comprises a portable application framework, one or more portable applications, and/or the current processing state of one or more portable applications (i.e., runtime state). In an embodiment, the portable application framework (e.g., resultsets 299A) and the active portable application (e.g., resultsets 299C) are stored as nested datasets within the Runtime dataset (e.g., Runtime dataset 299), as illustrated in FIG. 6. In an embodiment, a nested Values dataset (e.g., Machine values 299B) within a row of the portable application framework dataset (e.g., resultsets 299A) within an SDS of a machine (e.g., machine A) comprises an identifier (e.g., “4BDC . . . ”) of a machine object that represents that machine.

In an embodiment, the portable application runtime (e.g., PAR 284) stores, retrieves, and processes metadata and data within the Runtime dataset (e.g., Runtime dataset 299)

In an embodiment, the object event processor (e.g., OEP 281) stores, retrieves, and processes metadata and data within the Events dataset (e.g., Events dataset 291)

In an embodiment, the object query processor (e.g., OQP 283) retrieves and processes metadata and data within the Events dataset (e.g., Events dataset 291).

In an embodiment, SDS 290 contains certain object datasets that are defined from Events dataset 291, including Domain object dataset 292, Entity object dataset 293, Attribute object dataset 293A, Attribute Value object dataset 293B, Term object dataset 294, Item object dataset 295, Trigger object dataset 296, Action object dataset 296A, and Machine object dataset 297. It should be understood that SDS 290 may also contain one or more other object datasets defined from Events dataset 291 (e.g., represented by object dataset 298).

In an embodiment, each row within an object dataset (e.g., Domain object dataset 292, Entity object dataset 293, Attribute object dataset 293A, Attribute Value object dataset 293B, Term object dataset 294, Item object dataset 295, Trigger object dataset 296, Action object dataset 296A, Machine object dataset 297, and/or additional object dataset(s) 298) represents an object, and each column within an object dataset represents an attribute, such that each element value in a row within an object dataset represents an attribute value of the object represented by that row.

In an embodiment, within an SDS (e.g., SDS 290), an object dataset (e.g., Domain object dataset 292) may be derived from rows in the Events dataset (e.g., Events dataset 291) stored within the SDS.

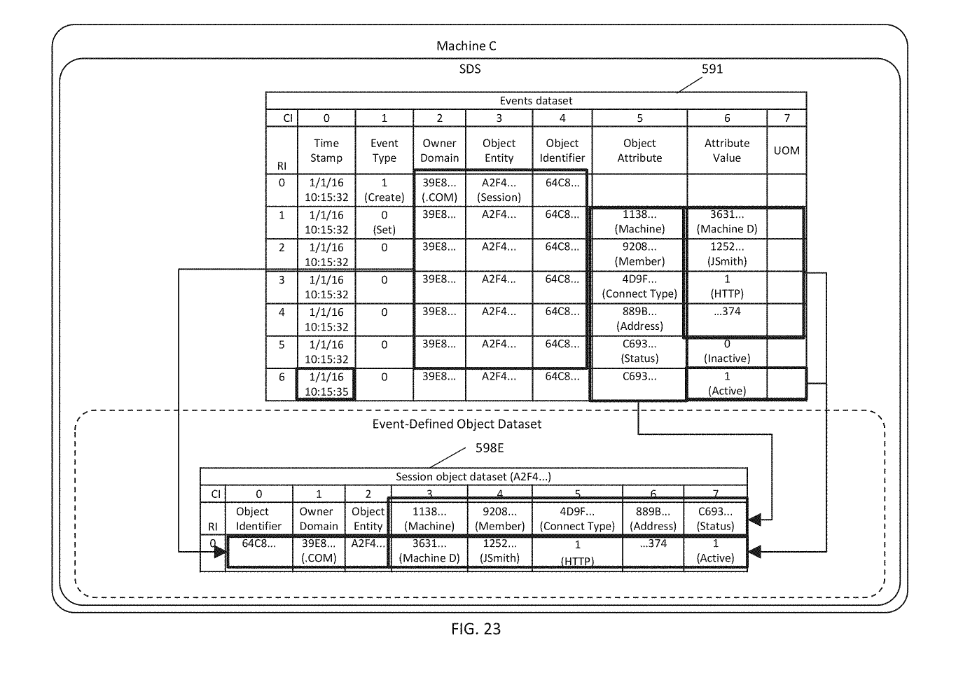

In an embodiment, within an SDS, an attribute value within an object dataset may be derived from the “Attribute Value” element value in the row in the Events dataset that identifies the object and identifies the attribute and has a most recent timestamp. As illustrated in FIG. 23, the attribute values within a row in a subset of the Session object dataset 598E may be derived from the “Attribute Value” elements (i.e., CI [6]) within rows in a subset of Events dataset 591 that correspond to specific “Owner Domain”, “Object Entity”, and “Object Identifier” elements within CI [2], CI [3], and CI [4], respectively. The “Time Stamp” element value at index location [6][0] is more recent than the “Time Stamp” element value at index location [5][0] for the same “Object Attribute” element value in CI [5]. Therefore, the attribute value for the corresponding attribute at index location [0][7] in Session object dataset 598E is derived from the “Attribute Value” element value at index location [6][6] in Events dataset 591.

In an embodiment, the processing of an Events dataset 271 by an OEP (e.g., OEP 281) may create one or more of these object datasets (e.g., Domain object dataset 292, Entity object dataset 293, Attribute object dataset 293A, Attribute Value object dataset 293B, Term object dataset 294, Term object dataset 295, Trigger object dataset 296, Action object dataset 296A, Machine object dataset 297, and/or additional object dataset(s) 298).

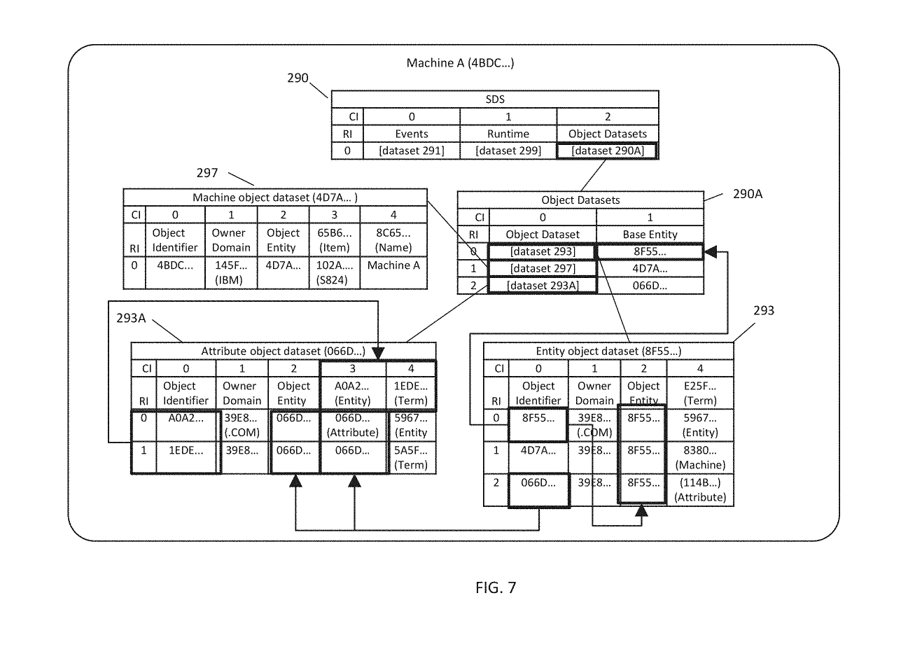

In an embodiment, an SDS (e.g., SDS 290) may be represented by a dataset that comprises a nested dataset that represent one or more object datasets generated from processing an Events dataset 271. As illustrated in FIG. 7, Entity object dataset 293, Attribute object dataset 293A, and Machine object dataset 297 are each stored in a row within an Object Datasets 290A which is stored within an element of SDS 290. In at least one such embodiment, an OEP or OQP can reference an object dataset by its index location within the SDS dataset. For example, Entity object dataset 293 can be referenced as index location [0][0] in Object Datasets 290A at index location [0][2] within SDS dataset 290. The row index of an object dataset within Object Datasets 290A can be derived from the row index (e.g., [0]) of the “Base Entity” element (e.g., “8F55 . . . ”) within Object Dataset 290A that identifies the base Entity object (e.g., RI [0] in Entity object dataset 293) of the object dataset. In at least one such embodiment, when processing a row in Events dataset 271 to update an object dataset, the value of the “Object Entity” element in the row in the Events dataset can correspond to a “Base Entity” element value in Object Dataset 290A that identifies the row index of the object dataset to be updated.

In an embodiment, processing of an Events dataset 271 by an OEP may create a new row (e.g., RI [2]) in Entity object dataset 293. A triggered action may create a corresponding row (e.g., RI [2]) in Object Datasets 290A that contains an object dataset (e.g., Attribute object dataset 293A) and an object identifier representing the new row in Entity object dataset 293. The new object dataset initially comprises an “Object Identifier” column (i.e., CI [0]), an “Owner Domain” column (i.e., CI [1]), and an “Object Entity” column (i.e., CI [2]), as illustrated in Table 17.

TABLE 17

| CI | Name | Type |
|---|---|---|
| 0 | Object Identifier | Identifier |
| 1 | Owner Domain | Identifier |
| 2 | Object Entity | Identifier |

In an embodiment, the “Object Identifier” column may contain any type of unique identifier, including, without limitation, a sequence of any number of digits or alphanumerical characters, hexadecimal numbers, and the like. An “Object Identifier” element value within a row in an object dataset identifies the object represented by that row. Thus, the element value in an “Object Identifier” column of any of the object datasets may be referred to herein as an “object identifier.”

In an embodiment, an object dataset (e.g., any of object datasets 292-298) within an SDS (e.g., SDS 290) can comprise additional initial columns as illustrated, for example, in Table 18 and Machine object dataset 297 in FIG. 8. In at least one such embodiment, each element value in a column of a row of an object dataset represents an attribute of the object represented by, identified in, or otherwise associated with that row.

TABLE 18

| Name | Type |
|---|---|
| Local ID | Incremental Number |
| Object Type | Number (0-Standard, 1-Group) |
| Deleted? | Boolean |
| Create Date | Date/Time |
| Update Date | Date/Time |
| Delete Date | Date/Time |

In an embodiment, processing of an Events dataset 271 by an OEP may create a new row in Attribute object dataset 293A. A triggered action may create a corresponding column in an object dataset that is referenced in the new row. As illustrated in FIG. 7, the two rows (i.e., RI [0] and RI [1]) added to Attribute object dataset 293A triggered the creation of two corresponding columns (i.e., CI [3] and CI [4]) within the same Attribute object dataset 293A which is identified by the “Entity” attribute value (i.e., CI [2]) of both rows.

In an embodiment, each of the rows of Attribute object dataset 293A represent a particular attribute, as an object, that can be related to other objects (e.g., objects within Entity object dataset 293). As discussed above and illustrated in FIG. 7, CI [0] for Attribute object dataset 293A comprises an identifier, such that each row represents a uniquely-identified attribute. Thus, for example, a column representing an attribute within an object dataset (e.g., any of object datasets 292-298, including Attribute object dataset 293A) within SDS 290 can be identified by the “Object Identifier” element value corresponding to the row in the Attribute object dataset 293A that represents that attribute. A column index (e.g., CI [3] in Attribute object dataset 293A) representing an attribute within Attribute object dataset 293A itself can be identified by the “Object Identifier” element value at CI [0] within Attribute object dataset 293A. For example, as illustrated in FIG. 7, CI [3] is identified by the unique identifier for the attribute represented by RI [0] (i.e., the unique identifier at index location [0][0]), i.e., “A0A2 . . . ”. In addition, CI [4] is identified by the unique identifier for the attribute represented by RI 1 (i.e., the unique identifier at index [1][0]), i.e., “1EDE . . . ”, and so on.

In an embodiment, an OEP or OQP can reference an attribute of an object by its index location within the SDS dataset. For example, as illustrated in FIG. 7, the “Term” attribute of an object (e.g., RI [1]) in Attribute object dataset 293A can be referenced as index location [1][4] in Attribute object dataset 293A. The column index (e.g., [4]) of an attribute of an object can be derived from an offset (e.g., 3) from the row index (e.g., [1]) of the object within Attribute object dataset 293A representing the attribute. In at least one such embodiment, when processing a row in Events dataset 271 to update an attribute of an object, the value of the “Object Attribute” element (e.g., “1EDE . . . ”) in the row in the Events dataset can correspond to an “Object Identifier” element value (e.g., index location [1][0]) in Attribute object dataset 293A that identifies the column index (e.g., [4]) of the attribute to be updated.

In an embodiment, the “Owner Domain” attribute value at CI [1] within an object dataset can identify a domain. An object dataset can include objects owned by one domain or multiple domains. Each domain may be represented as a row within Domain object dataset 292.

In an embodiment, an “Owner Domain” attribute value within an object dataset (e.g., any of object datasets 292-298) within SDS 290 can be set to the value of an object identifier uniquely identifying a domain within Domain object dataset 292 (e.g., the element in the “Object Identifier” column of the row representing the domain object). The “Owner Domain” element value at CI [1] within Domain object dataset 292 itself can be set to the value of the object identifier at CI [0] within Domain object dataset 292. For example, as illustrated in FIG. 11, the element value at index location [2][1], i.e., “0914 . . . ”, representing the domain that owns the domain object, represented by RI [1], is the same as the element value at index location [1][0]. In this example, the relationship between the objects can be referred to as an object owned by the “Zebra” Domain object.

In an embodiment, objects within Domain object dataset 292 may represent persons, organizations, business units, and the like. In at least one such embodiment, a domain object representing an organization and represented as a row in the Domain object dataset 292 can be assigned as the owner domain for a domain object representing a person, business unit, or other organization, also represented as a row in the Domain object dataset 292. As another example, a domain object representing a person and represented as a row in the Domain object dataset 292 can be assigned as the owner domain for a domain object representing a business unit or other person, also represented as a row in the Domain object dataset 292. In either case, a first domain object is assigned as the owner domain for a second domain object by identifying the first domain object in the “Owner Domain” column (CI [1]) of the second domain object.

In an embodiment, the “Object Entity” element value at CI [2] within an object dataset can identify an entity. An object dataset can include objects of one entity, or multiple entities with the same base entity structure. Each entity may be represented as a row within Entity object dataset 293.

In an embodiment, an “Object Entity” element value within an object dataset (e.g., any of object datasets 292-298) within SDS 290 can be set to the value of an object identifier within Entity object dataset 293. The “Object Entity” element value at CI [2] within Entity object dataset 293 itself can be set to the value of the object identifier at CI [0] within Entity object dataset 293. For example, as illustrated in FIG. 7, the element value at index location [0][2], i.e., “8F55 . . . ”, is the same as the element value at index location [0][0].

In an embodiment, processing Events (e.g., Events dataset 271) by an OEP on a machine (e.g., OEP 281 on machine 200) can create one or more object datasets (e.g., object dataset 298) within an SDS (e.g., SDS 290) on the same machine.

In an embodiment, processing Events (e.g., Events dataset 271) by an OEP on a machine (e.g., OEP 281 on machine 200) can create one or more additional rows or columns within an existing object dataset (e.g., Entity object dataset 293) within a SDS (e.g., SDS 290) on the same machine.

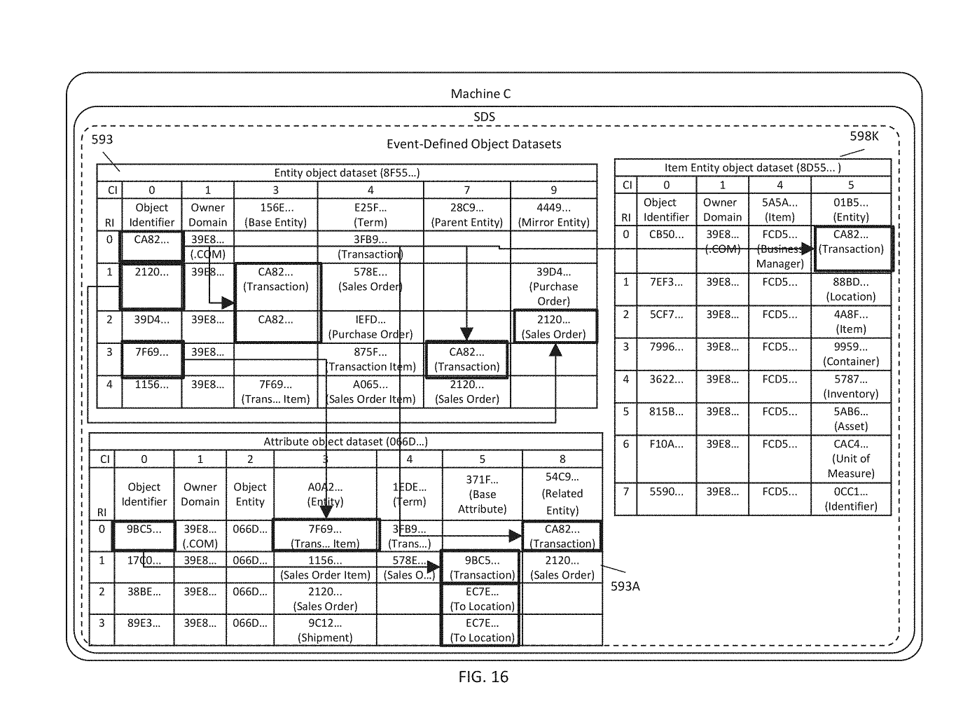

In an embodiment, Entity object dataset 293 can contain rows that represent both base entities and supplemental entities as objects. An example is illustrated in FIG. 16, according to an embodiment. In at least one such embodiment, one or more supplemental entity objects share the same attributes as a base entity object and each supplemental entity object comprises one or more attributes that supplement the attributes of a base entity object. A column within Entity object dataset 593 (e.g., CI [3]) can identify the base Entity object for a supplemental Entity object. In the illustrated example, the “Base Entity” element value at index location [1][3] within a subset of Entity object dataset 593 is set to the value of the object identifier at index location [0][0] within in Entity object dataset 593, which is illustrated as “CA82 . . . ”. Thus, in the example illustrated in FIG. 16, the entity represented by RI [1] and identified as “2120 . . . ” is a supplemental entity that is based on the base entity represented by RI [0] and identified as “CA82 . . . ”.

In another embodiment, a supplemental entity can be based on another supplemental entity. In an example, a “Thermal Printer” entity can be based on a “Printer” entity which can be based on a “Machine” entity.

In an embodiment, one or more objects, representing attributes, within Attribute object dataset 293A can be related to a base or supplemental Entity object within Entity object dataset 293. In at least one such embodiment, a column within Attribute object dataset 293A (e.g., CI 3) can identify the Entity object related to an Attribute object. For example, as illustrated in FIG. 16, the element value at index location [0][3] in a subset of the Attribute object dataset 593A is set to the value of the object identifier (i.e., “7569 . . . ”) for the base entity represented by row [3][0] in a subset of the Entity object dataset 593.

In an embodiment, Attribute object dataset 293A can contain rows that represent both base attributes and supplemental attributes as objects. In at least one such embodiment, one or more supplemental Attribute objects can be related to a supplemental Entity object and one or more base Attribute objects can be related to a base Entity object. Also, in at least one such embodiment, a supplemental Attribute object can be related to a base Attribute object, where the supplemental Entity object that is related to the supplemental Attribute object is related to the base Entity object which is related to the base Attribute object. A column (e.g., CI 5) within Attribute object dataset 293A can identify the base Attribute object related to a supplemental attribute object. For example, as illustrated in FIG. 16, the “Base Attribute” element value at index location [1][5] within Attribute object dataset 593A is set to the value of the object identifier (i.e., “9BC5 . . . ”) at index location [0][0] within Attribute object dataset 593A. Thus, the supplemental attribute represented by RI [1] in the Attribute object dataset 593A and identified as “17C0 . . . ” is related to the base attribute represented by RI [0] and identified as “9BC5 . . . ” in the Attribute object dataset 593A.

In an embodiment, an object dataset (e.g., Term object dataset 294) can contain objects related to one or more supplemental entities related to the same base entity. In at least one such embodiment, the “Object Entity” element value (e.g., at CI [2]) within Term object dataset 294 is set to the object identifier (e.g., at CI [0]) for a base Entity object within Entity object dataset 293. For example, as illustrated in FIG. 17, the “Object Entity” element value at index location [5][2] in Term object dataset 594 is set to the value of the “Object Identifier” element at index location [1][0] within Entity object dataset 593, indicating that Term object dataset 594 contains the supplemental entity represented by RI [1] in Entity object dataset 593 and identified by “E5BC . . . ”. In addition, the “Object Entity” element value at index location [6][2] within Term object dataset 594 is set to the value of the “Object Identifier” element value at index location [2][0] within Entity object dataset 593, indicating that Term object dataset 594 also contains the supplemental entity represented by RI [2] in Entity object dataset 593 and identified by “ACF9 . . . ”. The “Base Entity” element value of the supplemental entities represented by R1 [1] and RI [2] in Entity object dataset 593 are set the same identifier (i.e., “6C7A . . . ”) of a base Entity object (i.e., RI [0]) in Entity object dataset 593.

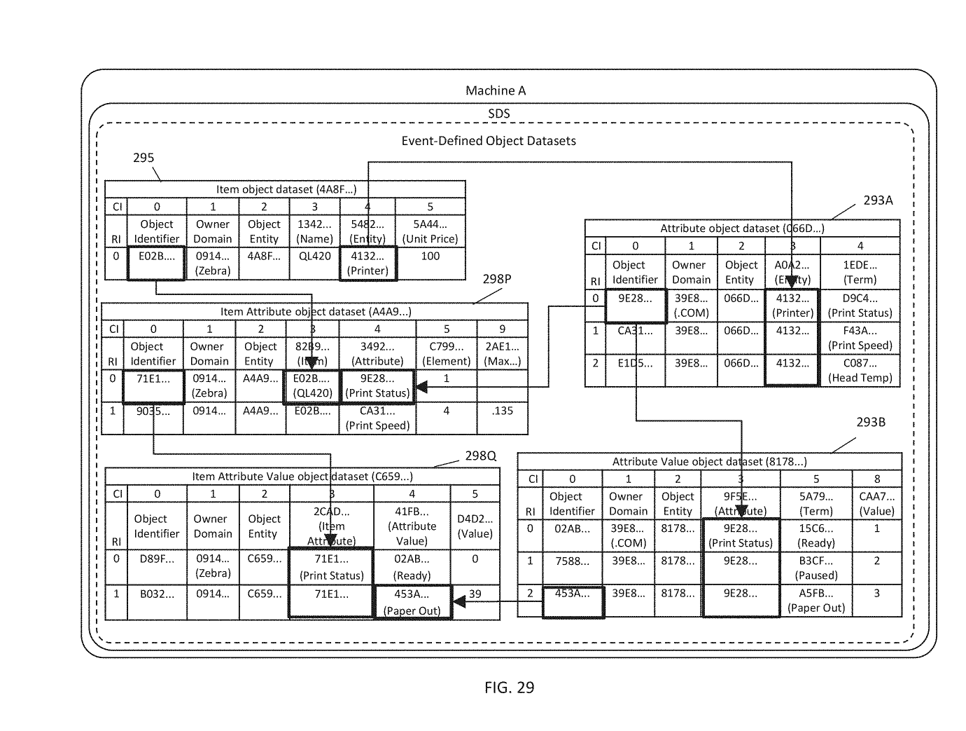

In an embodiment, an Item object related to an Entity object can incorporate, as Item Attribute objects, one or more Attribute objects of the Entity object as illustrated in FIG. 29. For example, a “Printer” Entity object can be related to a plurality of Item objects with each Item object supporting a subset of the complete attribute set a universal printer definition.

In an embodiment, human-readable terms for objects within certain object datasets (e.g., Entities object dataset 593, Attributes object dataset 593A) can be constructed from a related object from a Terms object dataset 594 as illustrated in FIG. 17. For example, a human readable “Sales Order Item” term can be constructed from three root Term objects related to elements of a fourth composite Term object (i.e., RI [9] in Term object dataset 594) that is related to an object at RI [4] in Entity object 593. The human-readable “Sales Order Item” term comprises the “Name” element value (i.e., CI [3]) of each of the three root Term objects (i.e., “Sales”, “Order”, and “Item”). A human-readable “Sales Order” term comprises the “Name” element value (i.e., CI [3]) of each of two root Term objects (i.e., “Sales”, and “Order”).

In an embodiment, a plurality of Term objects can be identified by the same object identifier where each of the Term objects represents a human-readable term with the same meaning in different human languages. In at least one such embodiment, an attribute of the Term object identifies the human language. As illustrated in FIG. 17, Term objects in RI [5] and RI [6] in Term object dataset 594 share the same object identifier (i.e., “49EA . . . ”). In an embodiment, the “Object Entity” attribute value of the Term objects identifies an Entity object that represents a human-readable language (e.g., English). The “Name” attribute value of the Term objects represents the translation of the term in the human-readable language identified by its “Object Entity” attribute value. For example, the value (i.e., “Articulo”) of the “Name” element value at index location [6][3] in Term object dataset 594 corresponds to the value (i.e., “E5BC . . . ”) of the “Object Entity” attribute at index location [6][2] which identifies the Entity object that represents the Spanish language.

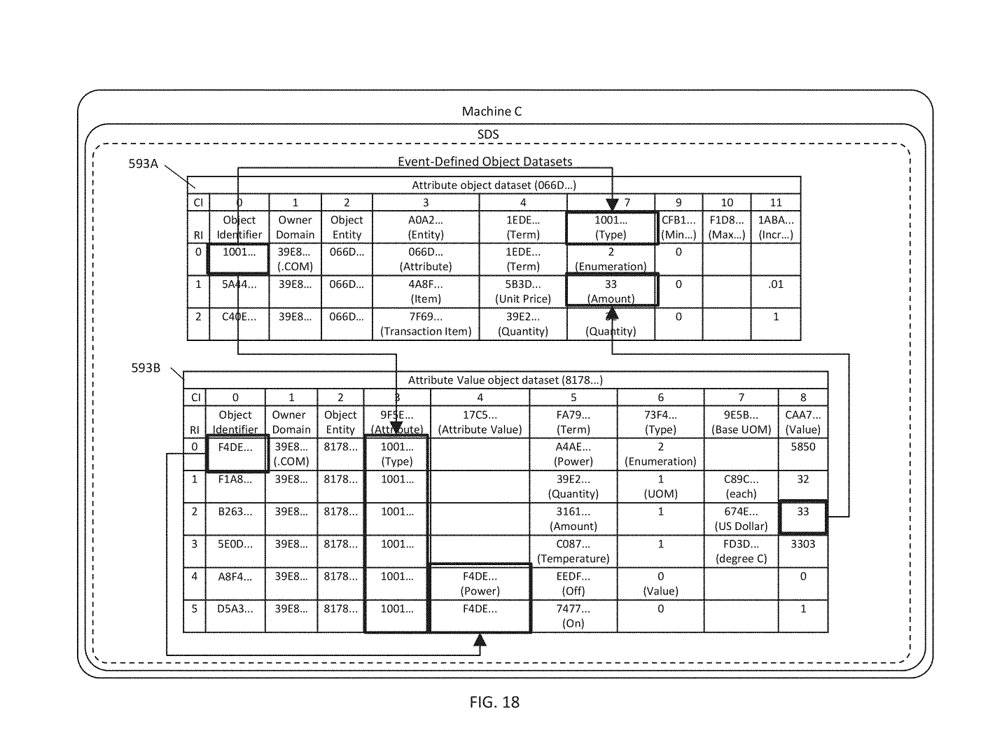

In an embodiment, the value of a type of attribute can be limited to an enumeration of values that are each represented by a child Attribute Value object related to the parent Attribute object that is representing the attribute. As illustrated in FIG. 18, the value of the “Type” attribute (i.e., CI [7]) in the Attribute object dataset 593A is limited to the “Value” attribute values in CI [8] in the Attribute Value object dataset 593B that are related to the Attribute object representing the “Type” attribute. For example, the value of the “Type” element at index location [1][7] in a subset of Attribute object dataset 593A is set to the value (i.e., “33”) in index location [2][8] in a subset of the Attribute object dataset 593A.

In an embodiment, a type of enumerated value represented by a parent Attribute Value object can also represent an enumeration of values that are each represented by an Attribute Value object related to the parent Attribute Value object. For example, the “Attribute Value” element value (i.e., CI [4]) of child Attribute Value objects in RI [4] and RI [5] within a subset of Attribute object dataset 593B identify a parent Attribute Value object in RI [0].

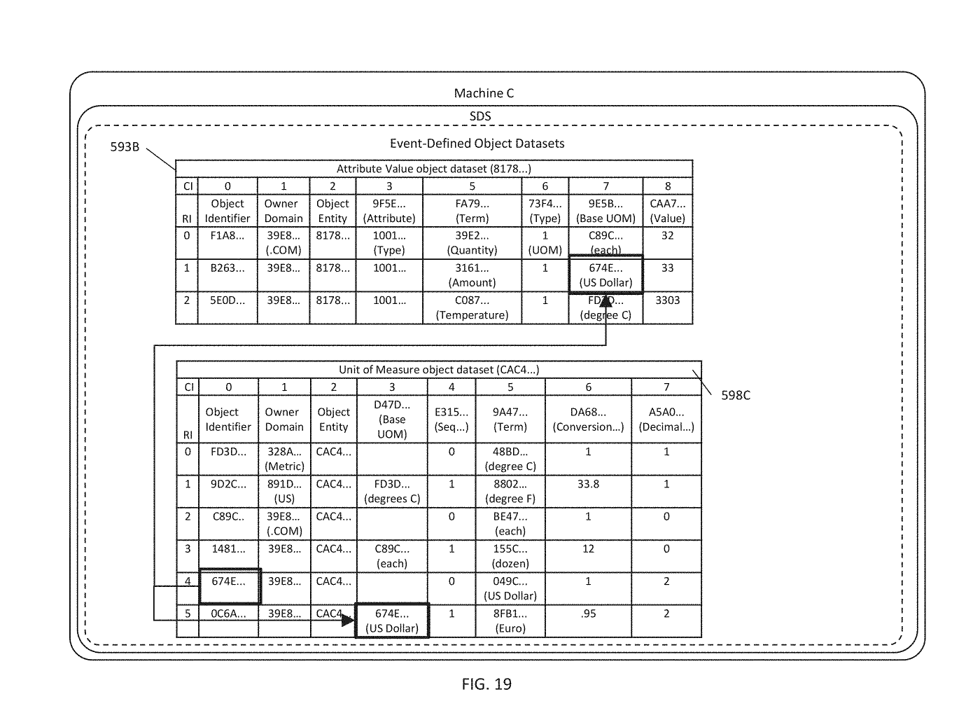

In an embodiment, a type of enumerated value represented by an Attribute Value object can be related to a Unit of Measure object as illustrated in the rows in a subset of Attribute object dataset 593A in FIG. 19. For example, the “Base UOM” element value (i.e., CI [7]) of Attribute Value object in RI [1] within a subset of Attribute object dataset 593B identifies a Unit of Measure object in RI [4] within a subset of Unit of Measure object dataset 598C. In an embodiment, a base Unit of Measure object (e.g., US Dollar) can be related to a plurality of alternate Unit of Measure objects (e.g., Euro) that each comprise a conversion factor (e.g., 0.95) based on the base Unit of Measure. In an embodiment, a type of attribute (e.g., Amount) corresponds to an enumerated value (e.g., 33) that is related to a base Unit of Measure (e.g., US Dollar). In at least one such embodiment, a row in Events that sets the value of an attribute (e.g., Unit Price) of this type, also identifies the unit of measure object associated with the value (e.g., US Dollar or Euro). In at least one such embodiment, the “UOM” element value within Events identifies the unit of measure object. In at least one such embodiment, the value of an attribute of this type, that is associated with an alternate unit of measure (e.g., Euro), can be converted to a value that represents a base unit of measure (e.g., US Dollar) based on the conversion factor of the alternate unit of measure.

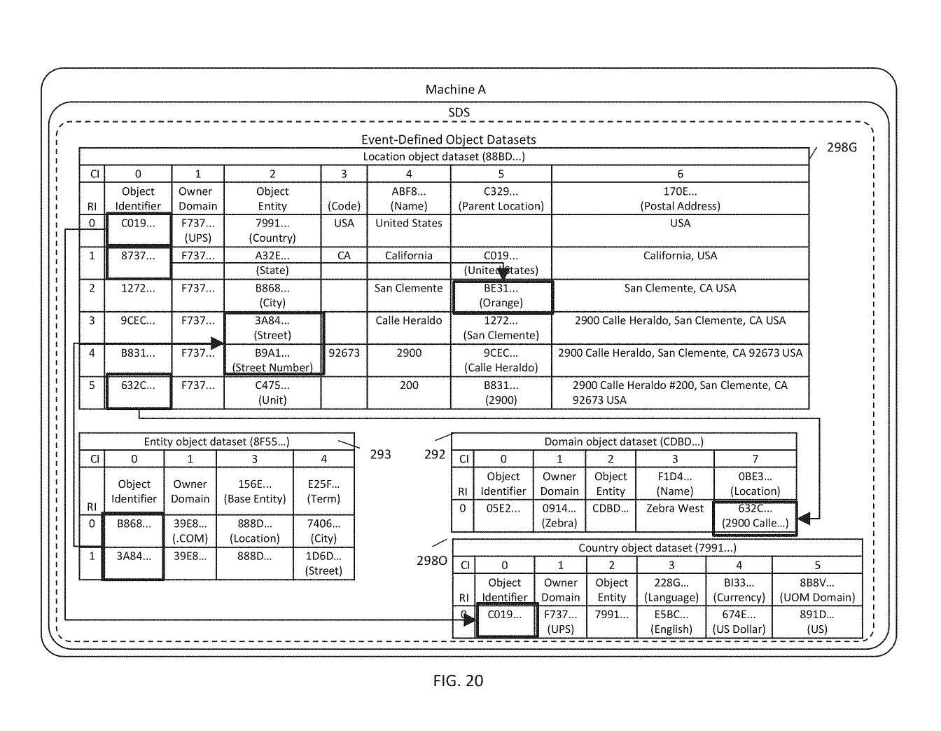

In an embodiment, a Location object dataset can comprise related objects of supplemental entities (e.g., Country, State, City, Street) to a base Location entity that can form a composite postal address as illustrated at index location [5][6] in Location object dataset 298G in FIG. 20. The Location object comprising a composite postal address can be related to a plurality of entity objects. For example, the “Location” attribute value of a Domain object at RI [0] in a subset of Domain object dataset 292 identifies a Location object at RI [5] in Location object dataset 298G that comprises a postal address, as illustrated in FIG. 20.

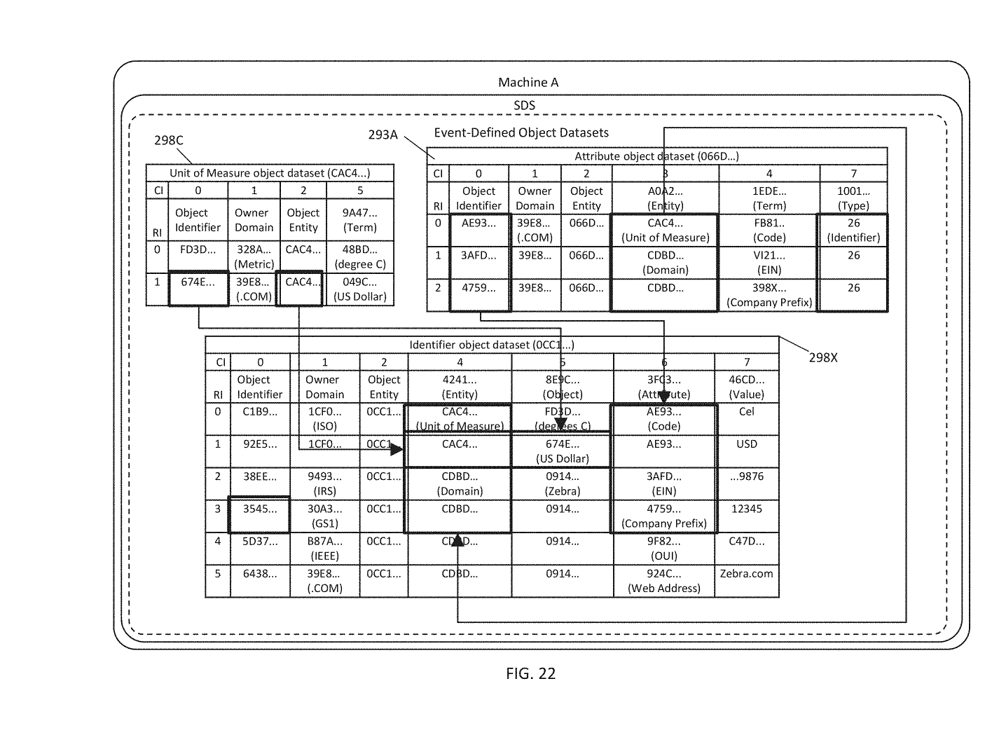

In an embodiment, an Identifier object dataset can comprise alternate identifiers, as a type of attribute for objects, as illustrated in FIG. 22. For example, the “Value” element value at index location [1][7] in Identifier object dataset 298X is set to an alternate identifier (i.e., “USD”) for an object (i.e., RI [1]) in Unit of Measure object dataset 298C. A plurality of alternate identifiers can be created for a single object, each owned by a separate Domain object (e.g., “ISO” Domain object representing ISO.org). In an embodiment, an identifier element (e.g., “Object Identifier”, “UOM”) in Events dataset 271 can comprise an alternate identifier (e.g., “USD”) which can be converted to a corresponding object identifier (e.g., “674E . . . ”) by an object event processor.

### 6. Example Embodiment of an Object Event Processor

The following description illustrates a non-limiting embodiments of an Object Event Processor (OEP), as a resource of a machine. FIG. 3 illustrates the relationships between an OEP 281, an agent 210, a rendered view generator 282, as a type of resource, an object query processor 283, as a type of resource, a portable application runtime 284, as a type of resource, and a structured data store 290, according to an embodiment.

In an embodiment, agent 210 invokes OEP 281 to process Events (e.g., Events 271) included in a statement in a row within a BEAM Payload and OEP 281 returns BEAM Payload 261 as a response to agent 210.

In an embodiment, OEP 281 processes one or more rows in Events. In an embodiment, each row in Events comprises a type of action.

In an embodiment, processing a type of action within Events comprises creating an object within an object dataset within SDS 290.

In an embodiment, processing a type of action within Events comprises creating a new object that represents a group of objects within an object dataset within SDS 290. In the example illustrated in FIG. 8, RI [3] in Events dataset 291 creates an object (i.e., RI [2]) in Machine object dataset 297 comprising an object type that designates a group object.

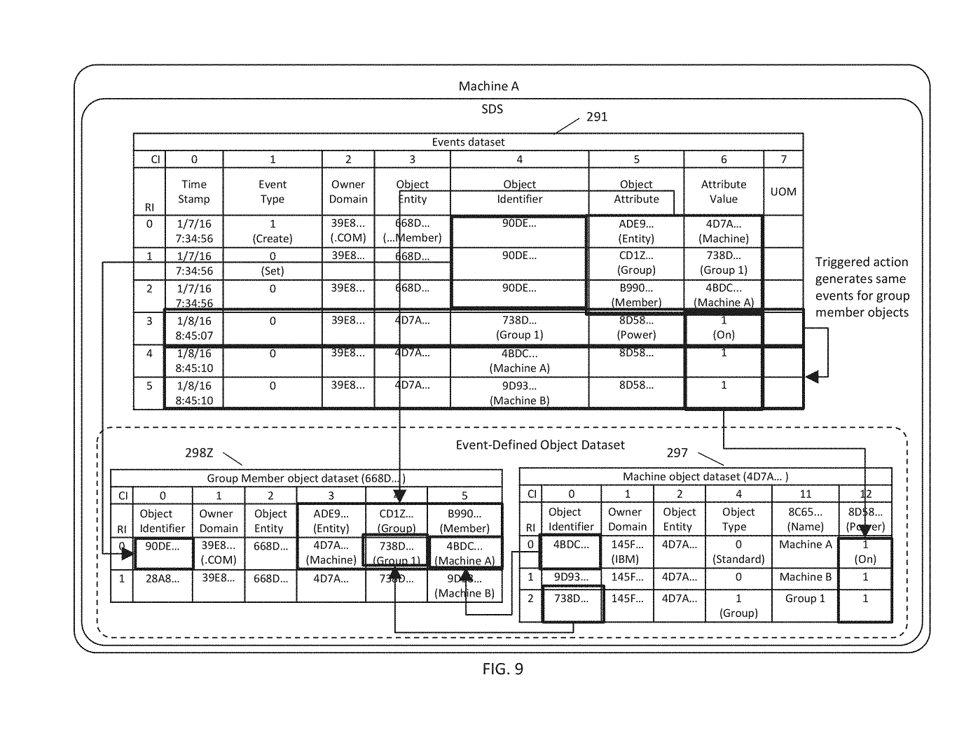

In an embodiment, processing a type of action within Events defines a member relationship between an object and a group object within an object dataset within SDS 290. In the example illustrated in FIG. 9, RI [0] through RI [2] in Events dataset 291 defines a new object (i.e., RI [0]) in Group Member object dataset 298Z that defines a member relationship between the object in RI [0] in Machine object dataset 297 with the group object in RI [2] in Machine object dataset 297.

In an embodiment, processing a type of action within Events comprises deleting an object within an object dataset within SDS 290.

In an embodiment, when processing a type of action within Events that deletes a group object, a triggered action generates an additional row in Events for processing, having the same type of action, for each object that is a member of the group object.

In an embodiment, processing a type of action within Events comprises setting an attribute value of an object within an object dataset within SDS 290 to a value contained in the same row as the action within Events.

In an embodiment, when processing a type of action within Events that sets an attribute value of a group object, a triggered action generates an additional row in Events for processing, having the same type of action and attribute value, for each object that is a member of the group object. In the example illustrated in FIG. 9, RI [3] in Events dataset 291 sets the “Power” attribute value (i.e., “1”) of a group object (i.e., RI [2]) in Machine object dataset 297. Additional rows (i.e., RI [4] and RI [5]) are generated in Events dataset 291 that set the same attribute value of each object (i.e., RI [0] and RI [1]) in Machine object dataset 297 that is a member of the group object (i.e., RI [0] and RI [1] in Group Member object dataset 298Z).

In an embodiment, objects created, updated, and deleted by OEP 281 may include objects retrieved by OQP 283 to generate one or more resultsets which may represent a portable application framework or portable application.

In an embodiment, an object within an object dataset within an SDS that is updated by OEP 281 may represent the state of the machine on which OEP 281 resides.

In an embodiment, rows in Events processed by an OEP define an aggregate Trigger object.

In an embodiment, an aggregate Trigger object comprises an object in Trigger object dataset 296 (Trigger object) and one or more related child objects within Action object dataset 296A (Action object).

In an embodiment, a Trigger object comprises a type of condition that can be satisfied by elements in one or more rows in an Events dataset (i.e., a triggering event).

In an embodiment, an Action object comprises a type of action that is processed by an OEP when the condition of the parent Trigger object is satisfied (i.e., a triggered action).

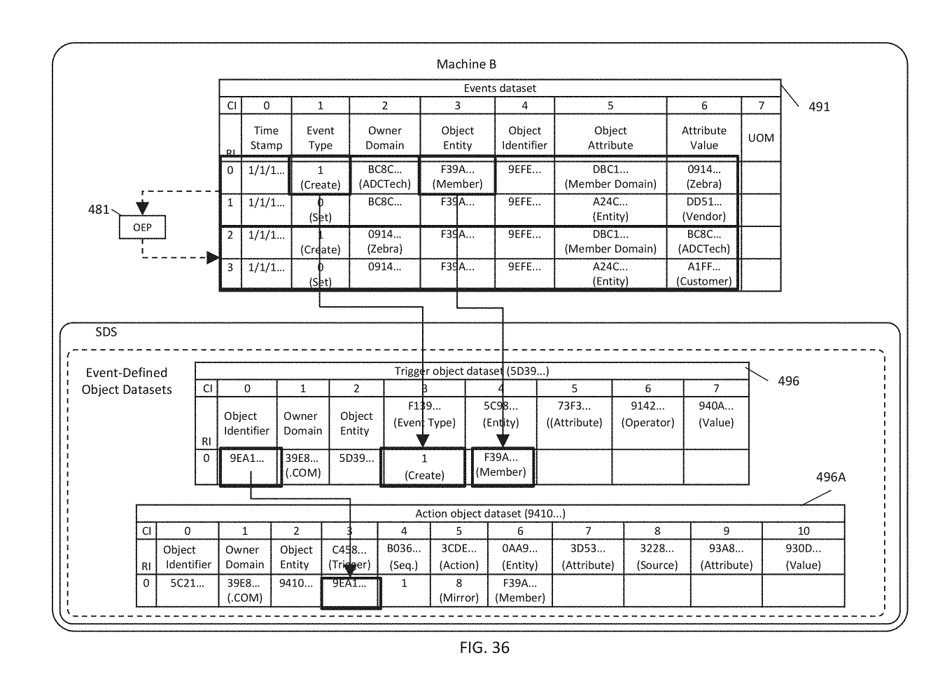

In an embodiment, OEP 481 references aggregate Trigger objects to trigger actions while processing Events, as illustrated in FIG. 36.

In an embodiment, processing a type of triggered action, upon creating or updating an Entity object (e.g., RI [3] in Entity object dataset 593), comprises creating an Attribute object (e.g., RI [0] in Attribute object dataset 593A) from the “Parent Entity” element value (e.g., index location [3][7]) of the Entity object as illustrated in FIG. 16. In at least one such embodiment, the “Related Entity” element value (e.g., index location [0][8]) of the new Attribute object is set to the value of the “Parent Entity” element of the Entity object.

In an embodiment, processing a type of triggered action comprises creating one or more additional rows in Events for processing.

In an embodiment, processing a type of triggered action comprises submitting the triggering event (e.g., Events 255) to a PAR for processing which may include, without limitation, complex event processing.

In an embodiment, processing a type of triggered action comprises processing queries (e.g., Queries 256) comprised within the Action object representing the triggered action.

In an embodiment, processing queries from a triggered action comprises invoking RVG 282 to process Queries 256 and return Payload 246 to OEP 281. In at least one such embodiment, OEP 281 appends a row within BEAM Payload 261 from the row in Payload 246.

In an embodiment, processing a type of triggered action comprises generating a row in Events that sets an attribute value derived from one or more attribute values of related objects within object datasets within SDS 290.

In an embodiment, processing a type of triggered action comprises generating rows (i.e., duplicated events) in Events for processing that define a duplicated aggregate object (e.g., aggregate Item object) from elements within rows in an Events that define an originating aggregate object of the same entity. In at least one such embodiment, the Object Identifier of each object within the duplicated aggregate object is set to a unique value that is different from the Object Identifier of each corresponding object within the originating aggregate object.

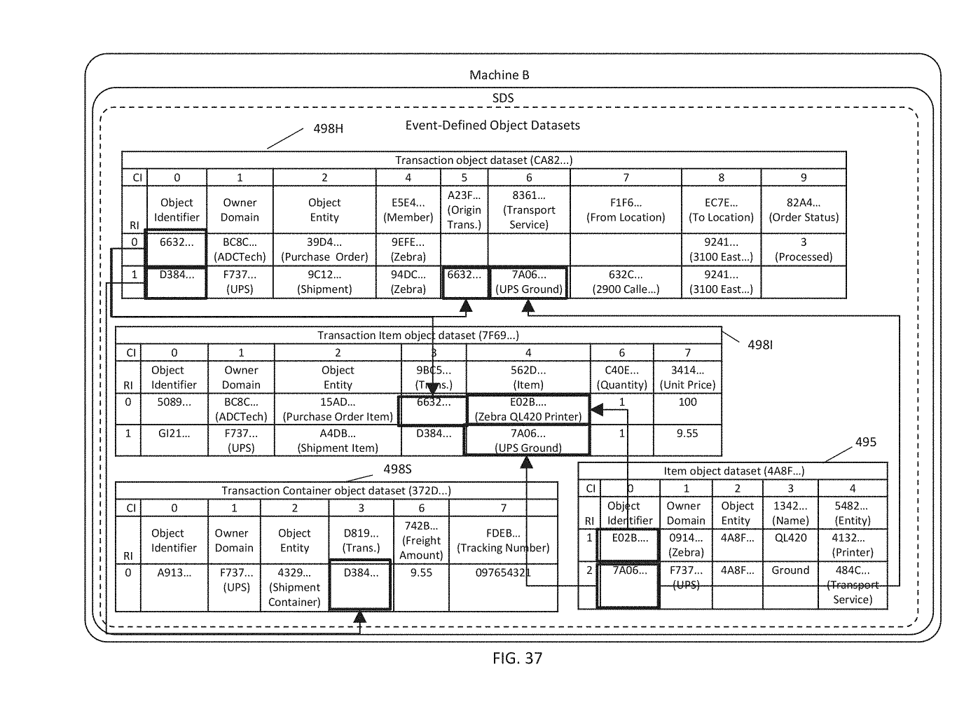

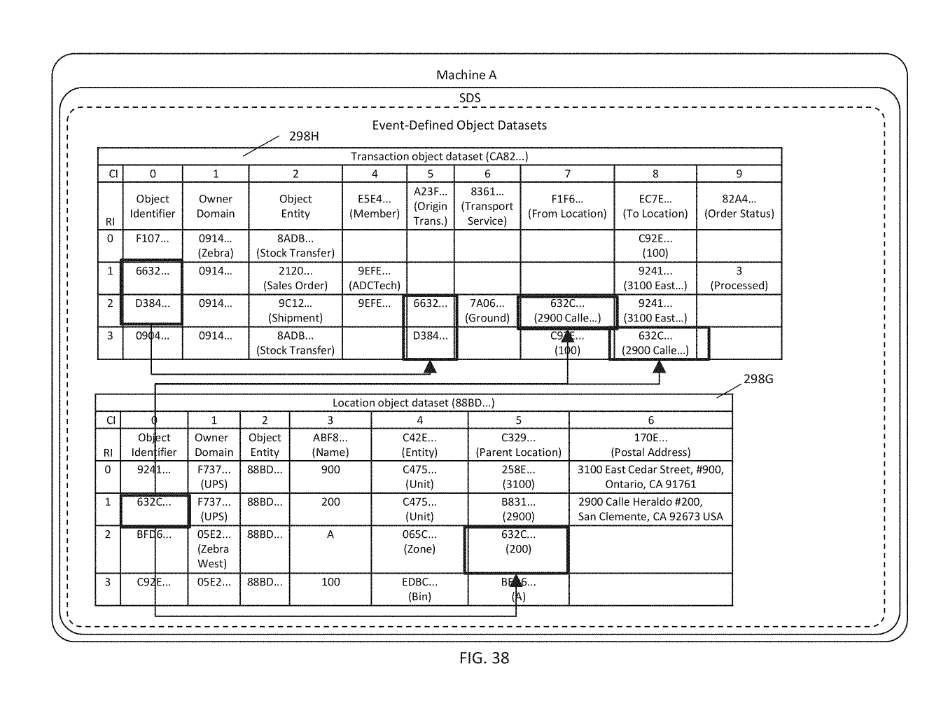

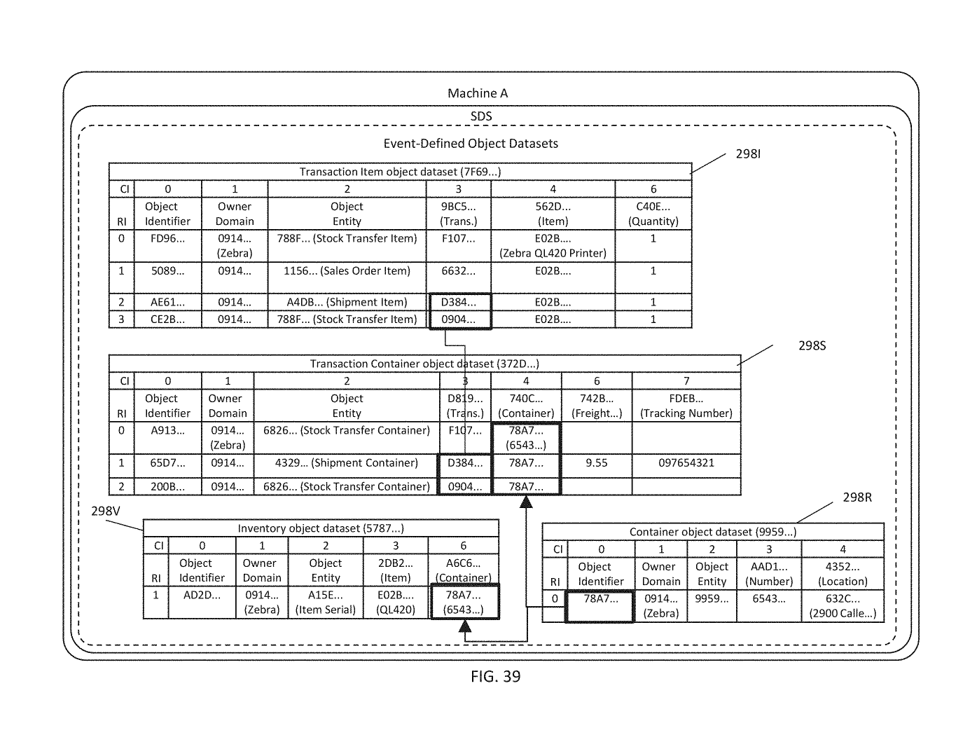

In an embodiment, processing a type of triggered action comprises generating rows (i.e., mirrored events) in Events for processing that define a mirrored aggregate object (e.g., aggregate Sales Order object) from elements within rows in Events that define an originating aggregate object (e.g., aggregate Purchase Order object). In at least one such embodiment, the Object Identifier of each object within the mirrored aggregate object (e.g., index location [1][0] in Transaction object dataset 298H in FIG. 38 and index location [1][0] in Transaction Item object dataset 298I in FIG. 39) is set to the Object Identifier of each corresponding object within the originating aggregate object (e.g., “6632 . . . ” at index location [0][0] in Transaction object dataset 498H in FIG. 37 and “5089 . . . ” at index location [0][0] in Transaction Item object dataset 498I in FIG. 37).

In an embodiment, processing a type of triggered action comprises generating a row in Events that updates an attribute value of a mirrored object (e.g., index location [1][9] within Transaction object dataset 298H in FIG. 38) from a triggering row in Events that updates a corresponding attribute value of the originating object of the mirrored object (e.g., “3” at index location [0][9] within Transaction object dataset 498H in FIG. 37).

In an embodiment, processing a type of triggered action comprises generating a row in Events that updates an attribute value of an originating object (e.g., index location [0][9] within Transaction object dataset 498H in FIG. 37) from a triggering row in Events that updates a corresponding attribute value of the mirrored object of the originating object (e.g., “3” at index location [1][9] within Transaction object dataset 298H in FIG. 38).

In an embodiment, Events processed by an OEP can define a relationship, represented by an originating Member object, between a first party and a second party. In at least one such embodiment, as illustrated in FIG. 36, a Domain object identified by the “Owner Domain” attribute value of the originating Member object (i.e., “BC8C . . . ” at index location [0][2] within Events dataset 491) represents the first party. A Domain object identified by the “Member Domain” attribute value of the originating Member object (i.e., “0914 . . . ” at index location [0][6] within Events dataset 491) represents the second party.

In an embodiment, processing a type of triggered action (e.g., RI [0] in Action object dataset 496A in FIG. 36) comprises generating rows (i.e., mirrored events) in Events (e.g., RI [2] and RI [3] within Events dataset 491) for processing that define a mirrored Member object from elements within rows in Events (e.g., RI [0] and RI [1] within Events dataset 491) that define the originating Member object. In at least one such embodiment, the “Owner Domain” attribute value of the mirrored Member object (i.e., index location [2][2] within Events dataset 491) is set to the Domain object identifier (i.e., “0914 . . . ”) of the second party. The “Member Domain” attribute value of the mirrored Member object (i.e., index location [2][6] within Events dataset 491) is set to the Domain object identifier (i.e., “BC8C . . . ”) of the first party. In at least one such embodiment, the “Entity” attribute value of the mirrored Member object (i.e., index location [3][6] within Events dataset 491) is set to the “Mirror Entity” attribute value of the Entity object (i.e., “A1FF . . . ” at index location [1][9] within Entity object dataset 593 illustrated in FIG. 14) identified by the “Entity” attribute value of the originating Member object (i.e., “DD51 . . . ” at index location [1][6] within Events dataset 491). In at least one such embodiment, one or more additional attribute values of the mirrored Member object may be set to the values of corresponding attributes of the originating Member object.

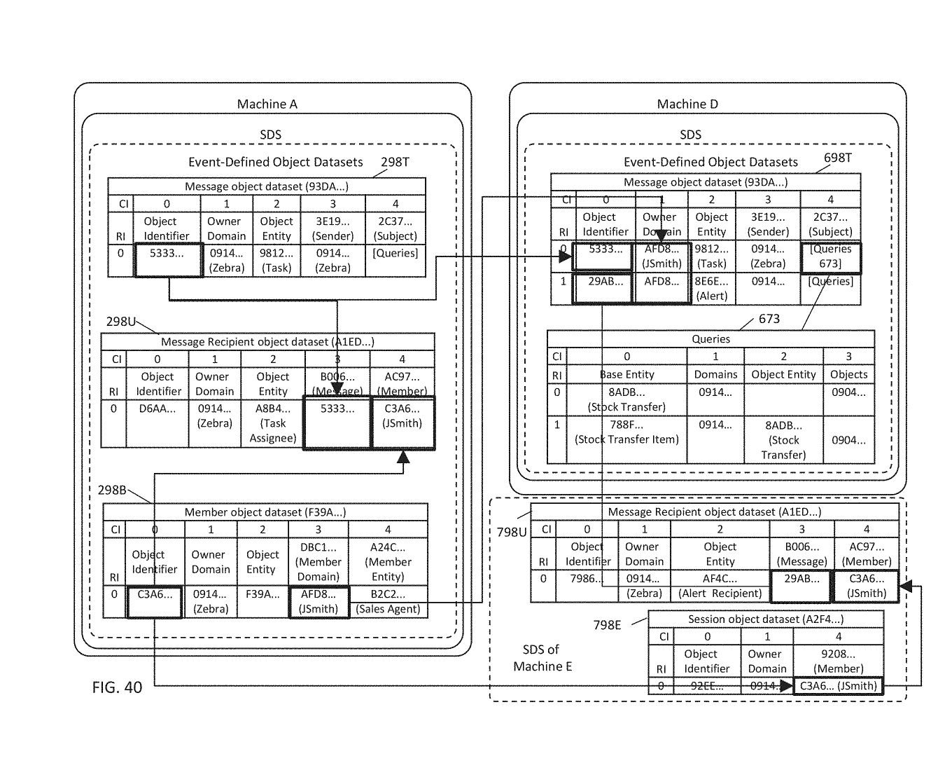

In an embodiment, Events processed by an OEP can define a type of email message, represented by an aggregate object (e.g., an aggregate Task object), exchanged between a first party and one or more second parties. In at least one such embodiment, as illustrated in FIG. 40, a parent Task object (e.g., RI [0] in Message object dataset 298T) and one or more related child Task Assignee objects (e.g., RI [0] in Message Recipient object dataset 298U) collectively form an originating aggregate Task object within a first machine (e.g., Machine A). In at least one such embodiment, the Domain object identified by the “Owner Domain” attribute value of the originating Task object (i.e., “0914 . . . ” at index location [0][1] within Message object dataset 298T) represents the first party. The Domain object identified by the “Member Domain” attribute value of a Member object (i.e., “AFD8 . . . ” at index location [0][3] within Member object dataset 298B) identified by the “Member” attribute value of a Task Assignee object (i.e., “C3A6 . . . ” at index location [0][4] within Message Recipient object dataset 298U) represents a second party.

In an embodiment, processing a type of triggered action comprises generating rows (i.e., mirrored events) in Events for processing that define one or more mirrored email messages (e.g., mirrored aggregate Task objects) from elements within rows in Events that define the originating email message (e.g., originating aggregate Task object). In one such embodiment, processing the mirrored events comprises transporting a subset of the mirrored events, as a statement within a BEAM Payload, to an OEP on a remote machine (e.g. Machine D) for processing. As an example of at least one such embodiment, as illustrated in FIG. 40, the subset of the mirrored events defines a mirrored Task object (as illustrated in RI [0] within Message object dataset 698T) on a remote machine (e.g., Machine D) from the rows in Events that define the originating Task object (e.g., RI [0] within Task object dataset 298T). In at least one such embodiment, the “Owner Domain” attribute value of the mirrored Task object (i.e., index location [0][1] within Message object dataset 698T) is set to the Domain object identifier (i.e., “AFD8 . . . ”) of the second party. In at least one such embodiment, one or more attribute values of the mirrored Task object (e.g., index location [0][3] within Message object dataset 698T) are set to the values of corresponding attributes of the originating Task object (e.g., “0914 . . . ” at index location [0][3] within Message object dataset 298T).

In an embodiment, Events processed by an OEP can define a type of business transaction, represented by an aggregate object (e.g., an aggregate Purchase Order object), between a first party and one or more second parties. In an example of at least one such embodiment, as illustrated in FIG. 37, a parent Purchase Order object (e.g., RI [0] within Transaction object dataset 498H) and one or more related child Transaction Item objects (e.g., RI [0] in Transaction Item object dataset 498I) collectively form an originating aggregate Purchase Order object within a first machine (e.g., Machine B). In at least one such embodiment, the Domain object identified by the “Owner Domain” attribute value of the Purchase Order object (i.e., “BC8C . . . ” at index location [0][1] within Transaction object dataset 498H) represents the first party. The Domain object identified by the “Member Domain” attribute value of a Member object (i.e., “0914 . . . ” at index location [0][6] within Events dataset 491 in FIG. 36) identified by the “Member” attribute value of the Purchase Order object (i.e., “9EFE . . . ” at index location [0][4] within Transaction object dataset 498H), represents a second party. In at least one such embodiment, the “Owner Domain” attribute value of the identified Member object matches the “Owner Domain” attribute value of the Purchase Order object that identifies the Member object (i.e., “BC8C . . . ” at index location [0][1] within Transaction object dataset 498H).

In an embodiment, processing a type of triggered action comprises generating rows in Events (i.e., mirrored events) for processing that define a mirrored business transaction (e.g., aggregate Sales Order object) from elements within rows in Events that define the originating business transaction (e.g., an aggregate Purchase Order object). In one such embodiment, processing the mirrored events comprises transporting the mirrored events, as a statement within a BEAM Payload, to an OEP on a remote machine (e.g. Machine A) for processing. As an example of at least one such embodiment, a subset of the mirrored events defines a Sales Order object (as illustrated in RI [1] of Transaction object dataset 298H in FIG. 38) on the remote machine (e.g., Machine A) from the rows in Events that define the originating Purchase Order object (as illustrated in RI [0] of Transaction object dataset 498H in FIG. 37).

In at least one such embodiment, the “Owner Domain” attribute value of the Sales Order object (i.e., index location [1][1] within Transaction object dataset 298H in FIG. 38) is set to the Domain object identifier (i.e., “0914 . . . ”) of the second party.

In at least one such embodiment, the “Owner Domain” attribute value of a mirrored Shipment object (i.e., index location [1][1] within Transaction object dataset 498H in FIG. 37) is set to the “Owner Domain” attribute value of an Item object (i.e., “F737 . . . ” at index location [2][1] within Item object dataset 495 in FIG. 37), representing a type of service performed by a party (i.e., service item), that is identified by an attribute value of an originating Shipment object (i.e., “7A06 . . . ” at index location [2][6] within Transaction object dataset 298H in FIG. 38). In at least one such embodiment, a triggered action generates events that define a child Shipment Item object of the mirrored Shipment object that represents the service item (e.g., RI [1] in Transaction Item object dataset 498I).

In at least one such embodiment, the “Object Entity” attribute value of the Sales Order object (i.e., index location [1][2] within Transaction object dataset 298H in FIG. 38) is set to the “Mirror Entity” attribute value of the Entity object (i.e., “2120 . . . ” at index location [2][9] within Entity object dataset 593 illustrated in FIG. 16) identified by the “Object Entity” attribute value of the Purchase Order object (i.e., “39D4 . . . ” at index location [0][2] within Transaction object dataset 498H in FIG. 37).

In at least one such embodiment, one or more additional attribute values of the Sales Order object (e.g., index location [1][8] within Transaction object dataset 298H in FIG. 38) may be set to the values of corresponding attributes of the Purchase Order object (e.g., “9241 . . . ” at index location [0][8] within Transaction object dataset 498H in FIG. 37).

In at least one such embodiment, a subset of the mirrored events defines one or more Sales Order Item objects (as illustrated in RI [1] of Transaction Item object dataset 298I in FIG. 39) on the remote machine (e.g., Machine A) from the rows in Events that define one or more Purchase Order Item objects (as illustrated in RI [0] of Transaction object dataset 498I in FIG. 37). One or more attribute values of each Sales Order Item object (e.g., index location [1][4] within Transaction Item object dataset 298I in FIG. 39) are set to the values of corresponding attributes of each Purchase Order Item object (e.g., “E02B . . . ” at index location [0][4] within Transaction Item object dataset 498I in FIG. 37).

In an embodiment, one or more child objects (e.g., Purchase Order Item objects) related to a business transaction (e.g., Purchase Order object) each represent a trade item that is traded between the first party and the second party. As an example of at least one such embodiment, as illustrated in FIG. 37, the “Transaction” attribute value of a Purchase Order Item object (e.g., index location [0][3] in Transaction Item object dataset 498I) is set to the Object Identifier of the parent Purchase Order object (i.e., “6632 . . . ” at index location [0][0] within Transaction object dataset 498H). The “Item” attribute value of a Purchase Order Item object (e.g., index location [0][4] in Transaction Item object dataset 498I) is set to the Object Identifier of an Item object representing a trade item (i.e., “E02B . . . ” at index location [0][0] within Item object dataset 495).

In an embodiment, the party that initially trades the trade item (i.e., owning party) is represented by the Domain object that is identified by the “Owner Domain” attribute value of an Item object.

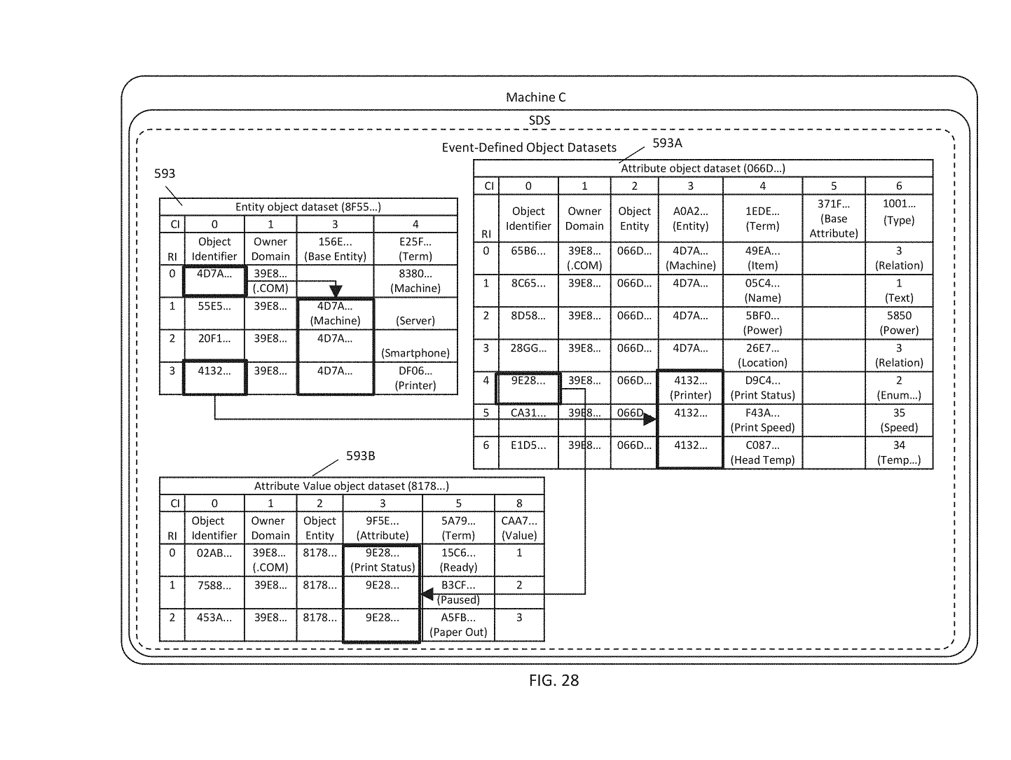

In an embodiment, the type of trade item is represented by an “Entity” attribute value of the Item object (e.g., index location [1][4] within Item object dataset 495 in FIG. 37) which is set to the Object Identifier of an Entity object (e.g., “4132 . . . ” at index location [3][0] within Entity object dataset 593 in FIG. 28). In at least one such embodiment, a type of trade item, represented by an Entity object, can include, without limitation, a manufactured product or machine, business service, and data subscription service traded by a party. In at least one such embodiment, the Item object represents the owning party's unique model of the type of trade item (e.g., Zebra QL420 Printer).

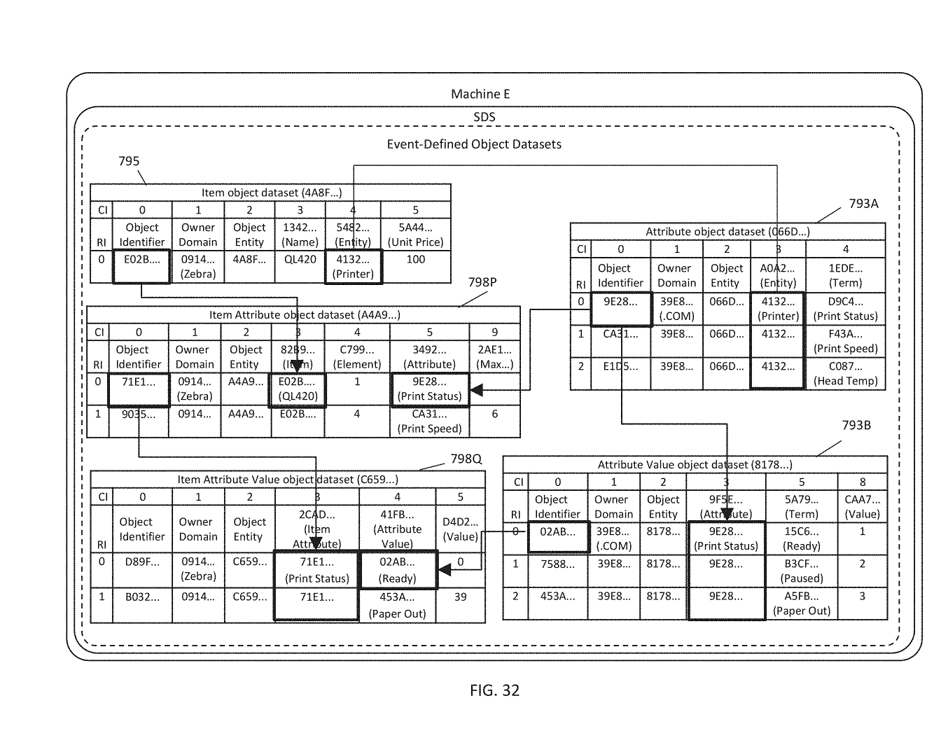

In at least one such embodiment, the unique model of the type of trade item is represented by one or more child Item Attribute objects related to a parent Item object. As an example of at least one such embodiment, as illustrated in FIG. 32, a parent Item object (i.e., RI [0]0 in Item object dataset 795) has a related child Item Attribute object (i.e., RI [0] within Item Attribute dataset 798P) that is related to a child Attribute object (i.e., RI [0] within Attribute dataset 793A) related to a parent Entity object identified by the “Entity” attribute value of the Item object (i.e., “4132 . . . ” at index location [0][4] within Item dataset 795). In at least one such embodiment, one or more attribute values of the Item Attribute object (e.g., “1” at index location [0][4] within Item Attribute dataset 798P) define characteristics specific to the Item object, as a unique model of an Entity object.

In an embodiment, an Item object represents a unique model of a type of machine. In at least one such embodiment, a production unit of the Item object (i.e., machine) is represented by a Machine object and supplemental object (e.g., Printer object) corresponding to the type of machine.

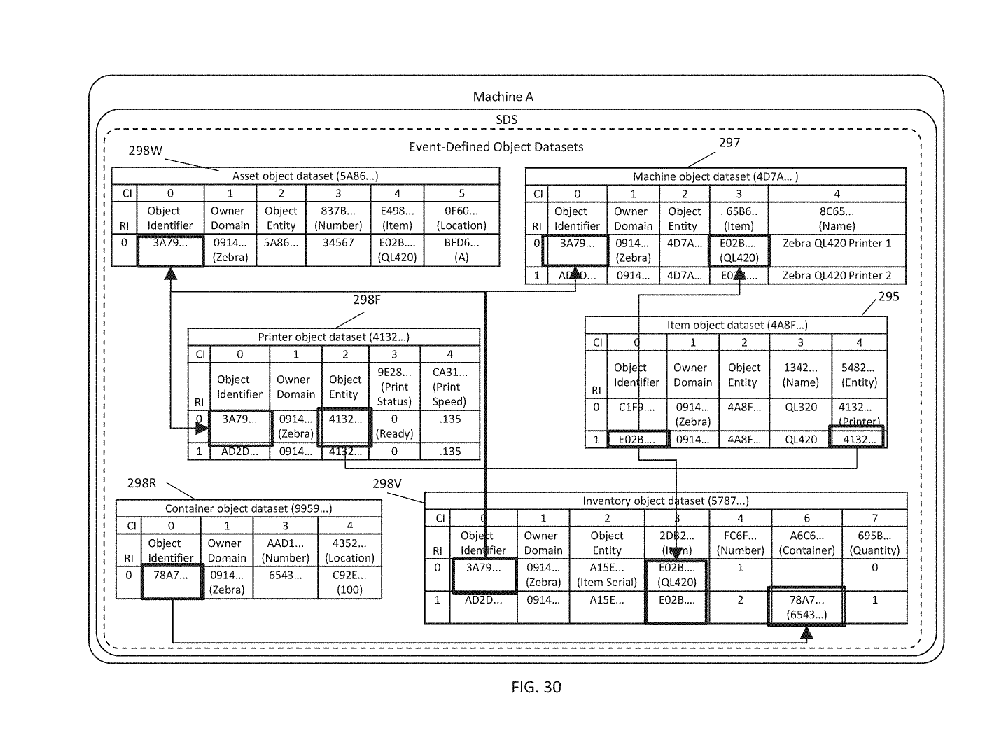

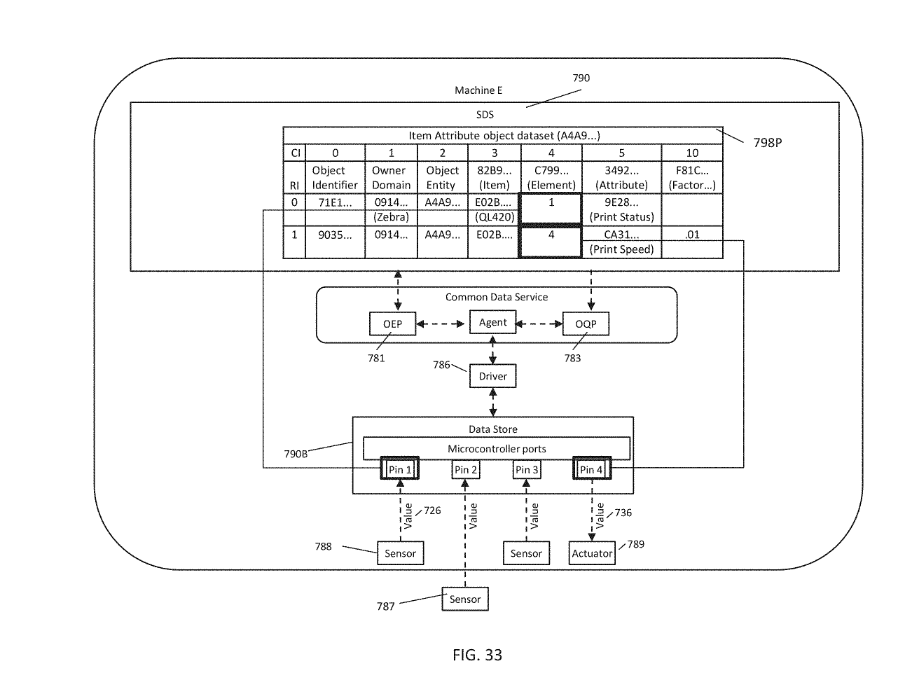

In an embodiment, attribute values of the Machine object and supplemental object correspond to settings of port pins within one or more microcontrollers on the machine. In at least one such embodiment, as illustrated in FIG. 33, a driver 786 on the machine represented by the Machine object, while processing a row in Events that updates an attribute value of the Machine object or supplemental object, will change the state (i.e., Value 736) of the corresponding port pin within a microcontroller on the machine. In an embodiment, the corresponding port pin (e.g., Pin 4) is defined by an attribute value of an Item Attribute object (e.g., “4” at index location [1][4] in Item Attribute object dataset 798P) related to the Item object (e.g., RI [1] in Item object dataset 295 in FIG. 30) related to the Machine object (e.g., RI [0] in Machine object dataset 297 in FIG. 30).

In an embodiment, processing a type of triggered action comprises generating rows in Events (i.e., derived events) for processing that define a type of business transaction (e.g., derived aggregate Shipment object) from elements within rows in Events that define another type of business transaction (e.g., an aggregate Sales Order object). In an example of at least one such embodiment, as illustrated in FIG. 38, a subset of the derived events defines a Shipment object (RI [2] of Transaction object dataset 298H) from the rows in Events that define a Sales Order object (RI [1] of Transaction object dataset 298H).

In at least one such embodiment, the “Owner Domain” attribute value of the Shipment object (i.e., index location [2][1] within Transaction object dataset 298H) is set to the “Owner Domain” attribute value of the Sales Order object (i.e., “0914 . . . ” at index location [1][1] within Transaction object dataset 298H).

In at least one such embodiment, the “Entity” attribute value of the Shipment object (i.e., index location [2][2] within Transaction object dataset 298H) is set to the “Entity” attribute value of the triggered Action object (i.e., “9C12 . . . ” at index location [3][6] within Trigger Action object dataset illustrated in Table 23).

In at least one such embodiment, the “Origin Transaction” attribute value of the Shipment object (i.e., index location [2][5] within Transaction object dataset 298H) is set to the Object Identifier of the Sales Order object (i.e., “6632 . . . ” at index location [1][0] within Transaction object dataset 298H).

In at least one such embodiment, one or more attribute values of the Shipment object (e.g., index location [2][8] within Transaction object dataset 298H) are set to the values of corresponding attributes of the Sales Order object (e.g., “9241 . . . ” at index location [1][8] within Transaction object dataset 298H). In at least one such embodiment, a corresponding attribute comprises an attribute object identified by the “Base Attribute” attribute value of an attribute object related to the entity of the originating object (e.g. “EC7E . . . ” at index location [2][5] in Attribute object dataset 593A in FIG. 16) that is also identified by the “Base Attribute” attribute value of an attribute object related to the entity of the derived object (e.g. “EC7E . . . ” at index location [3][5] in Attribute object dataset 593A in FIG. 16).

In an embodiment, processing a type of triggered action comprises generating a row in Events that updates an attribute value of an originating object (e.g., index location [1][8] within Transaction object dataset 298H in FIG. 38) from a triggering row in Events that updates a corresponding attribute value of a derived object related to the originating object (e.g., “9241 . . . ” at index location [2][8] within Transaction object dataset 298H in FIG. 38).

In an embodiment, when processing rows in Events generated from triggered actions (i.e., triggered events), OEP generates a row in a Payload 261 that comprises the triggered events that comprise the same “Owner Domain” attribute value, and where the data store of the Domain identified by the same “Owner Domain” attribute value is on a remote machine (e.g., machine 300). In at least one such embodiment, the OEP invokes agent 210 to transport the Payload 261 to the agent on the remote machine (e.g., agent 310 on machine 300).

In an embodiment, processing a type of triggered action comprises invoking PAR 284 to process one or more events (e.g., Events 255).

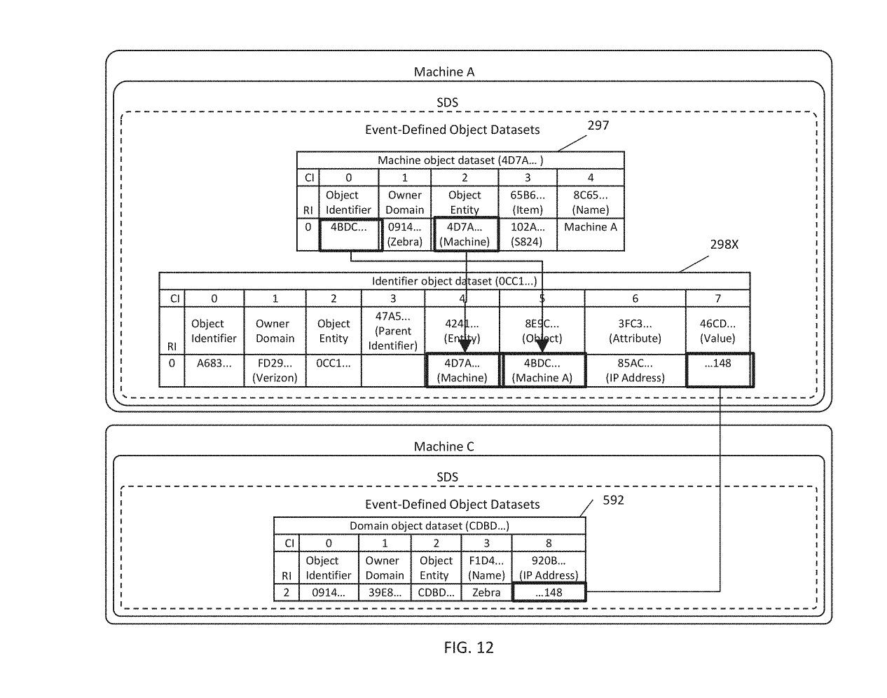

In an embodiment, OEP 281 may convert an alternate identifier in an “Object Identifier” element in Events dataset 271 to an object identifier by referencing a related object in Identifier object dataset 298X. In at least one such embodiment, as illustrated in FIG. 12, the “Value” attribute value (e.g., “ . . . 148”) of an Identifier object (e.g., RI [0] in Identifier object dataset 298X) comprises the alternate identifier and the “Object” attribute value (e.g., “4BDC . . . ”) of the same Identifier object comprises the object identifier.

In an embodiment, OEP 281 may convert an alternate identifier in an “Object Attribute” element in Events dataset 271, originated from Driver 286, to an object identifier of an Attribute object by referencing a related object in Item Attribute object dataset 298P. In at least one such embodiment, as illustrated in FIG. 33, the “Element” attribute value (e.g., “4”) of an Item Attribute object (e.g., RI [1] in Item Attribute object dataset 298P) comprises the alternate identifier and the “Attribute” attribute value (e.g., “CA31 . . . ”) of the same Item Attribute object comprises the object identifier.

In an embodiment, OEP 281 may convert an object identifier in an “Object Attribute” element in Events dataset 271, to be submitted to Driver 286, to an alternate identifier by referencing a related object in Item Attribute object dataset 298P. In at least one such embodiment, as illustrated in FIG. 33, the “Element” attribute value of an Item Attribute object (e.g., RI [1] in Item Attribute object dataset 298P) comprises the alternate identifier and the “Attribute” attribute value of the same Item Attribute object comprises the object identifier.

In an embodiment, OEP 281 may convert an alternate value in an “Attribute Value” element in Events dataset 271, originating from Driver 286, to an enumerated value by referencing a related object in Item Attribute Value object dataset 298Q. In at least one such embodiment, as illustrated in FIG. 29, the “Value” attribute value (e.g., “39”) of an Item Attribute Value object (e.g., RI [1] in Item Attribute Value object dataset 298Q) comprises the alternate identifier and the “Value” attribute value (e.g., “3”) of an Item Attribute object (e.g., RI [2] in Item Attribute object dataset 293B) related to the Item Attribute Value object comprises the enumerated value.

In an embodiment, OEP 281 may convert an enumerated value in an “Attribute Value” element in Events dataset 271, to be submitted to Driver 286, to an alternate identifier by referencing a related object in Item Attribute Value object dataset 298Q. In at least one such embodiment, as illustrated in FIG. 29, the “Value” attribute value (e.g., “39”) of an Item Attribute Value object (e.g., RI [1] in Item Attribute Value object dataset 298Q) comprises the alternate identifier and the “Value” attribute value (e.g., “3”) of an Item Attribute object (e.g., RI [2] in Item Attribute object dataset 293B) related to the Item Attribute Value object comprises the enumerated value.

### 7. Example Embodiment of a Rendered View Generator

The following description illustrates a non-limiting embodiment of a Rendered View Generator (RVG), as a resource of a machine. FIG. 3 illustrates the relationships between an RVG 282, an agent 210, an object event processor 281, as a type of resource, and an object query processor 283, as a type of resource, according to an embodiment.

In an embodiment, agent 210 invokes RVG 282 to process Queries 272 included in a statement in a row within a BEAM Payload (e.g., BEAM Payload 415) and RVG 282 returns, as a response to agent 210, Payload 262 that comprises a rendered view as a statement.

In an embodiment, OEP 281 invokes RVG 282 to process Queries 256 and RVG 282 returns, as a response to OEP 281, Payload 246 that comprises a rendered view as a statement.

In an embodiment, RVG 282 invokes OQP 283 to process Queries 257 (derived from Queries 272 or Queries 256) and OQP 283 returns Resultsets 247 as a response to RVG 282.

In an embodiment, RVG 282 generates a rendered view (e.g., Rendered View 276A as illustrated in FIG. 43) by processing elements within queries (e.g., Queries 257 as illustrated in FIG. 42) and corresponding query resultsets (e.g., Resultsets 247 as illustrated in FIG. 42).

### 8. Example Embodiment of an Object Query Processor

The following description illustrates a non-limiting embodiment of an Object Query Processor (OQP), as a resource of a machine. FIG. 3 illustrates the relationships between an OQP 283, an agent 210, a rendered view generator 282, as a type of resource, a session manager 285, as a type of resource, and a structured data store 290, according to an embodiment.

In an embodiment, agent 210 invokes OQP 283 to process Queries 273 included in a statement in a row within a BEAM Payload (e.g., BEAM Payload 415). OQP 283 returns Resultsets 263 as a response to agent 210.

In an embodiment, RVG 282 invokes OQP 283 to process Queries 257 and OQP 283 returns Resultsets 247 as a response to RVG 282.

In an embodiment, OQP 283 generates a row in a Resultsets (e.g., Resultsets 247) for each row in a queries dataset (e.g., Queries 257) as illustrated in FIG. 42.

In an embodiment, each row in a Resultsets (e.g., Resultsets 247) comprises attribute values (e.g., Shipment Container values 247A illustrated in FIG. 42) derived from objects within object datasets within SDS 290 that are identified within the corresponding row within a Queries dataset (e.g., Queries 257).

In an embodiment, each row in a Resultsets (e.g., Resultsets 247) comprises attribute values (e.g., Shipment Container values 247A illustrated in FIG. 42) derived from elements in Events dataset 291 within SDS 290 that define objects that are identified within the corresponding row within a Queries dataset (e.g., Queries 257).

In an embodiment, a row in a Resultsets (e.g., Resultsets 247) comprises human-readable terms (e.g., Shipment Container terms 247B illustrated in FIG. 42), derived from objects within object datasets within SDS 290, corresponding to attributes that are identified within the corresponding row within a Queries dataset (e.g., Queries 257).

In an embodiment, resultsets generated by OQP 283 from queries may include elements that represent the state of machine 200.

In an embodiment, resultsets generated by OQP 283 from queries may represent a portable application or portable application framework.

In an embodiment, Queries processed by OQP 283 can be generated from resultsets generated by OQP 283 that incorporate elements from related objects in View object dataset 298A, View Entity object dataset 298L, View Element object dataset 298M, and View Condition object dataset 298N in SDS 290, as illustrated in FIG. 41.

In an embodiment, resultsets generated by OQP 283 can be limited to objects comprising an “Owner Domain” attribute value that matches the identifier of the Domain object related to the current session.

In an embodiment, resultsets generated by OQP 283 can be limited to objects comprising an attribute value that matches the identifier of the Member object related to the current session.

In an embodiment, one or more attribute values within resultsets generated by OQP 283 may each comprise a queries dataset that can be processed by an OQP.

### 9. Example Embodiment of a Portable Application Runtime

The following description illustrates a non-limiting embodiment of a Portable Application Runtime (PAR), as a resource of a machine. FIG. 3 illustrates the relationships between an PAR 284, an agent 210, an object event processor 281, as a type of resource, and a structured data store 290, according to an embodiment.

In an embodiment, agent 210 invokes PAR 284 to process a type of statement.

In an embodiment, processing a type of statement by PAR 284 comprises retrieving the current state of a portable application framework and portable application (i.e., runtime state) from the Runtime dataset 299 within SDS 290, as illustrated in FIG. 6, and returning the runtime state as a response to agent 210.

In an embodiment, processing a type of statement by PAR 284 comprises retrieving the runtime state from the Runtime dataset 299 within SDS 290 and processing the retrieved runtime state to generate Payload 264.

In an embodiment, processing a type of statement by PAR 284 comprises changing the retrieved runtime state.

In an embodiment, processing a type of statement by PAR 284 comprises storing the changed runtime state to the Runtime dataset 299 within SDS 290.

In an embodiment, processing a type of statement by PAR 284 comprises generating Events within the runtime state and sending the Events to agent 210 as a statement within a row of Payload 264.

In an embodiment, processing a type of statement by PAR 284 comprises generating Queries within the runtime state and sending the Queries to agent 210 as a statement within a row of Payload 264.

In an embodiment, Queries generated by PAR 284 comprise Entity and Attribute object identifiers from the portable application within the runtime state.

In an embodiment, Queries generated by PAR 284 comprise Entity and Attribute object identifiers from the portable application framework within the runtime state.

In an embodiment, agent 210 invokes an object query processor (e.g., OQP 283) to process the Queries (e.g., Queries 273) generated by PAR 284 and returns the resultsets (e.g., Resultsets 263) generated by the object query processor to PAR 284, as Resultsets 274, for processing.

In an embodiment, Resultsets 274 returned to PAR 284 in response to Queries generated by PAR 284 are incorporated by PAR 284 into its runtime state.

In an embodiment, Resultsets 274 returned to PAR 284 in response to Queries generated by PAR 284 comprise datasets that represent a portable application.

In an embodiment, Resultsets 274 returned to PAR 284 in response to Queries generated by PAR 284 comprise datasets that represent a portable application framework.

In an embodiment, Resultsets 274 returned to PAR 284 in response to Queries generated by PAR 284 comprise datasets that are processed by PAR 284 to generate a second Queries that is sent to agent 210 as a statement within a row of Payload 264.

In an embodiment, processing a type of statement by PAR 284 comprises generating a View within its runtime state and sending the View to agent 210 as a statement within a row of Payload 264.

In an embodiment, generating a View by PAR 284 comprises generating Queries within the runtime state and sending the Queries to agent 210 as a statement within a row of Payload 264, and incorporating into the View certain elements of the Queries and Resultsets 274 returned to PAR 284 in response to the Queries.

In an embodiment, a type of statement processed by PAR 284 can represent a user event or machine event.

In an embodiment, a type of statement processed by PAR 684 originates from an event within a user interface (e.g., interface 686A illustrated in FIG. 26) that was generated from a View (e.g., Rendered View 676) generated by PAR 684.

In an embodiment, Events generated by PAR 684 (e.g., Events dataset 691 generated by PAR 684 illustrated in FIG. 26) comprise Entity and Attribute object identifiers from the portable application within the runtime state paired with attribute values entered on a user interface (e.g., interface 686A illustrated in FIG. 26) that was generated from a View generated by PAR 684.

In an embodiment, OEP 281 invokes PAR 284 to process Events 255.

In an embodiment, processing Events 255 by PAR 284 comprises updating its runtime state from elements in Events 255.

In an embodiment, processing Events 255 by PAR 284 comprises triggering an action that generates Payload 264 from elements in its runtime state and invoking agent 210 to process Payload 264.

Example Embodiment of a Session Manager

The following description illustrates a non-limiting embodiment of a Session Manager (SM), as a resource of a machine. FIG. 3 illustrates the relationships between a SM 285, an agent 210, an object event processor 281, as a type of resource, and an object query processor 283, as a type of resource, according to an embodiment.

In an embodiment, agent 210 invokes SM 285 to process Credentials 275 included in a row within a BEAM Payload (e.g., BEAM Payload 415). SM 285 returns a type of response (e.g., Session 265) to agent 210.

In an embodiment, processing Credentials 275 by SM 285 comprises generating Queries 258 and sending Queries 258 to OQP 283, and generating a type of response based on the elements within Resultsets 248 returned to SM 285 in response to Queries 258.

In an embodiment, Queries 258 generated by SM 285 comprises elements from Credentials 275.

In an embodiment, Queries 258 generated by SM 285 comprises Entity and Attribute object identifiers related Session object dataset 298E.

In an embodiment, processing Credentials 275 by SM 285 comprises, based on the elements within Resultsets 248 returned to SM 285, generating Events defining a new Session object and sending the Events to OEP 281 for processing.

In an embodiment, a type of response generated by Credentials 275 and returned to agent 210 comprises the object identifier, as Session 265, of a new Session object (i.e., current session) generated as Events by SM 285.

In an embodiment, a type of response generated by Credentials 275 and returned to agent 210 comprises a Status 265 that represents a type of invalidity of Credentials 275.

### 11. Example Embodiment of Metadata Objects within a Structured Data Store

The following description illustrates a non-limiting embodiment of metadata object datasets that are defined from the Events dataset within a structured data store. The Events dataset comprises object identifiers within these metadata object datasets to provide common semantics for data exchange between a plurality of machines.

In an embodiment, Entity object dataset 293 can comprise the objects illustrated in Table 19.

TABLE 19
Entity object dataset (8F55 . . . )

| Object | 156E . . . | E25F . . . | 28C9 . . . |
|---|---|---|---|
| Identifier | (Base Entity) | (Term) | (Parent Entity) |
| 8E6E . . . | 93DA . . . | E151 . . . (Alert) | |
| | (Message) | | |
| AF4C . . . | A1ED . . . | E695 . . . (Alert | 524F . . . (Alert) |
| | (Message | Recipient) | |
| | Recipient) | | |
| 5AB6 . . . | | 65C5 . . . (Asset) | |
| EDBC . . . | 88BD . . . | 960A . . . (Bin) | |
| | (Location) | | |
| 9959 . . . | | AD8A . . . (Container) | |
| 8903 . . . | 5787 . . . | 0BA3 . . . (Container | 9959 . . . (Container) |
| | (Inventory) | Item) | |
| 236F . . . | CDBD . . . | 3A8C . . . (Contact) | |
| | (Domain) | | |
| B868 . . . | 88BD . . . | 7406 . . . (City) | |
| | (Location) | | |
| 7991 . . . | 88BD . . . | BE05 . . . (County) | |
| | (Location) | | |
| 7991 . . . | 88BD . . . | 2932 . . . (Country) | |
| | (Location) | | |
| A1FF . . . | CDBD . . . | D31E . . . (Customer) | |
| | (Domain) | | |
| D6D2 . . . | CA82 . . . | 16BD . . . (Customer | |
| | (Transaction) | Payment) | |
| CDBD . . . | | 4B6A . . . (Domain) | |
| E5BC . . . | 6C7A . . . (Term) | 4542.. (English) | |
| 8F55 . . . | | 5967 . . . (Entity) | |
| 066D . . . | | 114B . . . (Entity | 8F55 . . . (Entity) |
| | | Attribute) | |
| 8178 . . . | | 548C . . . (Attribute | 066D . . . (Entity |
| | | Value) | Attribute) |
| 2C8D . . . | | B243 . . . (Entity View) | 8F55 . . . (Entity) |
| C7E4 . . . | | DEFD . . . (View | 2C8D . . . (Entity View) |
| | | Condition) | |
| E99D . . . | | 9228 . . . (View Element) | 2C8D . . . (Entity View) |
| BEB0 . . . | | 251B . . . (View Entity) | 2C8D . . . (Entity View) |
| 668D . . . | | JJ3K . . . (Group | |
| | | Member) | |
| 0CC1 . . . | | 8FD0 . . . (Identifier) | |
| 5787 . . . | | 2205 . . . (Inventory) | |
| 4A8F . . . | | 49EA . . . (Item) | |
| A4A9 . . . | | ECA8 . . . (Item | 48AF . . . (Item) |
| | | Attribute) | |
| C659 . . . | | 32DE . . . (Item Attribute | A4A9 . . . (Item Attribute) |
| | | Value) | |
| 8D55 . . . | | 29DE . . . (Item Entity) | 48AF . . . (Item) |
| 648A . . . | 5787 . . . | E0A3 . . . (Item | 48AF . . . (Item) |
| | (Inventory) | Location) | |
| B180 . . . | 5787 . . . | 8307 . . . (Item Lot) | 48AF . . . (Item) |
| | (Inventory) | | |
| A15E . . . | 5787 . . . | 10FD . . . (Item Serial) | 48AF . . . (Item) |
| | (Inventory) | | |
| 88BD . . . | | 26E7 . . . (Location) | |
| 4D7A . . . | | 8380 . . . (Machine) | |
| F39A . . . | | CCE5 . . . (Member) | |
| 15C3 . . . | | 4530 . . . (Member | CCE5 . . . (Member) |
| | | Service) | |
| 93DA . . . | | FD58 . . . (Message) | |
| A1ED . . . | | CD13 . . . (Message | 93DA . . . (Message) |
| | | Recipient) | |
| ADB9 . . . | CDBD . . . | 767C . . . (Ontologist) | |
| | (Domain) | | |
| 4132 . . . | 4D7A . . . | DF06 . . . (Printer) | |
| | (Machine) | | |
| CAAD . . . | CA82 . . . | 4E85 . . . (Purchase | |
| | (Transaction) | Invoice) | |
| 009F . . . | 7F69 . . . | D1EF . . . (Purchase | CAAD . . . (Purchase |
| | (Transaction | Invoice Item) | Invoice) |
| | Item) | | |
| 39D4 . . . | CA82 . . . | 1EFD . . . (Purchase | |
| | (Transaction) | Order) | |
| 15AD . . . | 7F69 . . . | 1BEC . . . (Purchase | 39D4 . . . (Purchase |
| | (Transaction | Order Item) | Order) |
| | Item) | | |
| B2C2 . . . | CDBD . . . | 4884 . . . (Sales Agent) | |
| | (Domain) | | |
| 751F . . . | CA82 . . . | F0F6 . . . (Sales Invoice) | |
| | (Transaction) | | |
| 65BE . . . | 7F69 . . . | 7055 . . . (Sales Invoice | 751F . . . (Sales Invoice) |
| | (Transaction | Item) | |
| | Item) | | |
| 2120 . . . | CA82 . . . | 578E . . . (Sales Order) | |
| | (Transaction) | | |
| 1156 . . . | 7F69 . . . | A065 . . . (Sales Order | 2120 . . . (Sales Order) |
| | (Transaction | Item) | |
| | Item) | | |
| 55E5 . . . | 4D7A . . . | 014D . . . (Server) | |
| | (Machine) | | |
| A2F4 . . . | | 5B6E . . . (Session) | |
| AC7C . . . | | ED54 . . . (Session | 5B6E . . . (Session) |
| | | Event) | |
| 9C12 . . . | CA82 . . . | BD64 . . . (Shipment) | |
| | (Transaction) | | |
| 4329 . . . | 372D . . . | 1D85 . . . (Shipment | 9C12...(Shipment) |
| | (Transaction | Container) | |
| | Container) | | |
| A4DB . . . | 7F69 . . . | A182 . . . (Shipment | 9C12...(Shipment) |
| | (Transaction | Item) | |
| | Item) | | |
| 20F1 . . . | 4D7A . . . | DD88...(Smartphone) | |
| | (Machine) | | |
| ACF9 . . . | 6C7A . . . (Term) | 7321...(Spanish) | |
| A32E . . . | 88BD . . . | BF4D...(State) | |
| | (Location) | | |
| 8ADB . . . | CA82 . . . | AD44 . . . (Stock | |
| | (Transaction) | Transfer) | |
| 6826 . . . | 372D . . . | 51B9 . . . (Stock Transfer | 8ADB . . . (Stock |
| | (Transaction | Container) | Transfer) |
| | Container) | | |
| 788F . . . | 7F69 . . . | 6B99 . . . (Stock Transfer | 8ADB . . . (Stock |
| | (Transaction | Item) | Transfer) |
| | Item) | | |
| 3A84 . . . | 88BD . . . | 1D6D . . . (Street) | |
| | (Location) | | |
| B9A1 . . . | 88BD . . . | 7BD2 . . . (Street | |
| | (Location) | Number) | |
| F3D7 . . . | | 8DA5 . . . (Subscription) | |
| 9812 . . . | 93DA . . . | 4423 . . . (Task) | |
| | (Message) | | |
| A8B4 . . . | A1ED . . . | C632 . . . (Task | 9812...(Task) |
| | (Message | Assignee) | |
| | Recipient) | | |
| 6C7A . . . | | E0FE . . . (Term) | |
| CA82 . . . | | 3FB9 . . . (Transaction) | |
| 372D . . . | | EE13 . . . (Transaction | CA82 . . . (Transaction) |
| | | Container) | |
| 7F69 . . . | | 18F8 . . . (Transaction | |
| | | Item) | |
| 5D39 . . . | | 6A6F . . . (Trigger) | |
| 9410 . . . | | 03A8 . . . (Trigger | 5D39 . . . (Trigger) |
| | | Action) | |
| CAC4 . . . | | 300D . . . (Unit of | |
| | | Measure) | |
| DD51 . . . | CDBD . . . | 268C . . . (Vendor) | |
| | (Domain) | | |
| 2847 . . . | CA82 . . . | BC9E . . . (Vendor | |
| | (Transaction) | Payment) | |
| 065C . . . | 88BD . . . | 4928 . . . (Zone) | |
| | (Location) | | |

In an embodiment, Attribute object dataset 293A can comprise the objects illustrated in Table 20.

TABLE 20
Attribute object dataset (066D . . . )

| Object | A0A2 . . . | 1EDE . . . | 1001 . . . |
|---|---|---|---|
| Identifier | (Entity) | (Term) | (Type) |
| 837B . . . | 5AB6 . . . (Asset) | Number | 8 (Number) |
| E498 . . . | 5AB6 . . . (Asset) | Item | 3 (Relationship) |
| 0F60 . . . | 5AB6 . . . (Asset) | Location | 3 (Relationship) |
| B6D0 . . . | 8817 . . . (Carrier) | SCAC | 26 (Identifier) |
| AAD1 . . . | 9959 . . . (Container) | Number | 8 (Number) |
| 4352 . . . | 9959 . . . (Container) | Location | 3 (Relationship) |
| 029F . . . | 9959 . . . (Container) | Container Class | 3 (Relationship) |
| 64A0 . . . | 9959 . . . (Container) | Type | 2 (Enumeration) |
| B4B4 . . . | 9959 . . . (Container) | Weight | 38 (Weight) |
| 0A6E . . . | 9959 . . . (Container) | Dimensions | 21 (Dimensions) |
| D3E4 . . . | 9959 . . . (Container) | Outer Container | 3 (Relationship) |
| 228G . . . | 7991 . . . (Country) | Language | 3 (Relationship) |
| BI33 . . . | 7991 . . . (Country) | Currency | 3 (Relationship) |
| 8B8V . . . | 7991 . . . (Country) | UOM Domain | 3 (Relationship) |
| F1D4 . . . | CDBD . . . (Domain) | Name | 1 (Text) |
| 7C01 . . . | CDBD . . . (Domain) | Type | 2 (Enumeration) |
| 924C . . . | CDBD . . . (Domain) | Web Address | 26-(Identifier) |
| 93BB . . . | CDBD . . . (Domain) | Language | 28 (Language) |
| 0BE3 . . . | CDBD . . . (Domain) | Location | 3 (Relationship) |
| 920B . . . | CDBD . . . (Domain) | IP Address | 1 (Text) |
| DAC4 . . . | CDBD . . . (Domain) | First Name | 1 (Text) |
| 3604 . . . | CDBD . . . (Domain) | Middle Name | 1 (Text) |
| B48C . . . | CDBD . . . (Domain) | Last Name | 1 (Text) |
| DB6B . . . | CDBD . . . (Domain) | Suffix | 1 (Text) |
| 151B . . . | CDBD . . . (Domain) | Company | 1 (Text) |
| 6FE7 . . . | CDBD . . . (Domain) | Full Name | 22 (Full Name) |
| DB11 . . . | CDBD . . . (Domain) | Password | 14 (Password) |
| 3AFD . . . | CDBD . . . (Domain) | EIN | 26-(Identifier) |
| 4759 . . . | CDBD . . . (Domain) | Company Prefix | 26-(Identifier) |
| 9F82 . . . | CDBD . . . (Domain) | OUI | 26-(Identifier) |
| 156E . . . | 8F55...(Entity) | Base Entity | 3 (Relationship) |
| E25F . . . | 8F55...(Entity) | Term | 3 (Relationship) |
| BE05 . . . | 8F55...(Entity) | Type | 2 (Enumeration) |
| BE05 . . . | 8F55...(Entity) | Key | 2 (Enumeration) |
| 28C9 . . . | 8F55...(Entity) | Parent Entity | 3 (Relationship) |
| 52E6 . . . | 8F55...(Entity) | Child Entity | 3 (Relationship) |
| 4449 . . . | 8F55...(Entity) | Mirror Entity | 3 (Relationship) |
| 4B5D . . . | 8F55...(Entity) | Autonumber | 3 (Relationship) |
| | | Attribute | |
| C8A4 . . . | 8F55...(Entity) | Starting | 8 (Number) |
| | | Autonumber | |
| A0A2 . . . | 066D . . . (Entity Attribute) | Entity | 3 (Relationship) |
| 1EDE . . . | 066D . . . (Entity Attribute) | Term | 3 (Relationship) |
| 371F . . . | 066D . . . (Entity Attribute) | Base Attribute | 3 (Relationship) |
| 1001 . . . | 066D . . . (Entity Attribute) | Type | 2 (Enumeration) |
| 91AA . . . | 066D . . . (Entity Attribute) | Sequence | 25 (Sequence) |
| 54C9 . . . | 066D . . . (Entity Attribute) | Related Entity | 3 (Relationship) |
| CFB1 . . . | 066D . . . (Entity Attribute) | Minimum Value | 8 (Number) |
| F1D8 . . . | 066D . . . (Entity Attribute) | Maximum Value | 8 (Number) |
| 1ABA . . . | 066D . . . (Entity Attribute) | Increment Value | 8 (Number) |
| 741D . . . | 066D . . . (Entity Attribute) | Default Value | 8 (Number) |
| 251C . . . | 066D . . . (Entity Attribute) | Required? | 9 (Yes/No) |
| 9A1F . . . | 066D . . . (Entity Attribute) | Key | 2 (Enumeration) |
| 9F5E . . . | 8178 . . . (Attribute Value) | Attribute | 3 (Relationship) |
| 17C5 . . . | 8178 . . . (Attribute Value) | Attribute Value | 3 (Relationship) |
| 86D5 . . . | 8178 . . . (Attribute Value) | Sequence | 25 (Sequence) |
| FA79 . . . | 8178 . . . (Attribute Value) | Term | 3 (Relationship) |
| 73F4 . . . | 8178 . . . (Attribute Value) | Type | 2 (Enumeration) |
| 9E5B . . . | 8178 . . . (Attribute Value) | Base UOM | 3 (Relationship) |
| CAA7 . . . | 8178 . . . (Attribute Value) | Value | 8 (Number) |
| EAD9 . . . | 2C8D . . . (View) | Entity | 3 (Relationship) |
| BBCA . . . | 2C8D . . . (View) | Term | 3 (Relationship) |
| 3983 . . . | 2C8D . . . (View) | Parent View | 3 (Relationship) |
| 4A82 . . . | 2C8D . . . (View) | Type | 2 (Enumeration) |
| 4379 . . . | 2C8D . . . (View) | Height | 37 (Length) |
| 7040 . . . | 2C8D . . . (View) | Width | 37 (Length) |
| CC9B . . . | 2C8D . . . (View) | Left Margin | 37 (Length) |
| 1D6D . . . | 2C8D . . . (View) | Right Margin | 37 (Length) |
| CD97 . . . | 2C8D . . . (View) | Top Margin | 37 (Length) |
| 036D . . . | 2C8D . . . (View) | Bottom Margin | 37 (Length) |
| 78B3 . . . | 2C8D . . . (View) | Orientation | 2 (Enumeration) |
| B4A6 . . . | E99D . . . (View Element) | View | 3 (Relationship) |
| 0973 . . . | E99D . . . (View Element) | Sequence | 25 (Sequence) |
| 1CAF . . . | E99D . . . (View Element) | Type | 2 (Enumeration) |
| 6127 . . . | E99D . . . (View Element) | View Entity | 3 (Relationship) |
| 7D7D . . . | E99D . . . (View Element) | Attribute | 3 (Relationship) |
| B939 . . . | E99D . . . (View Element) | Sortation | 2 (Enumeration) |
| 9023 . . . | E99D . . . (View Element) | Left Position | 29 (Position) |
| 1D22 . . . | E99D . . . (View Element) | Top Position | 29 (Position) |
| 78D5 . . . | E99D . . . (View Element) | Height | 37 (Length) |
| 3675 . . . | E99D . . . (View Element) | Width | 37 (Length) |
| 47AA . . . | E99D . . . (View Element) | Rotation | 8 (Number) |
| 914E . . . | E99D . . . (View Element) | Alignment | 2 (Enumeration) |
| 5201 . . . | E99D . . . (View Element) | Font Size | 8 (Number) |
| 9BE2 . . . | E99D . . . (View Element) | Font Style | 2 (Enumeration) |
| 89C1 . . . | E99D . . . (View Element) | Font Family | 2 (Enumeration) |
| 58C8 . . . | C7E4 . . . (View Condition) | View | 3 (Relationship) |
| FAD1 . . . | C7E4 . . . (View Condition) | Sequence | 25 (Sequence) |
| BBF5 . . . | C7E4 . . . (View Condition) | View Entity | 3 (Relationship) |
| 5C75 . . . | C7E4 . . . (View Condition) | Attribute | 3 (Relationship) |
| 4698 . . . | C7E4 . . . (View Condition) | Operator | 2 (Enumeration) |
| DB0D . . . | C7E4 . . . (View Condition) | Value Type | 2 (Enumeration) |
| 8CE5 . . . | C7E4 . . . (View Condition) | Value Attribute | 3 (Relationship) |
| B268 . . . | C7E4 . . . (View Condition) | Value | 30 (Variant) |
| 61E9 . . . | BEB0 . . . (View Entity) | View | 3 (Relationship) |
| DC58 . . . | BEB0 . . . (View Entity) | Sequence | 25 (Sequence) |
| 1474 . . . | BEB0 . . . (View Entity) | View Entity | 3 (Relationship) |
| 423C . . . | BEB0 . . . (View Entity) | Entity | 3 (Relationship) |
| ADE9 . . . | 668D . . . (Group Member) | Entity | 3 (Relationship) |
| CD1Z . . . | 668D . . . (Group Member) | Group | 3 (Relationship) |
| B990 . . . | 668D . . . (Group Member) | Member | 3 (Relationship) |
| 47A5 . . . | OCC1 . . . (Identifier) | Parent Identifier | 3 (Relationship) |
| 4241 . . . | OCC1 . . . (Identifier) | Entity | 3 (Relationship) |
| 8E9C . . . | OCC1 . . . (Identifier) | Object | 3 (Relationship) |
| 3FC3 . . . | OCC1 . . . (Identifier) | Attribute | 3 (Relationship) |
| 46CD . . . | OCC1 . . . (Identifier) | Value | 1 (Text) |
| 2DB2 . . . | 5787 . . . (Inventory) | Item | 3 (Relationship) |
| FC6F . . . | 5787 . . . (Inventory) | Number | 8 (Number) |
| EA60 . . . | 5787 . . . (Inventory) | Location | 3 (Relationship) |
| A6C6 . . . | 5787 . . . (Inventory) | Container | 3 (Relationship) |
| 695B . . . | 5787 . . . (Inventory) | Quantity | 32 (Quantity) |
| 1342 . . . | 4A8F . . . (Item) | Name | 1 (Text) |
| 5482 . . . | 4A8F . . . (Item) | Entity | 3 (Relationship) |
| 5A44 . . . | 4A8F . . . (Item) | Unit Price | 33 (Amount) |
| 1C80 . . . | 4A8F . . . (Item) | Type | 2 (Enumeration) |
| EEC4 . . . | 4A8F . . . (Item) | Traceability | 2 (Enumeration) |
| 50B2 . . . | 4A8F . . . (Item) | Image | 13 (Image) |
| C6CD . . . | 4A8F . . . (Item) | Description | 6 (Description) |
| 8YDD . . . | 4A8F . . . (Item) | GTIN | 26 (Identifier) |
| 82B9 . . . | A4A9 . . . (Item Attribute) | Item | 3 (Relationship) |
| 3492 . . . | A4A9 . . . (Item Attribute) | Attribute | 3 (Relationship) |
| C799 . . . | A4A9 . . . (Item Attribute) | Element | 1 (Text) |
| 8524 . . . | A4A9 . . . (Item Attribute) | Base UOM | 3 (Relationship) |
| 0685 . . . | A4A9 . . . (Item Attribute) | Increment Value | 8 (Number) |
| 5993 . . . | A4A9 . . . (Item Attribute) | Minimum Value | 8 (Number) |
| 2AE1 . . . | A4A9 . . . (Item Attribute) | Maximum Value | 8 (Number) |
| F81C . . . | A4A9 . . . (Item Attribute) | Factor | 8 (Number) |
| 37C7 . . . | A4A9 . . . (Item Attribute) | Read? | 9 (Yes/No) |
| C7E3 . . . | A4A9 . . . (Item Attribute) | Write? | 9 (Yes/No) |
| 5A5A . . . | 8D55 . . . (Item Entity) | Item | 3 (Relationship) |
| 01B5 . . . | 8D55 . . . (Item Entity) | Entity | 3 (Relationship) |
| B90F . . . | 8D55 . . . (Item Entity) | Dataset | 1 (Text) |
| FD35 . . . | A15E (Item Serial) | Item | 3 (Relationship) |
| FE43 . . . | A15E (Item Serial) | Serial Number | 8 (Number) |
| 1041 . . . | A15E (Item Serial) | Location | 3 (Relationship) |
| 45FA . . . | A15E (Item Serial) | Container | 3 (Relationship) |
| 0F13 . . . | A15E (Item Serial) | Quantity | 32 (Quantity) |
| 2CAD . . . | C659 . . . (Item Attribute Value) | Item Attribute | 3 (Relationship) |
| 41FB . . . | C659 . . . (Item Attribute Value) | Attribute Value | 3 (Relationship) |
| D42D . . . | C659 . . . (Item Attribute Value) | Value | 8 (Number) |
| ED2A . . . | 88BD . . . (Location) | Code | 1 (Text) |
| ABF8 . . . | 88BD . . . (Location) | Name | 1 (Text) |
| C329 . . . | 88BD . . . (Location) | Parent Location | 3 (Relationship) |
| 170E . . . | 88BD . . . (Location) | Postal Address | 20 (Postal Address) |
| A242 . . . | 88BD . . . (Location) | Geocode | 26 (Identifier) |
| 65B6 . . . | 4D7A . . . (Machine) | Item | 3 (Relationship) |
| 0A54 . . . | 4D7A . . . (Machine) | Name | 1 (Text) |
| 8DF8 . . . | 4D7A . . . (Machine) | Power | 31 (Power) |
| 28GG . . . | 4D7A . . . (Machine) | Location | 3 (Relationship) |
| 85AC . . . | 4D7A . . . (Machine) | IP Address | 26 (Identifier) |
| D9G1 . . . | 4D7A . . . (Machine) | Event Sync | 16 (Date/Time) |
| | | Date/Time | |
| 3E19 . . . | 93DA . . . (Message) | Sender | 3 (Relationship) |
| 2C37 . . . | 93DA . . . (Message) | Subject | 18 (Subject) |
| 6BA9 . . . | 93DA . . . (Message) | Sent Date/Time | 16 (Date/Time) |
| FE29 . . . | 93DA . . . (Message) | Status | 2 (Enumeration) |
| B7CE . . . | 93DA . . . (Message) | Body | 6 (Description) |
| B006 . . . | A1ED . . . (Message Recipient) | Message | 3 (Relationship) |
| AC97 . . . | A1ED . . . (Message Recipient) | Member | 3 (Relationship) |
| 366A . . . | A1ED . . . (Message Recipient) | Status | 2 (Enumeration) |
| 336C . . . | A1ED . . . (Message Recipient) | Type | 2 (Enumeration) |
| DBC1 . . . | F39A . . . (Member) | Member Domain | 3 (Relationship) |
| A24C . . . | F39A . . . (Member) | Member Entity | 3 (Relationship) |
| F631 . . . | F39A . . . (Member) | Subscription | 3 (Relationship) |
| DE5A . . . | F39A . . . (Member) | Status | 2 (Enumeration) |
| 3BB8 . . . | F39A . . . (Member) | Parent Member | 3 (Relationship) |
| F938 . . . | F39A . . . (Member) | Event Sync | 16 (Date/Time) |
| | | Date/Time | |
| F761 . . . | F39A . . . (Member) | Agent Domain | 3 (Relationship) |
| DBC1 . . . | 15C3 . . . (Member Service) | Member | 3 (Relationship) |
| F631 . . . | 15C3 . . . (Member Service) | Item | 3 (Relationship) |
| A9C9 . . . | 15C3 . . . (Member Service) | Data Store | 1 (Text) |
| 9E28 . . . | 4132 . . . (Printer) | Print Status | 2 (Enumeration) |
| CA31 . . . | 4132 . . . (Printer) | Print Speed | 35 (Speed) |
| E1D5 . . . | 4132 . . . (Printer) | Head Temp . . . | 3303 (Temperature) |
| 781R . . . | 4132 . . . (Printer) | Capacity | 37 (Length) |
| 892B . . . | 4132 . . . (Printer) | Motor Power | 31 (Power) |
| 1138 . . . | A2F4 . . . (Session) | Machine | 3 (Relationship) |
| 9208 . . . | A2F4 . . . (Session) | Member | 3 (Relationship) |
| 4D9F . . . | A2F4 . . . (Session) | Connect Type | 2 (Enumeration) |
| 889B . . . | A2F4 . . . (Session) | Address | 1 (Text) |
| C693 . . . | A2F4 . . . (Session) | Status | 2 (Enumeration) |
| 1AEE . . . | A2F4 . . . (Session) | Start Date/Time | 16 (Date/Time) |
| 9ABB . . . | A2F4 . . . (Session) | End Date/Time | 16 (Date/Time) |
| 9A17 . . . | A2F4 . . . (Session) | Language | 3 (Relationship) |
| 4200 . . . | A2F4 . . . (Session) | Subscription | 3 (Relationship) |
| C9E6 . . . | AC7C . . . (Session Event) | Session | 3 (Relationship) |
| 3BE7 . . . | AC7C . . . (Session Event) | Date/Time | 16 (Date/Time) |
| 9F53 . . . | AC7C . . . (Session Event) | Duration | 36 (Duration) |
| BFA4 . . . | AC7C . . . (Session Event) | Command | 3 (Relationship) |
| 0F9E . . . | AC7C . . . (Session Event) | View Mode | 3 (Relationship) |
| C409 . . . | AC7C . . . (Session Event) | Entity | 3 (Relationship) |
| E2AB . . . | AC7C . . . (Session Event) | Subject | 18 (Subject) |
| 6089 . . . | F3D7 . . . (Subscription) | Duration | 36 (Duration) |
| DA87 . . . | F3D7 . . . (Subscription) | Allow Create? | 9 (Yes/No) |
| DA12 . . . | F3D7 . . . (Subscription) | Allow Delete? | 9 (Yes/No) |
| 09EE . . . | F3D7 . . . (Subscription) | Allow Update? | 9 (Yes/No) |
| 7104 . . . | F3D7 . . . (Subscription) | Design Access | 2 (Enumeration) |
| B0C3 . . . | F3D7 . . . (Subscription) | Entity Access | 2 (Enumeration) |
| 3756 . . . | F3D7 . . . (Subscription) | Read Access | 2 (Enumeration) |
| F139 . . . | 5D39 . . . (Trigger) | Event Type | 2 (Enumeration) |
| 5C98 . . . | 5D39 . . . (Trigger) | Entity | 3 (Relationship) |
| 73F3 . . . | 5D39 . . . (Trigger) | Attribute | 3 (Relationship) |
| 9142 . . . | 5D39 . . . (Trigger) | Operator | 2 (Enumeration) |
| 940A . . . | 5D39 . . . (Trigger) | Value | 1 (Text) |
| C458 . . . | 9410 . . . (Trigger Action) | Trigger | 3 (Relationship) |
| B036 . . . | 9410 . . . (Trigger Action) | Sequence | 25 (Sequence) |
| 3CDE . . . | 9410 . . . (Trigger Action) | Action Type | 2 (Enumeration) |
| 0AA9 . . . | 9410 . . . (Trigger Action) | Entity | 3 (Relationship) |
| 3D53 . . . | 9410 . . . (Trigger Action) | Attribute | 3 (Relationship) |
| 3228 . . . | 9410 . . . (Trigger Action) | Source Type | 2 (Enumeration) |
| 93A8 . . . | 9410 . . . (Trigger Action) | Source Attribute | 3 (Relationship) |
| 930D . . . | 9410 . . . (Trigger Action) | Source Value | 1 (Text) |
| B3A1 . . . | 9410 . . . (Trigger Action) | Parent Attribute | 3 (Relationship) |
| BE45 . . . | 9410 . . . (Trigger Action) | View | 3 (Relationship) |
| 7E72 . . . | 6C7A . . . (Term) | Name | 1 (Text) |
| D515 . . . | 6C7A . . . (Term) | Plural Name | 1 (Text) |
| 7B2A . . . | 6C7A . . . (Term) | Sub Term 1 | 3 (Relationship) |
| 5FE7 . . . | 6C7A . . . (Term) | Sub Term 2 | 3 (Relationship) |
| DEDB . . . | 6C7A . . . (Term) | Sub Term 3 | 3 (Relationship) |
| 68A1 . . . | 6C7A . . . (Term) | Sub Term 4 | 3 (Relationship) |
| E635 . . . | 6C7A . . . (Term) | Code | 26 (Identifier) |
| BF27 . . . | CA82 . . . (Transaction) | Number | 8 (Number) |
| E5E4 . . . | CA82 . . . (Transaction) | Member | 3 (Relationship) |
| A23F . . . | CA82 . . . (Transaction) | Origin | 3 (Relationship) |
| | | Transaction | |
| 8361 . . . | CA82 . . . (Transaction) | Transport Service | 3 (Relationship) |
| F1F6 . . . | CA82 . . . (Transaction) | From Location | 3 (Relationship) |
| EC7E . . . | CA82 . . . (Transaction) | To Location | 3 (Relationship) |
| 82A0 . . . | CA82 . . . (Transaction) | Order Status | 2 (Enumeration) |
| CE9C . . . | CA82 . . . (Transaction) | Shipment Status | 2 (Enumeration) |
| 020E . . . | CA82 . . . (Transaction) | Invoice Status | 2 (Enumeration) |
| EE27 . . . | CA82 . . . (Transaction) | Payment Status | 2 (Enumeration) |
| EEB5 . . . | CA82 . . . (Transaction) | Transfer Status | 2 (Enumeration) |
| 1E6B . . . | CA82 . . . (Transaction) | Sales Agent | 3 (Relationship) |
| 0840 . . . | CA82 . . . (Transaction) | Driver | 3 (Relationship) |
| D2DC . . . | CA82 . . . (Transaction) | Freight Amount | 33 (Amount) |
| D819 . . . | 372D . . . (Transaction Container) | Transaction | 3 (Relationship) |
| 740C . . . | 372D . . . (Transaction Container) | Container | 3 (Relationship) |
| 8140 . . . | 372D . . . (Transaction Container) | Status | 2 (Enumeration) |
| 742B . . . | 372D . . . (Transaction Container) | Freight Amount | 33 (Amount) |
| FDEB . . . | 372D . . . (Transaction Container) | Tracking Number | 26 (Identifier) |
| 9BC5 . . . | 7F69 . . . (Transaction Item) | Transaction | 3 (Relationship) |
| 562D . . . | 7F69 . . . (Transaction Item) | Item | 3 (Relationship) |
| BA93 . . . | 7F69 . . . (Transaction Item) | Inventory | 3 (Relationship) |
| C40E . . . | 7F69 . . . (Transaction Item) | Quantity | 32 (Quantity) |
| 3414 . . . | 7F69 . . . (Transaction Item) | Unit Price | 33 (Amount) |
| 8BB3 . . . | 7F69 . . . (Transaction Item) | Total Price | 33 (Amount) |
| D47D . . . | CAC4 . . . (Unit of Measure) | Base UOM | 3 (Relationship) |
| E315 . . . | CAC4 . . . (Unit of Measure) | Sequence | 25 (Sequence) |
| 9A47 . . . | CAC4 . . . (Unit of Measure) | Term | 3 (Relationship) |
| DA68 . . . | CAC4 . . . (Unit of Measure) | Conversion | 8 (Number) |
| | | Factor | |
| A5A0 . . . | CAC4 . . . (Unit of Measure) | Decimal Places | 8 (Number) |
| AE93 . . . | CAC4 . . . (Unit of Measure) | Code | 26 (Identifier) |
| DDDD . . . | CAC4 . . . (Unit of Measure) | Number | 26 (Identifier) |

In an embodiment, Attribute Value object dataset 298R can comprise the objects illustrated in Table 21.

TABLE 21
Attribute Value object dataset (8178 . . . )

| Object | 9F5E . . . | 17C5 . . . | CAA7 . . . |
|---|---|---|---|
| Identifier | (Attribute) | (Name) | (Value) |
| 0540 . . . | 1001 . . . (Type) | Text | 1 |
| 92C3 . . . | 1001 . . . (Type) | Enumeration | 2 |
| 1C5A . . . | 1001 . . . (Type) | Relationship | 3 |
| 3A45 . . . | 1001 . . . (Type) | Date | 4 |
| C2FD . . . | 1001 . . . (Type) | Time | 5 |
| 354C . . . | 1001 . . . (Type) | Description | 6 |
| CE18 . . . | 1001 . . . (Type) | Function | 7 |
| 840E . . . | 1001 . . . (Type) | Number | 8 |
| 9618 . . . | 1001 . . . (Type) | Yes/No | 9 |
| 02B4 . . . | 1001 . . . (Type) | URL | 10 |
| 51CC . . . | 1001 . . . (Type) | Email Address | 11 |
| 6081 . . . | 1001 . . . (Type) | Phone Number | 12 |
| 084B . . . | 1001 . . . (Type) | Image | 13 |
| 6DE3 . . . | 1001 . . . (Type) | Password | 14 |
| 4EFB . . . | 1001 . . . (Type) | Color | 15 |
| D1CF . . . | 1001 . . . (Type) | Date/Time | 16 |
| 60AF . . . | 1001 . . . (Type) | File | 17 |
| D802 . . . | 1001 . . . (Type) | Subject | 18 |
| 2A86 . . . | 1001 . . . (Type) | Signature | 19 |
| 5E15 . . . | 1001 . . . (Type) | Postal Address | 20 |
| 5BB8 . . . | 1001 . . . (Type) | Dimensions | 21 |
| FE39 . . . | 1001 . . . (Type) | Full Name | 22 |
| 024B . . . | 1001 . . . (Type) | Level | 24 |
| E92F . . . | 1001 . . . (Type) | Sequence | 25 |
| 278B . . . | 1001 . . . (Type) | Identifier | 26 |
| 28FK . . . | 1001 . . . (Type) | Web Address | 27 |
| E8E3 . . . | 1001 . . . (Type) | Language | 28 |
| E388 . . . | 1001 . . . (Type) | Position | 29 |
| EKD8 . . . | 1001 . . . (Type) | Variant | 30 |
| F4DE . . . | 1001 . . . (Type) | Power | 5850 |
| F1A8 . . . | 1001 . . . (Type) | Quantity | 32 |
| B263 . . . | 1001 . . . (Type) | Amount | 33 |
| DB98 . . . | 1001 . . . (Type) | Illuminance | 3301 |
| 5E0D . . . | 1001 . . . (Type) | Temperature | 3303 |
| 8859 . . . | 1001 . . . (Type) | Humidity | 3304 |
| 8KG1 . . . | 1001 . . . (Type) | Pressure | 3315 |
| 2711 . . . | 1001 . . . (Type) | Acceleration | 3313 |
| 8BI3 . . . | 1001 . . . (Type) | Magnetization | 3314 |
| 52BE . . . | 1001 . . . (Type) | Speed | 35 |
| D832 . . . | 1001 . . . (Type) | Duration | 36 |
| G880 . . . | 1001 . . . (Type) | Length | 37 |
| 9SS8 . . . | 1001 . . . (Type) | Weight | 38 |
| 8928 . . . | 1001 . . . (Type) | Volume | 39 |
| 416F . . . | 336C . . . (Type) | To | 0 |
| FB5F . . . | 336C . . . (Type) | Cc | 1 |
| E8B4 . . . | 336C . . . (Type) | Bcc | 2 |
| 215D . . . | 366A . . . (Status) | Undelivered | 0 |
| 23C1 . . . | 366A . . . (Status) | Delivered | 1 |
| 8A77 . . . | 366A . . . (Status) | Read | 2 |
| 3D46 . . . | 97A3 . . . (Type) | Outbound | 0 |
| 5418 . . . | 97A3 . . . (Type) | Inbound | 1 |
| 2272 . . . | 82A0 . . . (Order Status) | Pending | 0 |
| B4A2 . . . | 82A0 . . . (Order Status) | Released | 1 |
| DD15 . . . | 82A0 . . . (Order Status) | Canceled | 2 |
| DBEB . . . | 82A0 . . . (Order Status) | Processed | 3 |
| 6DE9 . . . | 82A0 . . . (Order Status) | Invoiced | 4 |
| 7266 . . . | CE9C . . . (Shipment Status) | Pending | 0 |
| 93FF . . . | CE9C . . . (Shipment Status) | Released | 1 |
| 962D . . . | CE9C . . . (Shipment Status) | Packed | 11 |
| 18AB . . . | CE9C . . . (Shipment Status) | Pickup Requested | 12 |
| 86A8 . . . | CE9C . . . (Shipment Status) | Pickup Scheduled | 13 |
| 1B60 . . . | CE9C . . . (Shipment Status) | In Route | 14 |
| 7020 . . . | CE9C . . . (Shipment Status) | Delivered | 15 |
| A135 . . . | EEB5 . . . (Transfer Status) | Pending | 0 |
| 70EA . . . | EEB5 . . . (Transfer Status) | Released | 1 |
| 106A . . . | EEB5 . . . (Transfer Status) | Canceled | 2 |
| D045 . . . | EEB5 . . . (Transfer Status) | Processed | 3 |
| 89FE . . . | 9142 . . . (Operator) | equal to | 1 |
| 2582 . . . | 9142 . . . (Operator) | not equal to | 2 |
| 9BC4 . . . | 9142 . . . (Operator) | within | 3 |
| DE01 . . . | 9142 . . . (Operator) | less than | 4 |
| AB5C . . . | 9142 . . . (Operator) | Exceeds | 5 |
| 3472 . . . | 9142 . . . (Operator) | outside of | 6 |
| FF7D . . . | F139 . . . (Type) | On Set | 0 |
| F5C7 . . . | F139 . . . (Type) | On Create | 1 |
| 436F . . . | F139 . . . (Type) | On Delete | 2 |
| 8A7E . . . | 3CDE . . . (Action) | Set | 0 |
| 2000 . . . | 3CDE . . . (Action) | Increment | 1 |
| 8B86 . . . | 3CDE . . . (Action) | Decrement | 2 |
| AC66 . . . | 3CDE . . . (Action) | Send Alert | 3 |
| 6049 . . . | 3CDE . . . (Action) | Assign Task | 4 |
| AB3A . . . | 3CDE . . . (Action) | Assign Event | 5 |
| 1849 . . . | 3CDE . . . (Action) | Print | 6 |
| 5582 . . . | 3CDE . . . (Action) | Mirror | 8 |
| 6CC8 . . . | 3CDE . . . (Action) | Set Autonumber | 10 |
| 2708 . . . | 3CDE . . . (Action) | Derive | 11 |
| A664 . . . | 3CDE . . . (Action) | Create Agent | 12 |
| 01D3 . . . | 3228 . . . (Source) | Attribute | 1 |
| 62BE . . . | 3228 . . . (Source) | Constant | 2 |
| 89EA . . . | 3228 . . . (Source) | Total | 3 |
| F9CB . . . | 3228 . . . (Source) | Member | 4 |
| 8T22 . . . | DE5A . . . (Status) | Requested | 0 |
| BI25 . . . | DE5A . . . (Status) | Approved | 1 |
| 093A . . . | DE5A . . . (Status) | Declined | 2 |
| 882G . . . | 9E28 . . . (Print Status) | Offline | 0 |
| 02AB . . . | 9E28 . . . (Print Status) | Ready | 1 |
| 7588 . . . | 9E28 . . . (Print Status) | Paused | 2 |
| 453A . . . | 9E28 . . . (Print Status) | Paper Out | 3 |
| 6783 . . . | 9E28 . . . (Print Status) | Printing | 4 |

In an embodiment, Trigger object dataset 296 can comprise the objects illustrated in Table 22.

TABLE 22
Trigger object dataset (5D39 . . . )

| | CI | | | | | |
|---|---|---|---|---|---|---|
| | 3 | 3 | 4 | 5 | 6 | 7 |
| | Object | F139 . . . | 5C98 . . . | 73F3 . . . | 9142 . . . | 940A . . . |
| RI | Identifier | (Event Type) | (Entity) | (Attribute) | (Operator) | (Value) |
| 0 | 9EA1 . . . | 1 | F39A . . . | | | |
| | | (On Create) | (Member) | | | |
| 1 | 979B . . . | 0 | 39D4 . . . | 82A0 . . . | 1 | 1 |
| | | (On Set) | (Purchase Order) | (Order Status) | (equal to) | (Released) |
| 2 | E1E1 . . . | 0 | 2120 . . . | 82A0 . . . | 1 | 1 |
| | | (On Set) | (Sales Order) | (Order Status) | (equal to) | (Released) |
| 3 | 350F . . . | 0 | 9C12 . . . | CE9C . . . | 1 | 1 |
| | | (On Set) | (Shipment) | (Shipment | (equal to) | (Released) |
| | | | | Status) | | |
| 4 | 6213 . . . | 0 | 8ADB . . . | EEB5 . . . | 1 | 1 |
| | | (On Set) | (Stock Transfer) | (Transfer Status) | (equal to) | (Released) |
| 5 | 2DC6 . . . | 0 | 8ADB . . . | EEB5 . . . | 1 | 3 |
| | | (On Set) | (Stock Transfer) | (Transfer Status) | (equal to) | (Processed) |
| 6 | BA29 . . . | 0 | 9C12 . . . | CE9C . . . | 1 | 11 |
| | | (On Set) | (Shipment) | (Shipment | (equal to) | (Packed) |
| | | | | Status) | | |
| 7 | F01A . . . | 0 | 9C12 . . . | CE9C . . . | 1 | 12 |
| | | (On Set) | (Shipment) | (Shipment | (equal to) | (Pickup |
| | | | | Status) | | Requested) |
| 8 | F9A2 . . . | 0 | 9C12 . . . | CE9C . . . | 1 | 13 |
| | | (On Set) | (Shipment) | (Shipment | (equal to) | (Pickup |
| | | | | Status) | | Scheduled) |
| 9 | 6844 . . . | 0 | (Printer) | 9E28 . . . | 1 | 1 |
| | | (On Set) | | (Print Status) | (equal to) | (Ready) |
| 10 | 338G . . . | 0 | (Printer) | 9E28 . . . | 1 | 2 |
| | | (On Set) | | (Print Status) | (equal to) | (Paused) |
| 11 | T898 . . . | 0 | (Printer) | 9E28 . . . | 1 | 4 |
| | | (On Set) | | (Print Status) | (equal to) | (Printing) |
| 12 | G838 . . . | 0 | (Printer) | 9E28 . . . | 1 | 3 |
| | | (On Set) | | (Print Status) | (equal to) | (Paper Out) |
| 13 | N022 . . . | 0 | (Printer) | E1D5 . . . | 5 | 50 |
| | | (On Set) | | (Head Temp) | (exceeds) | |

In an embodiment, Trigger Action object dataset 296A can comprise the objects illustrated in Table 23.

TABLE 23
Trigger Action object dataset (9410 . . . )

| | CI | | | | | |
|---|---|---|---|---|---|---|
| | 0 | 3 | 5 | 6 | 7 | 10 |
| | Object | C458 . . . | 3CDE . . . | 0AA9 . . . | 3D53 . . . | 930D . . . |
| RI | Identifier | (Trigger) | (Action) | (Entity) | (Attribute) | (Value) |
| 0 | 5C21 . . . | 9EA1 . . . | 8 | F39A . . . | | |
| | | | (Mirror) | (Member) | | |
| 1 | 8243 . . . | 979B . . . | 8 | 2120 . . . | | |
| | | | (Mirror) | (Sales Order) | | |
| 2 | C048 . . . | E1E1 . . . | 0 | 2120 . . . | CE9C . . . | 1 |
| | | | (Set) | (Sales Order) | (Shipment Status) | (Released) |
| 3 | 1904 . . . | E1E1 . . . | 11 | 9C12 . . . | | |
| | | | (Derive) | (Shipment) | | |
| 4 | D865 . . . | 350F . . . | 0 | 9C12 . . . | EEB5 . . . | 1 |
| | | | (Set) | (Shipment) | (Transfer Status) | (Released) |
| 5 | 03C6 . . . | 350F . . . | 11 | 8ADB . . . | | |
| | | | (Derive) | (Stock Transfer) | | |
| 6 | BBE5 . . . | 6213 . . . | 4 | 8ADB . . . | 1E6B . . . | |
| | | | (Assign | (Stock Transfer) | (Sales Agent) | |
| | | | Task) | | | |
| 7 | EA73 . . . | 6213 . . . | 0 | 8ADB . . . | EEB5 . . . | 3 |
| | | | (Set) | (Stock Transfer) | (Transfer Status) | (Processed) |
| 8 | 4108 . . . | 2DC6 . . . | 2 | 648A . . . | 695B . . . | |
| | | | (Decrement) | (Item Location) | (Quantity) | |
| 9 | 819A . . . | 2DC6 . . . | 0 | 9959 . . . (Container) | 4352 . . . | |
| | | | (Set) | | (Location) | |
| 10 | CADC . . . | 2DC6 . . . | 0 | 9C12 . . . | CE9C . . . | 12 |
| | | | (Set) | (Shipment) | (Shipment Status) | (Pickup Req.) |
| 11 | 4D5D . . . | BA29 . . . | 0 | 9C12 . . . | 8361 . . . | |
| | | | (Set) | (Shipment) | (Transport | |
| | | | | | Service) | |
| 12 | 5583 . . . | F01A . . . | 4 | 9C12 . . . | 0840 . . . | |
| | | | (Assign Task) | (Shipment) | (Driver) | |
| 13 | 5A75 . . . | F01A . . . | 0 | 4329 . . . | FDEB . . . | |
| | | | (Set) | (Shipment | (Tracking | |
| | | | | Container) | Number) | |
| 14 | 748E . . . | F01A . . . | 0 | 9C12 . . . | D2DC . . . | |
| | | | (Set) | (Shipment) | (Freight Amount) | |
| 15 | E8A4 . . . | F01A . . . | 0 | 9C12 . . . | CE9C . . . | 13 |
| | | | (Set) | (Shipment) | (Shipment Status) | (Pickup Sch.) |
| 16 | 08A7 . . . | F01A . . . | 6 | 4329 . . . | | |
| | | | (Print) | (Shipment | | |
| | | | | Container) | | |
| 17 | B821 . . . | F9A2 . . . | 8 | 4D7A . . . | | |
| | | | (Change | (Machine) | | |
| | | | Owner) | | | |
| 18 | 683Z . . . | 6844 . . . | 0 | 4132 . . . | 892B . . . | 0 |
| | | | (Set) | (Printer) | (Motor Power) | (Off) |
| 19 | VB8A . . . | 338G . . . | 0 | 4132 . . . | 892B . . . | 0 |
| | | | (Set) | (Printer) | (Motor Power) | (Off) |
| 20 | B842 . . . | T898 . . . | 0 | 4132 . . . | 892B . . . | 1 |
| | | | (Set) | (Printer) | (Motor Power) | (On) |
| 21 | GH08 . . . | G838 . . . | 0 | 4132 . . . | 892B . . . | 0 |
| | | | (Set) | (Printer) | (Motor Power) | (Off) |
| 22 | 844H . . . | G838 . . . | 3 | A2F4 . . . | 9208 . . . | |
| | | | (Send Alert) | (Session) | (Member) | |
| 23 | L898 . . . | N022 . . . | 0 | 4132 . . . | 892B . . . | 0 |
| | | | (Set) | (Printer) | (Motor Power) | (Off) |
| 24 | 4J48 . . . | N022 . . . | 3 | A2F4 . . . | 9208 . . . | |
| | | | (Send Alert) | (Session) | (Member) | |

### 12. Example Utility

An implementation of a sample utility which utilizes an embodiment of the disclosed common data service for unified commerce and the internet of things will now be described.

For purposes of demonstrating the sample utility, Machines A, B, C, D and E all have the agent, OEP, RVG, OQP, SM and SDS components installed. Machines D and E also have the PAR component installed. Universally Unique Identifiers (UUIDs) are used as object identifiers within all object datasets within an SDS. A subset of the SDS content within each machine defines the machine's configuration as illustrated in FIG. 6 and as follows:

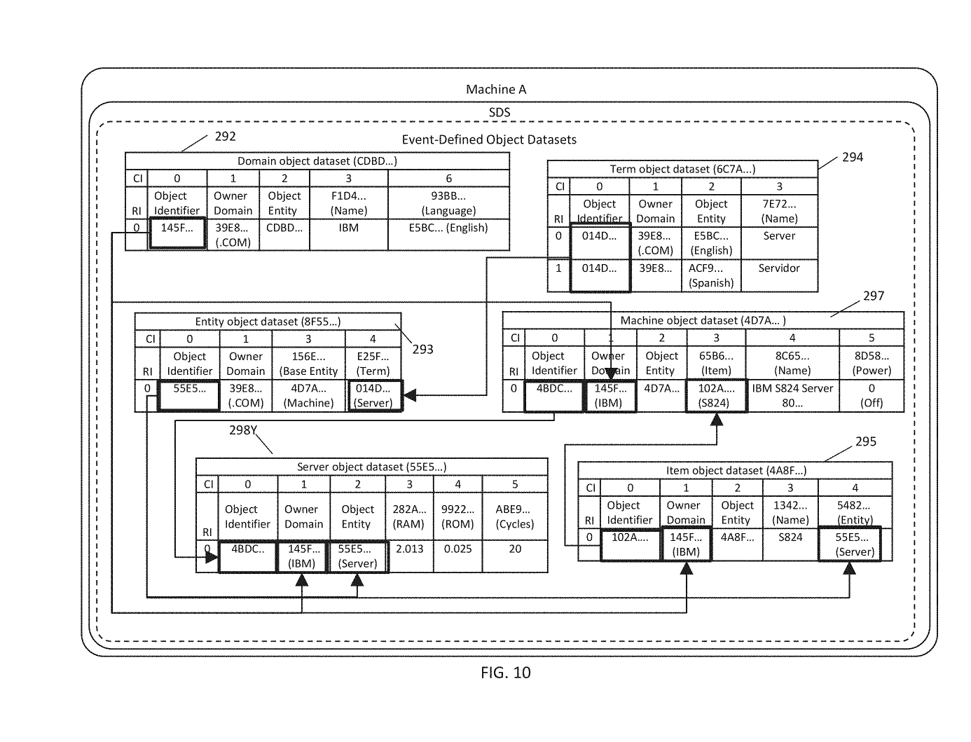

(1) Machine A is a cloud server represented by a “Machine A” Machine object owned by the organization represented by the “Zebra” Domain object as illustrated in RI [0] in Machine object dataset 297 contained in the SDS within Machine A in FIG. 11. FIG. 10 illustrates the object datasets derived from a subset of the Events dataset 291 contained in the SDS within Machine A when it was initially provisioned.

(2) Machine B is a multi-tenant cloud server represented by a “Machine B” Machine object owned by the organization represented by the “IBM” Domain object.

(3) Machine C is a cloud server represented by a “Machine C” Machine object owned by the organization represented by the “.COM” Domain object as illustrated in RI [0] in Machine object dataset 597 contained in the SDS within Machine C in FIG. 11.

(4) Machine D is a smartphone represented by a “Machine D” Machine object owned by the individual represented by the “JSmith” Domain object as illustrated in RI [1] in Machine object dataset 297 contained in the SDS within Machine A in FIG. 11. The current state of a portable application framework and portable application is contained in a Runtime dataset within the machine's SDS.

(5) Machine E is a newly manufactured, un-provisioned printer that has no content in its SDS, as the agent on Machine E has never been booted. The manufacturer of the printer, identified by the printer's MAC Address, is the organization represented by the “Zebra” Domain object.

A subset of the SDS content within one or more of the machines defines domains and their relationships to the machines and other domains as follows:

(1) As illustrated in FIG. 12, the “IP Address” attribute value of the “Zebra” Domain object is set to the “Value” attribute value (i.e., “ . . . 148” at index location [0][7] in Identifier object dataset 298X) of an Identifier object (referred to as “ . . . 148” as “IP Address” Identifier object) owned by the “Verizon” Domain object and related to Machine A (i.e., the “Object” attribute value at index location [0][5] in Identifier object dataset 298X is set to the object identifier at index location [0][0] in Machine object dataset 297). This configuration, (referred to as the cloud server (Machine A) of “Zebra”), enables machine messages addressed to the “Zebra” Domain object to be directed to Machine A. Similar configurations enable machine messages addressed to the “UPS” Domain object to be directed to Machine B, (referred to as multi-tenant cloud server (Machine B) of “ADCTech”), and machine messages addressed to the “.COM” Domain object to be directed to Machine C.

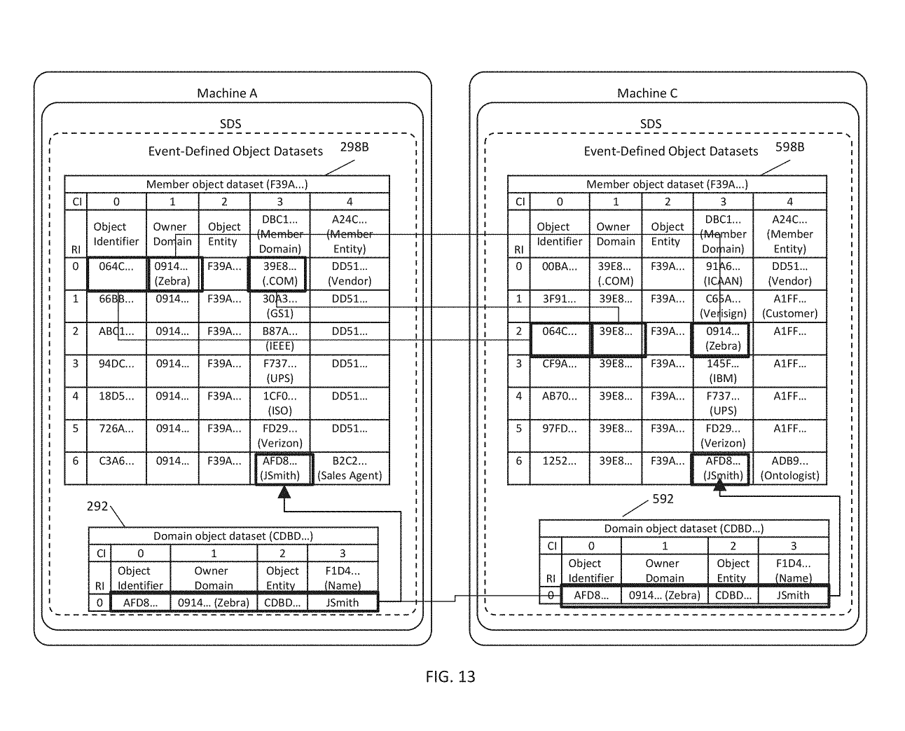

(2) The “Zebra” Domain object, “IBM” Domain object, “UPS” Domain object, and “Verizon” object are owned by the “.COM” Domain object, as illustrated in Domain object dataset 592 in FIG. 11, and are each identified, as a member domain, by a “Member Domain” attribute value within Member objects owned by the “.COM” Domain object (i.e., RI [2] through RI [5] in Member object dataset 598B in FIG. 13) that also identify the “Customer” Entity by a “Member Entity” attribute value in the same Member objects. The Member object at RI [2] within Member object dataset 598B can be referred to as “Zebra” Customer as a Member object. The “.COM” Domain object is designated as a “Vendor” Entity within mirrored Member objects, each owned separately by the “Verizon” Domain object, “UPS” Domain object, “IBM Domain object, and “Zebra” Domain object. The “.COM” Vendor as a Member object, owned by the “Zebra” Domain object, is illustrated in RI [0] of Member object dataset 298B in FIG. 13. The Object Identifier of a Member object (e.g., RI [2] within Member object dataset 598B) and the Object Identifier of its mirrored Member object (e.g., RI [0] within Member object dataset 298B) are set to the same value.

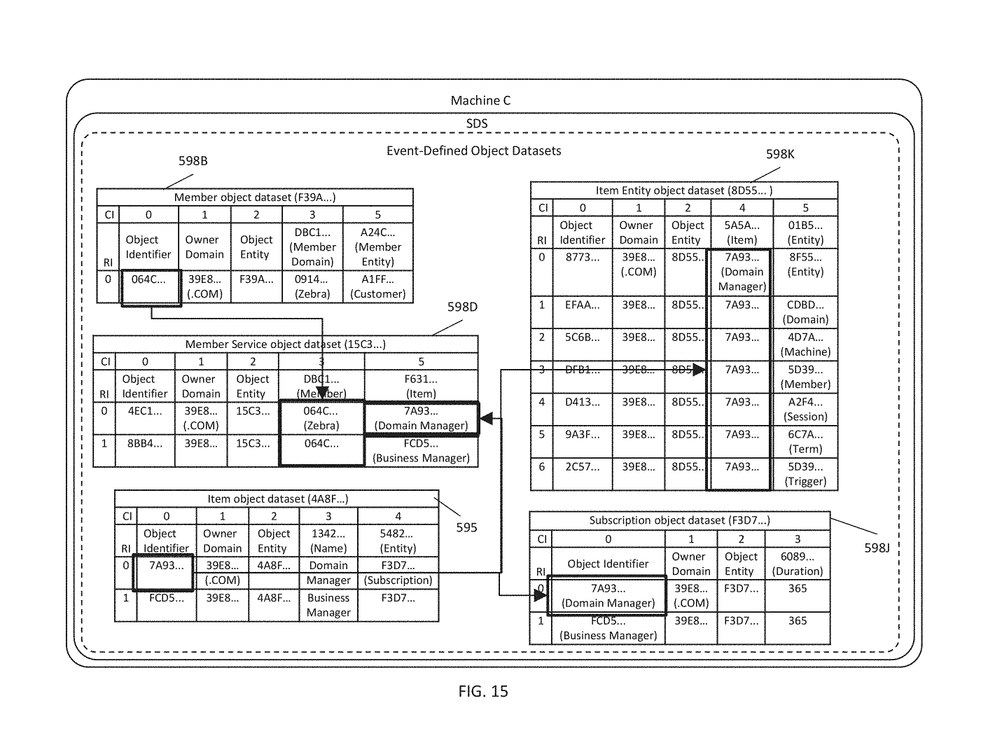

(3) As illustrated in FIG. 15, a child Member Service object (e.g., RI [0] in Member Service object dataset 598D) representing a data subscription, related to the “Domain Manager” Item object (i.e. RI [0] in Item object dataset 595), is related to each of the parent Customer as a Member objects owned by the “.COM” Domain object (e.g. RI [0] in Member object dataset 598B). Child Item Entity objects (e.g., RI [0] in Item Entity object dataset 598K) are related to the parent “Domain Manager” Item object and represent the types of objects (i.e., entities) that are shared with member domains, including aggregate Entity, Domain, Machine, Member, Session, Term, and Trigger objects (i.e., shared objects).

(4) As illustrated in FIG. 15, a child Member Service object (e.g., RI [1] in Member Service object dataset 598D) representing a data subscription, related to the “Business Manager” Item object (i.e. RI [1] in Item object dataset 595), is also related to each of the parent Customer as Member objects owned by the “.COM” Domain object (e.g. RI [0] in Member object dataset 598B). Child Item Entity objects (e.g., RI [0] in Item Entity object dataset 598K in FIG. 16) are related to the parent “Business Manager” Item object and represent the types of objects (i.e., entities) that are shared with member domains, including aggregate Transaction, Location, Item, Container, Inventory, Asset, Unit of Measure, and Identifier objects (i.e., shared objects).

(5) Shared objects owned by the .COM Domain object and stored in the SDS of Machine C have been synchronized within the SDS of each machine (e.g., Machine A, Machine B) that is directed to receive machine messages on behalf of a member domain (e.g. Zebra, UPS) associated with the data subscription. Synchronized objects, owned by the “.COM” Domain object, are illustrated within the object datasets in Tables 19-23 and within various object datasets in FIG. 7-41.

(6) As illustrated in RI [3] in Member object dataset 298B in FIG. 13, the “UPS” Domain object is designated as a “Vendor” Entity within a Member object (referred to as “UPS” Vendor as Member object), owned by the “Zebra” Domain object. The “Zebra” Domain object is designated as a “Customer” Entity within a mirrored Member object (referred to as “Zebra” Customer as Member object), owned by the “UPS” Domain object. A child Member Service object representing a data subscription, related to the “Business Manager” Item object, is related to each of the parent Customer as Member objects owned by the “UPS” Domain object. Shared objects owned by the “UPS” Domain object and stored in the SDS of Machine B have been synchronized within the SDS of each machine (e.g., Machine A) that is directed to receive machine messages on behalf of a member domain (e.g. Zebra) associated with the data subscription.

(7) As illustrated in FIG. 38, a “Bin 100” Location object (i.e., RI [3] in Location object dataset 298G) is related to an “A Zone” Location object (i.e., RI [2] in Location object dataset 298G) which are both owned by the “Zebra” Domain object. The “A Zone” Location object is related to the “2900 Calle Heraldo, San Clemente, Calif. 92673” Postal Address object (i.e., RI [1] in Location object dataset 298G) owned by the “UPS” Domain object.

(8) As illustrated in RI [6] in Member object dataset 298B in FIG. 13, the “JSmith” Domain object is owned by the “Zebra” Domain object, and is designated as a “Sales Agent” Entity within a Member object owned by the “Zebra” Domain object (referred to as “JSmith” Sales Agent as Member object). As illustrated in RI [6] in Member object dataset 598B in FIG. 13, the “JSmith” Domain object is also designated as an “Ontologist” Entity within a Member object owned by the “.COM” Domain object.

Tables 24 represent an ordered sequence of steps for demonstrating the sample utility. In this table, the sequence column represents the sequence step, the machine column represents the Machine (e.g., Machine A) performing the sequence step, and the component column represents the component of the machine (e.g., agent) identified in the machine column that performs the sequence step. The Automation column describes the sequence step being performed.

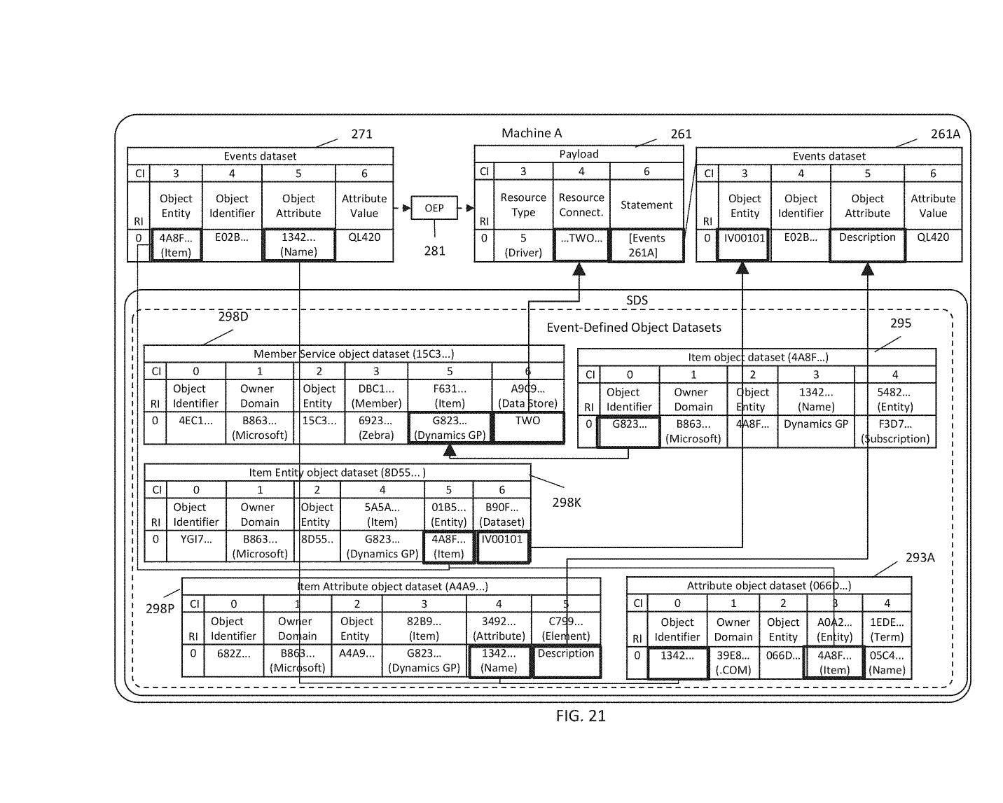

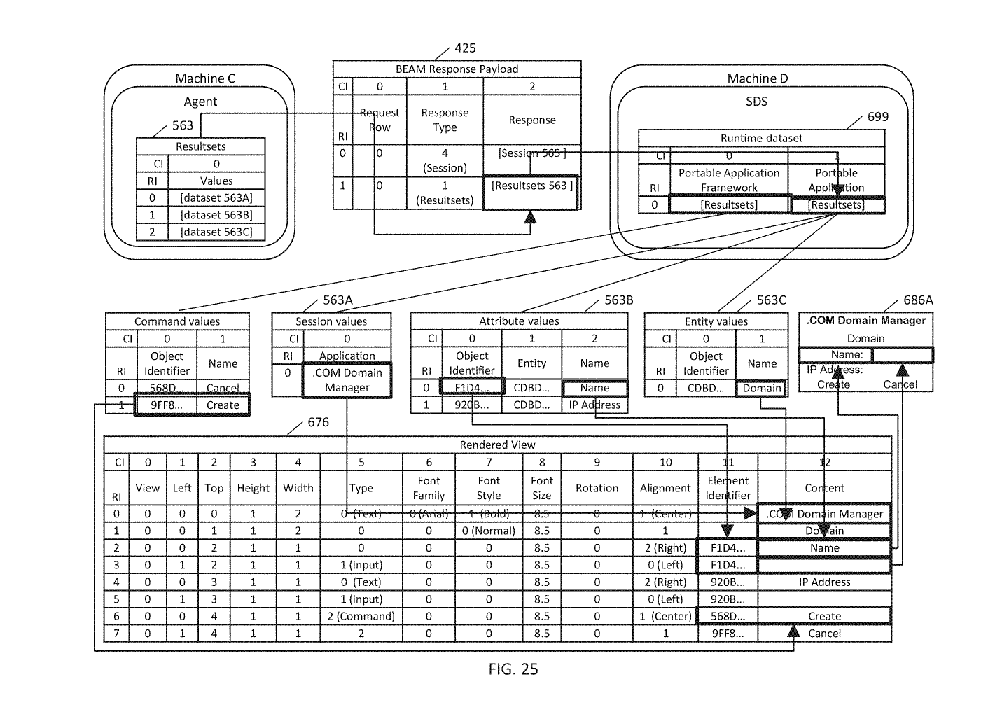

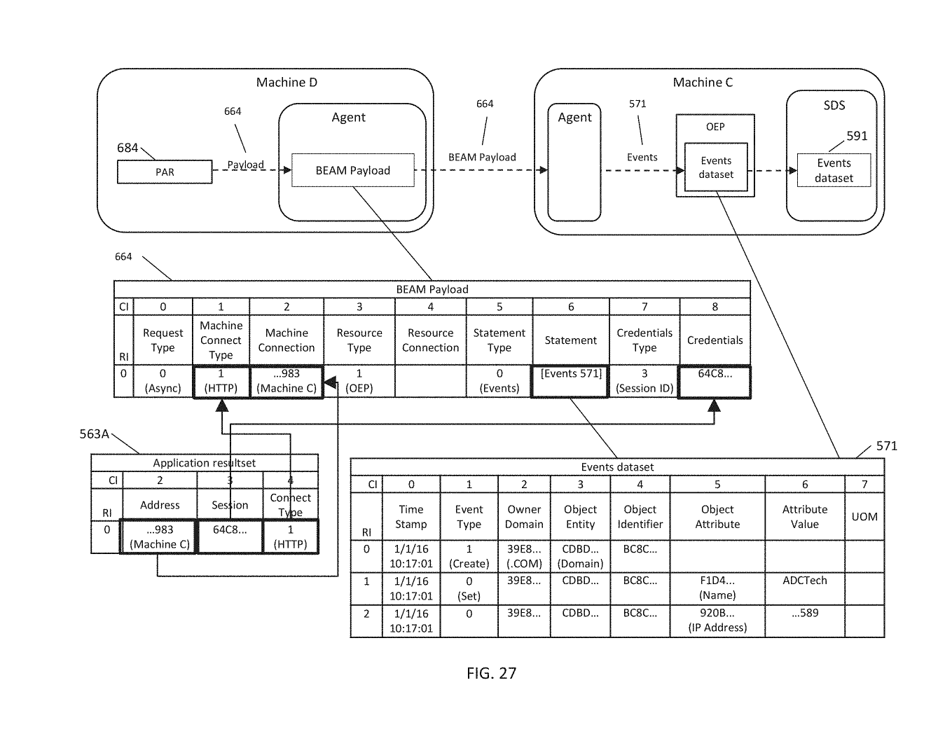

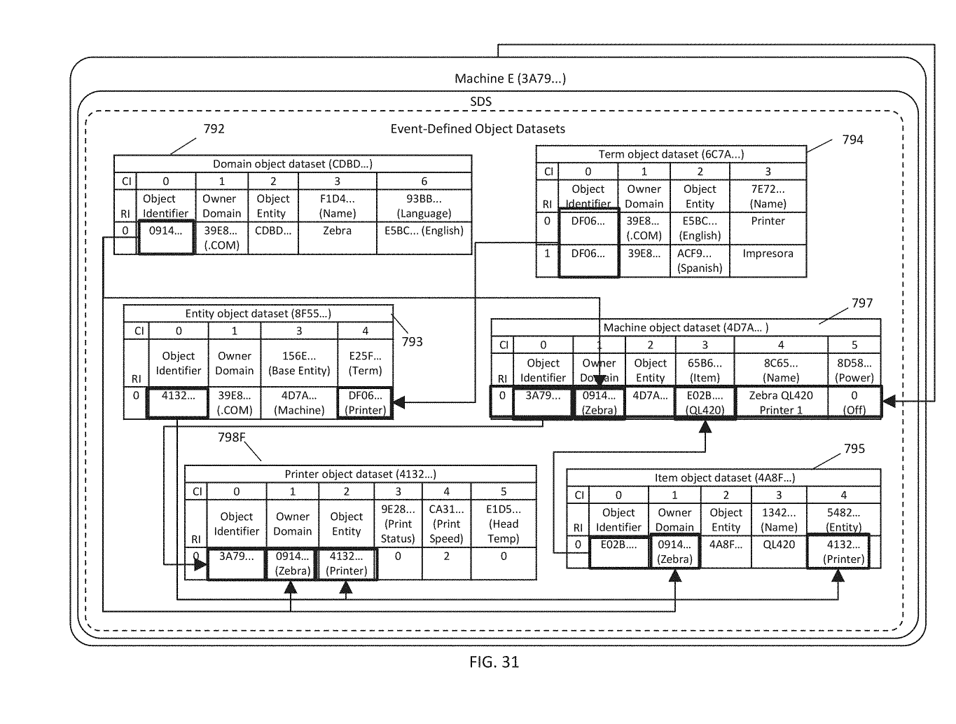

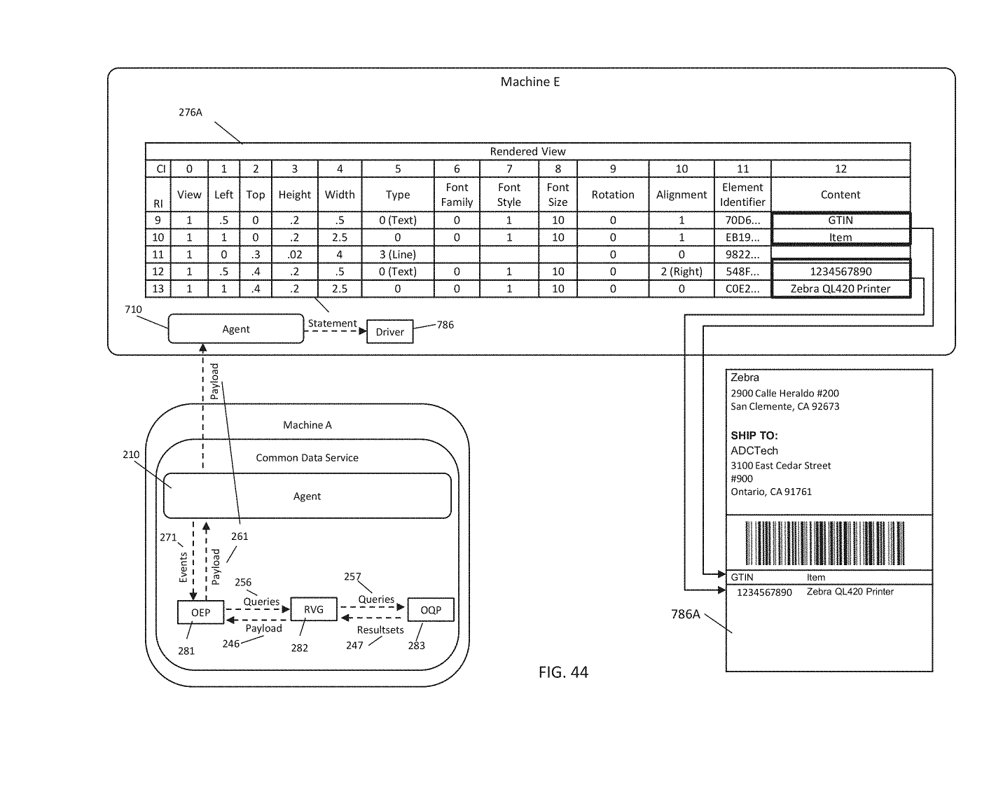

TABLE 24

| Sequence | Machine | Component | Automation |
|---|---|---|---|
| 1.1 | D | Agent/PAR | On booting of the Agent, the PAR retrieves the |
| | | | current state of a portable application framework |
| | | | and portable application from the Runtime |
| | | | dataset within SDS. |
| 1.2 | D | PAR | The portable application is processed with the |
| | | | portable application framework to generate a |
| | | | View that is submitted to the Agent as a |
| | | | statement within a BEAM Payload. |
| 1.3 | D | Agent | The View within the statement of the BEAM |
| | | | Payload is submitted to a Driver for processing. |
| 1.4 | D | Driver | An HTML script is generated from the View and |
| | | | submitted to the machine's display engine to |
| | | | render a user interface (UI). |
| 2.1 | D | PAR | From a UI event, a Queries dataset is generated |
| | | | that comprises attribute values from the |
| | | | Resultsets that define the portable application |
| | | | framework. |
| | | | A row in a BEAM Payload is generated that |
| | | | includes the IP Address associated with the |
| | | | “.COM” Domain object (Machine C), a |
| | | | Connection Type designating “HTTP”, a |
| | | | Resource Type designating an OQP, a Statement |
| | | | comprising the Queries, and Credentials |
| | | | comprising identifiers of the “Machine D” |
| | | | Machine object (i.e., 3631 . . . ) and the “JSmith” |
| | | | Domain object (i.e., AFD8 . . . ), as illustrated in |
| | | | RI [1] of Machine object dataset 297 in FIG. 11 |
| 2.2 | D | Agent | The BEAM Payload is transported via the |
| | | | Connection Type to the Agent on Machine C. |
| 2.3 | C | Agent | The Credentials from the row in the BEAM |
| | | | Payload are submitted to the SM for processing. |
| 2.4 | C | SM | A Queries dataset is generated based on the |
| | | | Credentials and submitted to the OQP for |
| | | | processing. |
| 2.5 | C | OQP | A Resultsets is generated from the Queries |
| | | | dataset and comprises attribute values of a |
| | | | Member object (i.e., RI [6] in Member object |
| | | | dataset 598B in FIG. 13) and related objects |
| | | | within the SDS. The Resultsets is returned to |
| | | | the SM. |
| 2.6 | C | SM/Agent | Upon validating the Credentials, Events are |
| | | | generated that define a new Session object from |
| | | | the Resultsets. The Session object identifier |
| | | | (Session ID) is included in a new row within a |
| | | | BEAM Response Payload dataset. The Events |
| | | | are submitted to the OEP for processing. |
| 2.7 | C | OEP | The Events that define the new Session object |
| | | | are stored within the SDS as illustrated in FIG. |
| | | | 23. |
| 2.8 | C | Agent | The Queries within the statement of the BEAM |
| | | | Payload are submitted to the OQP for |
| | | | processing. |
| 2.9 | C | OQP | A Resultsets 563 is generated, with nested |
| | | | datasets that define a “.COM Domain Manager” |
| | | | portable application, from the query definitions |
| | | | within Queries 573, as illustrated in FIG. 24. |
| | | | The Resultsets comprises identifiers and human- |
| | | | readable names for the Entity and Attribute |
| | | | objects related to the aggregate “Domain |
| | | | Manager” Item object, including the aggregate |
| | | | “Entity” Entity object, as illustrated in Item |
| | | | Entity dataset 598K in FIG. 15. |
| | | | The human-readable names (e.g., “Name” at |
| | | | index location [0][2] within Attribute values |
| | | | 563B and “Domain” at index location [0][1] |
| | | | within Entity values 563C) in FIG. 24 are |
| | | | derived from attribute values of Term objects |
| | | | (e.g., “Name” at index location [0][3] within |
| | | | Term object dataset 594) that are related to the |
| | | | “Language” attribute value of the “JSmith” |
| | | | Domain object (e.g., “E5BC . . . ” at index |
| | | | location [1][6] in Domain object dataset 592), as |
| | | | illustrated in FIG. 24. |
| | | | The Resultsets is returned to the Agent. |
| 2.10 | C | Agent | Another row in a BEAM Response Payload is |
| | | | generated that includes Resultsets 563 defining |
| | | | the portable application as illustrated in FIG. 25. |
| | | | The BEAM Response Payload is returned via |
| | | | the same connection to the Agent on Machine D. |
| 2.11 | D | Agent | The Session ID and Resultsets defining a |
| | | | portable application within the rows of the |
| | | | BEAM Response Payload are submitted to the |
| | | | PAR for processing. |
| 2.12 | D | PAR/Agent | The “.COM Domain Manager” portable |
| | | | application is stored within the Runtime dataset |
| | | | 699 and processed with the portable application |
| | | | framework to generate View 676, as illustrated |
| | | | in FIG. 25, that is submitted to a Driver for |
| | | | processing. |
| 2.13 | D | Driver | An HTML script is generated from the View and |
| | | | submitted to the machine's display engine to |
| | | | render a user interface 686A as illustrated in |
| | | | FIG. 25. |
| 3.1 | D | PAR | From UI events, rows in an Events dataset are |
| | | | generated that define a new aggregate “Printer” |
| | | | Entity object owned by the “.COM” Domain |
| | | | object and include Entity and Attribute object |
| | | | identifiers from the “.COM Domain Manager” |
| | | | portable application that are paired with attribute |
| | | | values entered by the user. |
| | | | From a UI event, a row in a BEAM Payload is |
| | | | generated that includes the IP Address |
| | | | associated with the “.COM” Domain object |
| | | | (Machine C), a Connection Type designating |
| | | | “HTTP”, a Resource Type designating an OEP, |
| | | | a Statement comprising the Events, and |
| | | | Credentials comprising the Session ID. |
| 3.2 | D | Agent | The BEAM Payload is transported via the |
| | | | Connection Type to the Agent on Machine C. |
| 3.3 | C | Agent | The Credentials within the BEAM Payload is |
| | | | submitted to SM for validation |
| 3.4 | C | SM | A Queries dataset is generated based on the |
| | | | Credentials and submitted to the OQP for |
| | | | processing. |
| 3.5 | C | OQP | A Resultsets is generated from the Queries |
| | | | dataset and comprises the “Status” attribute |
| | | | value of the Session object within the SDS |
| | | | identified by the Session ID, as illustrated at |
| | | | index location [0][7] of Session object dataset |
| | | | 598E in FIG. 23. The Resultsets is returned to |
| | | | the SM. |
| 3.6 | C | SM/Agent | Upon validating the Credentials, including the |
| | | | “Status” attribute value, the Events within the |
| | | | Statement of the BEAM Payload are submitted |
| | | | to the OEP for processing. |
| 3.7 | C | OEP | The Events that define the aggregate “Printer” |
| | | | Entity object are stored within the SDS and |
| | | | define subsets of object datasets illustrated in |
| | | | FIG. 28, including RI [3] within Entity object |
| | | | dataset 593, RI [4] through RI [6] within |
| | | | Attribute object dataset 593A, and RI [0] |
| | | | through RI [2] within Attribute Value object |
| | | | dataset 593B. |
| | | | A triggered action generates a row in a BEAM |
| | | | Payload for each Member object that is assigned |
| | | | a subscription to Entity objects owned by the |
| | | | “.COM” Domain object. As illustrated in FIG. |
| | | | 15, RI [0] within the Item Entity object dataset |
| | | | 598K associates the “Entity” Entity to the |
| | | | “Domain Manager” Item which is assigned to |
| | | | the “Zebra” Domain within RI [0] of Member |
| | | | Service object dataset 598D. Each new row in |
| | | | the BEAM Payload includes a Connection Type |
| | | | designating “HTTP”, a Resource Type |
| | | | designating an OEP, a Statement comprising the |
| | | | Events that define the “Printer” Entity object, |
| | | | and Credentials comprising the “.COM” Domain |
| | | | object identifier. One of the new rows identifies |
| | | | the IP Address for the “Zebra” Domain object |
| | | | (Machine A). |
| 3.8 | C | Agent | A row in the BEAM Payload is transported via |
| | | | the Connection Type to the Agent on Machine |
| | | | A. |
| 3.9 | A | Agent/SM/ | Upon validating the Credentials within the |
| | | OQP/OEP | BEAM Payload, Events that define a new |
| | | | Session object are stored within the SDS and the |
| | | | Session object identifier (Session ID) is included |
| | | | in a new row within a BEAM Response Payload |
| | | | dataset. |
| | | | The Events within the Statement of the BEAM |
| | | | Payload are submitted to the OEP for |
| | | | processing. |
| 3.10 | A | OEP | The Events that define the aggregate “Printer” |
| | | | Entity object are stored within the SDS. |
| 4.1 | D | PAR | From UI events, rows in an Events dataset 691 |
| | | | are generated that define a new “ADCTech” |
| | | | Domain object owned by the “.COM” Domain |
| | | | object and include Entity and Attribute object |
| | | | identifiers from the “.COM Domain Manager” |
| | | | portable application that are paired with attribute |
| | | | values entered by the user, as illustrated in FIG. |
| | | | 26. |
| | | | The “IP Address” attribute value of the |
| | | | “ADCTech” Domain object matches the |
| | | | “Value” attribute value of an “IP Address” |
| | | | Identifier object which is related to the |
| | | | “Machine B” Machine object. |
| | | | The “Location” attribute value of the |
| | | | “ADCTech” Domain object matches the |
| | | | identifier of the Location object illustrated in RI |
| | | | [0] within Location object dataset 298G in FIG. |
| | | | 38, which is owned by the “UPS” Domain object |
| | | | and represents the “3100 East Cedar Street, |
| | | | #900, Ontario, CA 91761” Postal Address. |
| | | | From a UI event, a row in a BEAM Payload 664 |
| | | | is generated that includes the IP Address |
| | | | associated with the “.COM” Domain object |
| | | | (Machine C), a Connection Type designating |
| | | | “HTTP”, a Resource Type designating an OEP, |
| | | | a Statement comprising the Events, and |
| | | | Credentials comprising the Session ID, as |
| | | | illustrated in FIG. 27. |
| 4.2 | D | Agent | The BEAM Payload 664 is transported via the |
| | | | Connection Type to the Agent on Machine C, as |
| | | | illustrated in FIG. 27. |
| 4.3 | C | Agent/SM/ | Upon validating the Credentials within the |
| | | OQP | BEAM Payload 664, the Events 571 within the |
| | | | Statement of the BEAM Payload are submitted |
| | | | to the OEP for processing, as illustrated in FIG. |
| | | | 27. |
| 4.4 | C | OEP | A triggered action generates rows in Events that |
| | | | define a new aggregate “ADCTech” Customer |
| | | | as Member object, owned by the “.COM” |
| | | | Domain object, from the rows in Events that |
| | | | define the “ADCTech” Domain object. |
| | | | The Events that define the new “ADCTech” |
| | | | Domain object and “ADCTech” Customer as |
| | | | Member object are stored within Events dataset |
| | | | 591 in the SDS, as illustrated in FIG. 27. |
| | | | A triggered action generates rows in an Events |
| | | | dataset that define a mirrored “.COM” Vendor |
| | | | as Member object, owned by the “ADCTech” |
| | | | Domain object, from the rows in Events that |
| | | | define the “ADCTech” Customer as Member |
| | | | object. |
| | | | A triggered action generates a row in a BEAM |
| | | | Payload that includes the IP Address of the |
| | | | “ADCTech” Domain object (Machine B), a |
| | | | Connection Type designating “HTTP”, a |
| | | | Resource Type designating an OEP, a Statement |
| | | | comprising the Events that define the |
| | | | “ADCTech” Domain object and “.COM” |
| | | | Vendor as Member object, and Credentials |
| | | | comprising the “.COM” Domain object |
| | | | identifier. |
| 4.5 | C | Agent | The BEAM Payload is transported via the |
| | | | Connection Type to the Agent on Machine B. |
| 4.6 | B | Agent/SM/ | Upon validating the Credentials within the |
| | | OQP/OEP | BEAM Payload, Events that define a new |
| | | | Session object are stored within the SDS and the |
| | | | Session object identifier (Session ID) is included |
| | | | in a new row within a BEAM Response Payload |
| | | | dataset. |
| | | | The Events within the Statement of the BEAM |
| | | | Payload are submitted to the OEP for |
| | | | processing. |
| 4.7 | B | OEP | The Events that define the “ADCTech” Domain |
| | | | object and “.COM” Vendor as Member object |
| | | | are stored within the SDS. |
| 5.1 | D | PAR | From a UI event, a Queries dataset is generated |
| | | | that comprises attribute values from the |
| | | | Resultsets that define the portable application |
| | | | framework. |
| | | | A row in a BEAM Payload is generated that |
| | | | includes the IP Address associated with the |
| | | | “Zebra” domain object (Machine A), a |
| | | | Connection Type designating “HTTP”, a |
| | | | Resource Type designating an OQP, a Statement |
| | | | comprising the Queries, and Credentials |
| | | | comprising identifiers of the “Machine D” |
| | | | Machine object and “JSmith” Domain object. |
| 5.2 | D | Agent | The BEAM Payload is transported via the |
| | | | Connection Type to the Agent on Machine A. |
| 5.3 | A | Agent/SM/ | Upon validating the Credentials within the |
| | | OQP/OEP | BEAM Payload, Events that define a new |
| | | | Session object are stored within the SDS and the |
| | | | Session object identifier (Session ID) is included |
| | | | in a new row within a BEAM Response Payload |
| | | | dataset. |
| 5.4 | A | Agent | The Queries within the statement of the BEAM |
| | | | Payload are submitted to the OQP for |
| | | | processing. |
| 5.5 | A | OQP | A Resultsets is generated, with nested datasets |
| | | | that define a “Zebra Business Manager” portable |
| | | | application, from the query definitions within |
| | | | the second Queries dataset. The Resultsets |
| | | | comprises identifiers and human-readable names |
| | | | for the Entity and Attribute objects related to the |
| | | | aggregate “Business Manager” Item object, |
| | | | illustrated in Item Entity dataset 598K in FIG. |
| | | | 16. |
| | | | The human-readable names are derived from |
| | | | attribute values of Term objects that are related |
| | | | to the “Language” attribute value of the |
| | | | “JSmith” Domain object”. |
| | | | The Resultsets is returned to the Agent. |
| 5.6 | A | Agent | Another row in a BEAM Response Payload is |
| | | | generated that includes the Resultsets defining |
| | | | the portable application |
| | | | The BEAM Response Payload is returned via |
| | | | the same connection to the Agent on Machine D. |
| 5.7 | D | Agent | The Session ID and Resultsets defining a |
| | | | portable application within the rows of the |
| | | | BEAM Response Payload are submitted to the |
| | | | PAR for processing. |
| 5.8 | D | PAR/Agent | The “Zebra Business Manager” portable |
| | | | application is processed with the portable |
| | | | application framework to generate a View that is |
| | | | submitted to a Driver for processing. |
| 5.9 | D | Driver | An HTML script is generated from the View and |
| | | | submitted to the machine's display engine to |
| | | | render a user interface (UI) |
| 6.1 | D | PAR | From UI events, rows in an Events dataset are |
| | | | generated that define a new aggregate “QL420” |
| | | | Item object owned by the “Zebra” Domain |
| | | | object and include Entity and Attribute object |
| | | | identifiers from the “Zebra Business Manager” |
| | | | portable application that are paired with attribute |
| | | | values entered by the user, as illustrated in RI [0] |
| | | | through RI [3] in Table 25. |
| | | | From a UI event, a row in a BEAM Payload is |
| | | | generated that includes the IP Address |
| | | | associated with the “Zebra” Domain object |
| | | | (Machine A), a Connection Type designating |
| | | | “HTTP”, a Resource Type designating an OEP, |
| | | | a Statement comprising the Events, and |
| | | | Credentials comprising the Session ID. |
| 6.2 | D | Agent | The BEAM Payload is transported via the |
| | | | Connection Type to the Agent on Machine A. |
| 6.3 | A | Agent/SM | Upon validating the Credentials, the Events |
| | | OQP | within the Statement of the BEAM Payload are |
| | | | submitted to the OEP for processing. |
| 6.4 | A | OEP | A row in the submitted Events sets the “Unit |
| | | | Price” attribute value of the “QL420” Item |
| | | | object to “95” with a UOM identifier (i.e., |
| | | | “OC6A . . . ”) representing a “Euro” Unit of |
| | | | Measure object, as illustrated in RI [3] in Table |
| | | | 25. The “Base UOM” attribute value of the |
| | | | Attribute Value object related to the “Unit Price” |
| | | | Attribute object is set to the identifier (i.e., |
| | | | “674E . . . ”) representing a “US Dollar” Unit of |
| | | | Measure object, as illustrated in RI [1] of |
| | | | Attribute object dataset 593A and RI [2] of |
| | | | Attribute Value object dataset 593B in FIG. 18. |
| | | | A triggered action, based on the “Conversion |
| | | | Factor” attribute value of the “Euro” Unit of |
| | | | Measure object (illustrated as “.95” at index |
| | | | location [5][6] in Unit of Measure object dataset |
| | | | 598C in FIG. 19), generates a new row in Events |
| | | | that sets the “Unit Price” attribute value to “100” |
| | | | with a UOM identifier (i.e., “674E . . . ”) |
| | | | representing the base “US Dollar” Unit of |
| | | | Measure object, as illustrated in RI [4] in Table |
| | | | 25. |
| | | | A triggered action generates additional rows in |
| | | | Events that define a derived “67890” as “GTIN” |
| | | | Identifier object, owned by the “Zebra” Domain |
| | | | object and related to the “12345” as “Company |
| | | | Prefix” Identifier object owned by the “GS1” |
| | | | Domain object, from the rows in Events that |
| | | | define the “QL420” Item object, as illustrated in |
| | | | RI [5] through RI [10] in Table 25. |
| | | | As illustrated in FIG. 21, a triggered action |
| | | | generates a row in a BEAM Payload (i.e., |
| | | | Payload 261) that comprises a Resource Type |
| | | | designating a Driver, a Resource Connection |
| | | | identifying a specific database driver (e.g., SQL |
| | | | Server) and a database (i.e., TWO), and a |
| | | | Statement comprising a second Events dataset |
| | | | (i.e., Events 261A) based on rows in Events (i.e., |
| | | | RI [0] in Events 271). The “Object Entity” and |
| | | | “Object Attribute” elements within the second |
| | | | Events are derived from attribute values of an |
| | | | aggregate Item object (e.g., “IV00101” at index |
| | | | location [0][6] in Item Entity object dataset |
| | | | 298K) that correspond to elements in Events. |
| | | | A triggered action generates a row in the BEAM |
| | | | Payload for each Member object that is assigned |
| | | | a Member Service subscription to Item objects |
| | | | owned by the “Zebra” Domain object. |
| | | | The Events that define the new aggregate |
| | | | “QL420” Item object and Identifier object are |
| | | | stored within the SDS and illustrated in subsets |
| | | | of object datasets in FIG. 29, including RI [0] |
| | | | within Item object dataset 295, RI [0] and RI [1] |
| | | | within Item Attribute object dataset 298P, and |
| | | | RI [0] and RI [1] within Item Attribute Value |
| | | | object dataset 298Q. |
| | | | The BEAM Payload is submitted to the agent for |
| | | | processing. |
| 6.5 | A | Agent | Separate rows in the BEAM Payload are |
| | | | transported via the Connection Type to agents |
| | | | on remote machines for processing. |
| | | | The second Events within the statement in |
| | | | another row in the BEAM Payload is submitted |
| | | | to a Driver for processing. |
| 6.6 | A | Driver | An SQL script is generated from the Events and |
| | | | submitted to the machine's database engine to |
| | | | create a record in a table of a legacy business |
| | | | system database. |
| 7.1 | D | PAR | From UI events, rows in an Events dataset are |
| | | | generated that define a new aggregate Stock |
| | | | Transfer object owned by the “Zebra” Domain |
| | | | object and include Entity and Attribute object |
| | | | identifiers from the “Zebra Business Manager” |
| | | | portable application that are paired with attribute |
| | | | values entered by the user. |
| | | | From a UI event, a row in a BEAM Payload is |
| | | | generated that includes the IP Address |
| | | | associated with the “Zebra” Domain object |
| | | | (Machine A), a Connection Type designating |
| | | | “HTTP”, a Resource Type designating an OEP, |
| | | | a Statement comprising the Events, and |
| | | | Credentials comprising the Session ID. |
| 7.2 | D | Agent | The BEAM Payload is transported via the |
| | | | Connection Type to the Agent on Machine A. |
| 7.3 | A | Agent/SM | Upon validating the Credentials within the |
| | | OQP | BEAM Payload, the Events within the Statement |
| | | | of the BEAM Payload are submitted to the OEP |
| | | | for processing. |
| 7.4 | A | OEP | A triggered action generates rows in Events that |
| | | | define a Container object and two Item Serial |
| | | | objects, owned by the “Zebra” Domain object, |
| | | | from the rows in Events that define the |
| | | | aggregate Stock Transfer object. |
| | | | A triggered action generates additional rows in |
| | | | Events that define two derived Machine objects |
| | | | and supplemental Printer objects, and a derived |
| | | | Asset object, owned by the “Zebra” Domain |
| | | | object, from the rows in Events that define the |
| | | | two Item Serial objects. The identifiers of the |
| | | | derived Machine, Printer, and Asset objects are |
| | | | set to the identifier of the Item Serial object from |
| | | | which they were derived. |
| | | | A triggered action generates additional rows in |
| | | | Events, including the Events in Table 26, that |
| | | | define two derived “MAC Address” Identifier |
| | | | objects, owned by the “Zebra” Domain object, |
| | | | from the rows in Events that define the two |
| | | | Machine objects. |
| | | | Events that define the new aggregate Stock |
| | | | Transfer object and the derived objects are |
| | | | stored within the SDS, including the derived |
| | | | objects as illustrated in the subsets of Container |
| | | | object dataset 298R, Inventory object dataset |
| | | | 298V, Machine object dataset 297, Printer object |
| | | | dataset 298F, and Asset object dataset 298W, in |
| | | | FIG. 30. |
| 8.1 | E | Agent | On booting of the Agent of the un-provisioned |
| | | | machine, a row in a BEAM Payload is generated |
| | | | that includes an IP Address derived from the |
| | | | machine's MAC Address (Machine A), a |
| | | | Connection Type designating “HTTP”, a |
| | | | Resource Type designating an OQP, and a |
| | | | Statement comprising Queries for a portable |
| | | | application framework, and Credentials |
| | | | comprising the machine's MAC Address (i.e., |
| | | | “...00:B0”). |
| | | | A second row in a BEAM Payload is generated |
| | | | that includes the same IP Address, Connection |
| | | | Type, and Credentials, and includes a Resource |
| | | | Type designating an OEP, and Statement |
| | | | comprising a row in Events that comprises an |
| | | | “Event Sync Date/Time” attribute value. |
| | | | The BEAM Payload is transported via the |
| | | | Connection Type to the Agent on Machine A. |
| 8.2 | A | Agent/SM/ | Upon validating the Credentials within the |
| | | OQP/OEP | BEAM Payload, Events that define a new |
| | | | Session object are stored within the SDS and the |
| | | | Session object identifier (Session ID) is included |
| | | | in a new row within a BEAM Response Payload |
| | | | dataset. |
| | | | The Queries within the statement of a row in the |
| | | | BEAM Payload is submitted to the OQP for |
| | | | processing. |
| 8.3 | A | OQP | A Resultsets is generated from the submitted |
| | | | Queries that comprises attribute values of |
| | | | aggregate View objects and related objects |
| | | | within the SDS. |
| | | | A second Queries dataset is generated from the |
| | | | Resultsets and the Credentials. |
| | | | A second Resultsets is generated, with nested |
| | | | datasets that define a portable application |
| | | | framework, from the query definitions within the |
| | | | second Queries dataset. The second Resultsets |
| | | | comprises attribute values from aggregate View |
| | | | objects and identifiers and human-readable |
| | | | names for the Entity and Attribute objects |
| | | | related to the framework, including the |
| | | | aggregate “Task” Entity object, which are |
| | | | retrieved from the SDS. |
| | | | The human-readable names are derived from |
| | | | attribute values of Term objects that are related |
| | | | to the “Language” attribute value of the |
| | | | “JSmith” Domain object”. |
| | | | The second Resultsets is returned to the Agent. |
| 8.4 | A | Agent | Another row in a BEAM Response Payload is |
| | | | generated that includes the second Resultsets |
| | | | defining the portable application framework. |
| | | | The Events within the statement of another row |
| | | | in the BEAM Payload is submitted to the OEP |
| | | | for processing. |
| 8.5 | A | OEP | A triggered action generates an Events dataset |
| | | | from the rows in Events stored in the SDS that |
| | | | define the “Zebra QL420 Printer 1” Machine |
| | | | object (identified by the Credentials as |
| | | | representing Machine E) and all related objects |
| | | | and their current attribute values containing a |
| | | | “Time Stamp” value postdating the “Event Sync |
| | | | Date/Time” attribute value within the submitted |
| | | | Events dataset. The objects defined by the new |
| | | | events dataset include RI [0] in Machine object |
| | | | dataset 297, RI [0] in Printer object dataset |
| | | | 298F, and RI [1] in Item object dataset 295, as |
| | | | illustrated in FIG. 30. The objects defined by |
| | | | these events also include the rows in the subsets |
| | | | of Item Attribute object dataset 298P, Attribute |
| | | | object dataset 293A, Item Attribute Value object |
| | | | dataset 298Q, and Attribute Value object dataset |
| | | | 293B, as illustrated in FIG. 29. |
| | | | A triggered action generates a row in a BEAM |
| | | | Payload that includes a Resource Type |
| | | | designating an OEP and a Statement comprising |
| | | | the Events dataset. |
| 8.6 | A | Agent | Another row in a BEAM Response Payload is |
| | | | generated that includes the BEAM Payload |
| | | | containing the Events dataset. |
| 8.7 | A | Agent | The BEAM Response Payload is returned via |
| | | | the same connection to the Agent on Machine E. |
| 8.8 | E | Agent | The Resultsets, within a row in the BEAM |
| | | | Response Payload, that define a portable |
| | | | application framework are stored in the Runtime |
| | | | dataset within the SDS. |
| | | | The Events within the BEAM Payload within |
| | | | another row in the BEAM Response Payload are |
| | | | submitted to the OEP for processing. |
| 8.9 | E | OEP | A triggered action generates a row in the |
| | | | submitted Events that sets the “Event Sync |
| | | | Date/Time” attribute value of the “Zebra QL420 |
| | | | Printer 1” Machine object to the most recent |
| | | | “Time Stamp” value in the submitted Events. |
| | | | The Events that define the new Machine object |
| | | | and related objects are stored within the SDS as |
| | | | illustrated FIG. 31 and FIG. 32, and include the |
| | | | rows in the subsets of Machine object dataset |
| | | | 797, Domain object dataset 792, Entity object |
| | | | dataset 793, Attribute object dataset 793A, |
| | | | Attribute Value object dataset 793B, Term |
| | | | object dataset 794, Item object dataset 795, |
| | | | Printer object dataset 798F, Item Attribute object |
| | | | dataset 798P, and Item Attribute Value object |
| | | | dataset 798Q. The related objects also include |
| | | | aggregate Trigger objects including RI [9] |
| | | | through RI [13] in the Trigger object dataset |
| | | | illustrated in Table 22 and RI [18] through RI |
| | | | [24] in the Trigger Action object dataset |
| | | | illustrated in Table 23. |
| 8.10 | E | Agent | On re-booting of the Agent, the portable |
| | | | application framework is retrieved from the |
| | | | Runtime dataset within the SDS and submitted |
| | | | to the PAR for processing. |
| 8.11 | E | PAR | A Queries dataset is generated that comprises |
| | | | attribute values from within the portable |
| | | | application framework. |
| | | | A row in a BEAM Payload is generated that |
| | | | includes a Connection Type designating “Local |
| | | | Machine” (Machine E), a Resource Type |
| | | | designating an OQP, and a Statement |
| | | | comprising the Queries. |
| 8.12 | E | Agent | The Queries within the statement of the BEAM |
| | | | Payload are submitted to the OQP for |
| | | | processing. |
| 8.13 | E | OQP | A Resultsets 763 is generated, with nested |
| | | | datasets that define a “Zebra QL420 Printer” |
| | | | portable application, from the query definitions |
| | | | within the Queries dataset 773, as illustrated in |
| | | | FIG. 34. The Resultsets 763 comprises |
| | | | identifiers and human-readable names for the |
| | | | Entity and Attribute objects related to the |
| | | | Machine object representing Machine E (i.e., |
| | | | identifier “8C65 . . . ” at index location [0][0] |
| | | | within Attribute object dataset 793A and human- |
| | | | readable name “Name” at index location [0][3] |
| | | | within Term object dataset 794) which are |
| | | | retrieved from the SDS. |
| | | | The human-readable names are derived from |
| | | | attribute values of Term objects that are related |
| | | | to the “Language” attribute value of the |
| | | | “JSmith” Domain object”. |
| | | | The Resultsets is returned to the PAR. |
| 8.14 | E | PAR/Agent | The “Zebra QL420 Printer” portable application |
| | | | is processed with the portable application |
| | | | framework to generate a View that is submitted |
| | | | to a Driver for processing. |
| 8.15 | E | Driver | The View is submitted to the machine's display |
| | | | engine to render a user interface (UI). |
| 9.1 | D | PAR | From a UI event, a Queries dataset is generated |
| | | | that comprises attribute values from within the |
| | | | portable application framework. |
| | | | A row in a BEAM Payload is generated that |
| | | | includes the MAC Address or IP Address |
| | | | associated with a printer (Machine E), a |
| | | | Connection Type designating “Bluetooth”, a |
| | | | Resource Type designating an OQP, a Statement |
| | | | comprising the Queries, and Credentials |
| | | | comprising identifiers of the “Machine D” |
| | | | Machine object and “JSmith” Domain object. |
| 9.2 | D | Agent | The BEAM Payload is transported via the |
| | | | Connection Type to the Agent on Machine E. |
| 9.3 | E | Agent/SM/ | Upon validating the Credentials within the |
| | | OQP/OEP | BEAM Payload, Events that define a new |
| | | | Session object are stored within the SDS and the |
| | | | Session object identifier (Session ID) is included |
| | | | in a new row within a BEAM Response Payload |
| | | | dataset. |
| 9.4 | E | Agent | The Queries within the statement of the BEAM |
| | | | Payload are submitted to the OQP for |
| | | | processing. |
| 9.5 | E | OQP | A Resultsets 763 is generated, with nested |
| | | | datasets that define a “Zebra QL420 Printer” |
| | | | portable application, from the query definitions |
| | | | within the Queries dataset 773, as illustrated in |
| | | | FIG. 34. The Resultsets comprises identifiers |
| | | | and human-readable names for the Entity and |
| | | | Attribute objects related to the Machine object |
| | | | representing Machine E which are retrieved |
| | | | from the SDS. |
| | | | The human-readable names are derived from |
| | | | attribute values of Term objects that are related |
| | | | to the “Language” attribute value of the |
| | | | “JSmith” Domain object”. |
| | | | The Resultsets is returned to the Agent. |
| 9.6 | E | Agent | Another row in a BEAM Response Payload is |
| | | | generated that includes the Resultsets defining |
| | | | the portable application. |
| 9.7 | E | Agent | The BEAM Response Payload is returned via |
| | | | the same connection to the Agent on Machine D. |
| 9.8 | D | Agent | The Session ID and Resultsets defining the |
| | | | portable application within the rows of the |
| | | | BEAM Response Payload are submitted to the |
| | | | PAR for processing. |
| 9.9 | D | PAR | The “Zebra QL420 Printer” portable application |
| | | | is processed with the portable application |
| | | | framework to generate a View that is submitted |
| | | | to a Driver for processing. |
| 9.10 | D | Driver | An HTML script is generated from the View and |
| | | | submitted to the machine's display engine to |
| | | | render a user interface (UI) |
| 10.1 | D | PAR | From a UI event, a Queries dataset is generated |
| | | | to retrieve current attribute values of the |
| | | | Machine object representing Machine E, and |
| | | | includes Entity and Attribute object identifiers |
| | | | from the “Zebra QL420 Printer” portable |
| | | | application. |
| | | | From a UI event, a row in a BEAM Payload is |
| | | | generated that includes the MAC Address or IP |
| | | | Address associated with the printer (Machine E), |
| | | | a Connection Type designating “Bluetooth”, a |
| | | | Resource Type designating an OQP, a Statement |
| | | | comprising the Queries, and Credentials |
| | | | comprising the Session ID. |
| 10.2 | D | Agent | The BEAM Payload is transported via the |
| | | | Connection Type to the Agent on Machine E. |
| 10.3 | E | Agent/SM/ | Upon validating the Credentials within the |
| | | OQP | BEAM Payload, the Queries within the |
| | | | Statement of the BEAM Payload are submitted |
| | | | to the OQP for processing. |
| 10.4 | E | OQP | A Resultsets is generated from the Queries |
| | | | dataset and comprises attribute values of a |
| | | | Machine object and related objects within the |
| | | | SDS. The Resultsets is returned to the Agent. |
| 10.5 | E | Agent | A row in a BEAM Response Payload is |
| | | | generated that includes the Resultsets. |
| | | | The BEAM Response Payload is returned via |
| | | | the same connection to the Agent on Machine D. |
| 10.6 | D | Agent | The Resultsets within the BEAM Response |
| | | | Payload is submitted to the PAR for processing. |
| 10.7 | D | PAR/Agent | The Resultsets is processed with the portable |
| | | | application framework and portable application |
| | | | to generate a View representing current printer |
| | | | settings that is submitted to a Driver for |
| | | | processing. |
| 10.8 | D | Driver | The View is submitted to the machine's display |
| | | | engine to render a user interface (UI). |
| 11.1 | D | PAR | From UI events, rows in an Events dataset are |
| | | | generated that set attribute values of the |
| | | | Machine object representing Machine E, and |
| | | | includes Entity and Attribute object identifiers |
| | | | from the “Zebra QL420 Printer” portable |
| | | | application that are paired with attribute values |
| | | | entered by the user, as illustrated in Table 27. |
| | | | From a UI event, a row in a BEAM Payload is |
| | | | generated that includes the MAC Address or IP |
| | | | Address associated with the printer (Machine E), |
| | | | a Connection Type designating “Bluetooth”, a |
| | | | Resource Type designating an OEP, a Statement |
| | | | comprising the Events, and Credentials |
| | | | comprising the Session ID. |
| 11.2 | D | Agent | The BEAM Payload is transported via the |
| | | | Connection Type to the Agent on Machine E. |
| 11.3 | E | Agent/SM/ | Upon validating the Credentials within the |
| | | OQP | BEAM Payload, the Events within the Statement |
| | | | of the BEAM Payload are submitted to the OEP |
| | | | for processing. |
| 11.4 | E | OEP | The Events that set attribute values of the |
| | | | Machine object are stored within the SDS. |
| | | | A triggered action generates a row in a BEAM |
| | | | Payload (i.e., Payload 761) that comprises a |
| | | | Resource Type designating a Driver, a Resource |
| | | | Connection identifying a specific |
| | | | microcontroller and port pin collection, and a |
| | | | Statement comprising a second Events dataset, |
| | | | illustrated in Table 28, based on a subset of rows |
| | | | in Events (i.e., RI [1] in Table 27). The “Object |
| | | | Attribute” and “Attribute Value” elements |
| | | | within the second Events are derived from |
| | | | attribute values of the aggregate Item object, |
| | | | representing the model of Machine E, that |
| | | | correspond to elements in Events. |
| | | | As illustrated in FIG. 33, the Attribute object |
| | | | identified by the “Object Attribute” element |
| | | | value a row in the Events dataset (i.e., |
| | | | “CA31 . . . ” at index location [1][5] in Table 27) |
| | | | is also identified by the “Attribute” attribute |
| | | | value of an Item Attribute object (i.e., RI [1] in |
| | | | Item Attribute object dataset 798P) within the |
| | | | SDS. The “Element” attribute value of the Item |
| | | | Attribute object (i.e., “4” at index location [1][4] |
| | | | in Item Attribute object dataset 798P) |
| | | | corresponds to a port pin (i.e., pin 4) within a |
| | | | microcontroller (i.e., data store 790B) which is |
| | | | powered based on the “Attribute Value” element |
| | | | value (i.e., “6”) in the row in the Events dataset |
| | | | in proportion to the “Factor” attribute value of |
| | | | the Item Attribute object (i.e., “.01” at index |
| | | | location [1][10] in Item Attribute object dataset |
| | | | 798P). The “Object Attribute” element value in |
| | | | the row of the second Events is set to the |
| | | | “Element” attribute value (i.e., “4”) of the Item |
| | | | Attribute object, and the “Attribute Value” |
| | | | element in the row of the second Events dataset |
| | | | is set to the calculated value (i.e., “.06) from the |
| | | | “Attribute Value” element value multiplied by |
| | | | the “Factor” attribute value. |
| | | | The BEAM Payload is submitted to the agent for |
| | | | processing. |
| 11.5 | E | Agent | The second Events within the statement in the |
| | | | row in the BEAM Payload is submitted to a |
| | | | Driver for processing |
| 11.6 | E | Driver | An actuator 789 is powered based on value 736 |
| | | | sent to its port pin (i.e., pin 4) within a |
| | | | microcontroller that is based on the “Attribute |
| | | | Value” element value in the row in the Events |
| | | | dataset. |
| 12.1 | D | PAR | From a UI event, a Queries dataset is generated |
| | | | that comprises attribute values from the |
| | | | Resultsets that define the portable application |
| | | | framework. |
| | | | From a UI event, a row in a BEAM Payload is |
| | | | generated that includes the IP Address |
| | | | associated with the “ADCTech” Domain object |
| | | | (Machine B), a Connection Type designating |
| | | | “HTTP”, a Resource Type designating an OQP, |
| | | | a Statement comprising the Queries, and |
| | | | Credentials comprising identifiers of the |
| | | | “Machine D” Machine object and “JSmith” |
| | | | Domain object. |
| 12.2 | D | Agent | The BEAM Payload is transported via the |
| | | | Connection Type to the Agent on Machine B. |
| 12.3 | B | Agent/SM/ | Upon validating the Credentials within the |
| | | OQP/OEP | BEAM Payload, Events that define a new |
| | | | Session object are stored within the SDS and the |
| | | | Session object identifier (Session ID) is included |
| | | | in a new row within a BEAM Response Payload |
| | | | dataset. |
| 12.4 | B | Agent | The Queries within the Statement of the BEAM |
| | | | Payload are submitted to the OQP for |
| | | | processing. |
| 12.5 | B | OQP | A Resultsets is generated, with nested datasets |
| | | | that define a “ADCTech Business Manager” |
| | | | portable application, from the query definitions |
| | | | within the second Queries dataset. The |
| | | | Resultsets comprises identifiers and human- |
| | | | readable names for the Entity and Attribute |
| | | | objects related to the aggregate “Business |
| | | | Manager” Item object, illustrated in Item Entity |
| | | | dataset 598K in FIG. 16. |
| | | | The human-readable names are derived from |
| | | | attribute values of Term objects that are related |
| | | | to the “Language” attribute value of the |
| | | | “JSmith” Domain object”. |
| | | | The Resultsets is returned to the Agent. |
| 12.6 | B | Agent | Another row in the BEAM Response Payload is |
| | | | generated that includes the Resultsets defining |
| | | | the portable application. |
| | | | The BEAM Response Payload is returned via |
| | | | the same connection to the Agent on Machine D. |
| 12.7 | D | Agent | The Session ID and Resultsets defining a |
| | | | portable application within the rows of the |
| | | | BEAM Response Payload are submitted to the |
| | | | PAR for processing. |
| 12.8 | D | PAR/Agent | The “ADCTech Business Manager” portable |
| | | | application is processed with the portable |
| | | | application framework to generate a View that is |
| | | | submitted to a Driver for processing. |
| 12.9 | D | Driver | An HTML script is generated from the View and |
| | | | submitted to the machine's display engine to |
| | | | render a user interface (UI). |
| 13.1 | D | PAR | From UI events, rows in an Events dataset are |
| | | | generated that define a new aggregate “Zebra” |
| | | | Vendor as Member object owned by the |
| | | | “ADCTech” Domain object and include Entity |
| | | | and Attribute object identifiers from the |
| | | | “ADCTech Business Manager” portable |
| | | | application that are paired with attribute values |
| | | | entered by the user. |
| | | | From a UI event, a row in a BEAM Payload is |
| | | | generated that includes the IP Address |
| | | | associated with the “ADCTech” Domain object |
| | | | (Machine B), a Connection Type designating |
| | | | “HTTP”, a Resource Type designating an OEP, |
| | | | a Statement comprising the Events, and |
| | | | Credentials comprising the Session ID. |
| 13.2 | D | Agent | The row in the BEAM Payload is transported via |
| | | | the Connection Type to the Agent on Machine |
| | | | B. |
| 13.3 | B | Agent/SM | Upon validating the Credentials within the |
| | | | BEAM Payload, the Events within the Statement |
| | | | of the BEAM Payload are submitted to the OEP |
| | | | for processing. |
| 13.4 | B | OEP | The Events that define the new “Zebra” Vendor |
| | | | as Member object are stored within the SDS. |
| | | | As illustrated in FIG. 36, a triggered action (i.e., |
| | | | RI [0] in Action object dataset 496A) generates |
| | | | rows RI [2] and RI [3] in Events dataset 491 that |
| | | | define a mirrored “ADCTech” Customer as |
| | | | Member object, owned by the “Zebra” Domain |
| | | | object, from rows RI [0] and RI [1] in Events |
| | | | dataset 491 that define the “Zebra” Vendor as |
| | | | Member object. |
| | | | A triggered action generates a row in a BEAM |
| | | | Payload that includes the IP Address of the |
| | | | “Zebra” Domain object (Machine A), the |
| | | | identification of an OEP, a Statement |
| | | | comprising the Events that define the |
| | | | “ADCTech” Customer as Member object, and |
| | | | Credentials comprising the “ADCTech” Domain |
| | | | object identifier. |
| 13.5 | A | Agent/SM/ | Upon validating the Credentials within the |
| | | OQP/OEP | BEAM Payload, Events that define a new |
| | | | Session object are stored within the SDS and the |
| | | | Session object identifier (Session ID) is included |
| | | | in a new row within a BEAM Response Payload |
| | | | dataset. |
| 13.6 | A | Agent | The Events within the Statement of the BEAM |
| | | | Payload are submitted to the OEP for |
| | | | processing. |
| 13.7 | A | OEP | A triggered action generates a row (i.e. RI [0]) in |
| | | | Events that sets the “Status” attribute value of |
| | | | the “ADCTech” Customer as Member object to |
| | | | an enumerated value designating “Approved” as |
| | | | illustrated in Table 29. |
| | | | A triggered action generates rows (i.e. RI [1] and |
| | | | RI [2]) in Events that define a new Member |
| | | | Service object related to the “Business Manager” |
| | | | Item object as illustrated in Table 29. |
| | | | The Events that define the aggregate Member |
| | | | object, including the Events in Table 29, are |
| | | | stored within the SDS. |
| 13.8 | A | Agent/OEP/ | A triggered action generates a second Events |
| | | OQP | dataset from the rows in Events stored in the |
| | | | SDS that define aggregate objects (e.g., the |
| | | | “QL420” Item object) of the entities (e.g., |
| | | | “Item” Entity object) related to the aggregate |
| | | | “Business Manager” Item object, as illustrated in |
| | | | Item Entity dataset 598K in FIG. 16. The |
| | | | second Events dataset includes rows in Events |
| | | | stored in the SDS owned by the “Zebra” Domain |
| | | | and containing a “Time Stamp” element value |
| | | | postdating the “Event Sync Date/Time” attribute |
| | | | value of the “ADCTech” Customer as Member |
| | | | object. The second Events dataset only includes |
| | | | objects of a subset of entities (e.g., the |
| | | | “Transaction” Entity object) that are related to |
| | | | the “ADCTech” Customer as Member object. |
| | | | A triggered action generates a row in a BEAM |
| | | | Payload that includes a Resource Type |
| | | | designating an OEP and a Statement comprising |
| | | | the second Events dataset and the Events in |
| | | | Table 29. |
| 13.9 | A | Agent | Another row in a BEAM Response Payload is |
| | | | generated that includes the BEAM Payload from |
| | | | the OEP that contains the second Events. |
| | | | The BEAM Response Payload is returned via |
| | | | the same connection to the Agent on Machine B. |
| 13.10 | B | Agent | The Events within the BEAM Payload within a |
| | | | row in the BEAM Response Payload are |
| | | | submitted to the OEP for processing. |
| 13.11 | B | OEP | A triggered action generates a row in the |
| | | | submitted Events that sets the “Event Sync |
| | | | Date/Time” attribute value of the “Zebra” |
| | | | Vendor as Member object to the most recent |
| | | | “Time Stamp” value in the submitted Events. |
| | | | The Events that define the synchronized objects |
| | | | are stored within the SDS. |
| 14.1 | D | PAR | From UI events, rows in an Events dataset are |
| | | | generated that define a new aggregate Purchase |
| | | | Order object owned by the “ADCTech” Domain |
| | | | object and include Entity and Attribute object |
| | | | identifiers from the “ADCTech Business |
| | | | Manager” portable application that are paired |
| | | | with attribute values entered by the user, as |
| | | | illustrated in Table 30. |
| | | | From a UI event, a row in a BEAM Payload is |
| | | | generated that includes the IP Address |
| | | | associated with the “ADCTech” Domain object |
| | | | (Machine B), a Connection Type designating |
| | | | “HTTP”, a Resource Type designating an OEP, |
| | | | a Statement comprising the Events, and |
| | | | Credentials comprising the Session ID. |
| 14.2 | D | Agent | The BEAM Payload is transported via the |
| | | | Connection Type to the Agent on Machine B. |
| 14.3 | B | Agent/SM/ | Upon validating the Credentials, the Events |
| | | OQP | within the Statement of the BEAM Payload are |
| | | | submitted to the OEP for processing. |
| 14.4 | B | OEP | A row in the submitted Events includes the |
| | | | “Attribute Value” element value of |
| | | | “1234567890” for the “Item” attribute of the |
| | | | Purchase Order Item object, as illustrated in RI |
| | | | [5] in Table 30. The OEP converts this element |
| | | | value to the identifier (i.e., “EO2B . . . ”) of the |
| | | | “QL420” Item object based on the matching |
| | | | Identifier object defined by the events illustrated |
| | | | in Table 25 (having a “Value” attribute value of |
| | | | “68790”) when combined with the Parent |
| | | | Identifier object illustrated in RI [3] in Identifier |
| | | | object dataset 298X in FIG. 22 (having a |
| | | | “Value” attribute value of “12345”). |
| | | | The Events that define the new aggregate |
| | | | Purchase Order object are stored within the SDS, |
| | | | as illustrated in RI [0] in Transaction object |
| | | | dataset 498H and RI [0] in Transaction Item |
| | | | object dataset 498I in FIG. 37. |
| | | | Elements in a row in the Events (i.e., RI [7] in |
| | | | Table 30) satisfy a condition defined in RI [1] in |
| | | | the Trigger object dataset illustrated in Table 22, |
| | | | which invokes the triggered action defined in RI |
| | | | [1] in the Trigger Action object dataset |
| | | | illustrated in Table 23. |
| | | | The triggered action generates rows in Events |
| | | | that define a mirrored aggregate Sales Order |
| | | | object, owned by the “Zebra.com” Domain |
| | | | object, from the rows in Events that define the |
| | | | aggregate Purchase Order object. |
| | | | The Sales Order object identifier is set to the |
| | | | Purchase Order object identifier (i.e., “6632 . . . ”). |
| | | | The “Member” attribute value of the Sales Order |
| | | | is set to the object identifier for the “ADCTech” |
| | | | Customer as Member object, which is the same |
| | | | as the “Member” attribute value of the Purchase |
| | | | Order which is set to the object identifier for the |
| | | | “Zebra” Vendor as Member object. |
| | | | A triggered action generates a row in a BEAM |
| | | | Payload that includes the IP Address of the |
| | | | “Zebra” Domain object (Machine A), a |
| | | | Connection Type designating “HTTP”, a |
| | | | Resource Type designating an OEP, a Statement |
| | | | comprising the Events that define the aggregate |
| | | | Sales Order object, and Credentials comprising |
| | | | the “ADCTech” Domain object identifier. |
| 14.5 | B | Agent | The BEAM Payload is transported via the |
| | | | Connection Type to the Agent on Machine A. |
| 14.6 | A | Agent/SM/ | Upon validating the Credentials within the |
| | | OQP/OEP | BEAM Payload, Events that define a new |
| | | | Session object are stored within the SDS and the |
| | | | Session object identifier (Session ID) is included |
| | | | in a new row within a BEAM Response Payload |
| | | | dataset. |
| | | | The Events within the Statement of the BEAM |
| | | | Payload are submitted to the OEP for |
| | | | processing. |
| 14.7 | A | OEP | Elements in a row in the submitted Events |
| | | | satisfy a condition defined in RI [2] in the |
| | | | Trigger object dataset illustrated in Table 22, |
| | | | which invokes the triggered actions defined in |
| | | | RI [2] and RI [3] in the Trigger Action object |
| | | | dataset illustrated in Table 23. |
| | | | One of the triggered actions generates rows in |
| | | | Events that define a derived aggregate Shipment |
| | | | object, owned by the “Zebra” Domain object, |
| | | | from the rows in Events that define the |
| | | | aggregate Sales Order object. |
| | | | Elements in a row in the generated Events |
| | | | satisfy a condition defined in RI [3] in the |
| | | | Trigger object dataset illustrated in Table 22, |
| | | | which invokes the triggered actions defined in |
| | | | RI [4] and RI [5] in the Trigger Action object |
| | | | dataset illustrated in Table 23. |
| | | | One of the triggered actions generates rows in |
| | | | Events that define a derived aggregate Stock |
| | | | Transfer object, owned by the “Zebra” Domain |
| | | | object, from the rows in Events that define the |
| | | | aggregate Shipment object. |
| | | | Elements in a row in the generated Events |
| | | | satisfy a condition defined in RI [4] in the |
| | | | Trigger object dataset illustrated in Table 22, |
| | | | which invokes the triggered actions defined in |
| | | | RI [6] and RI [7] in the Trigger Action object |
| | | | dataset illustrated in Table 23. |
| | | | One of the triggered actions generates rows in |
| | | | Events that define an assigned aggregate Task |
| | | | object, owned by the “Zebra” Domain object, |
| | | | from the rows in Events that define the |
| | | | aggregate Stock Transfer object. |
| | | | A Queries dataset is generated to retrieve current |
| | | | attribute values of the aggregate Stock Transfer |
| | | | object, and includes Entity and Attribute object |
| | | | identifiers from the rows in Events that define |
| | | | the aggregate Stock Transfer object. |
| | | | The “Subject” attribute value of the parent Task |
| | | | object is set to the Queries dataset. The |
| | | | “Member” attribute value of the child Task |
| | | | Assignee object is set to the identifier of an |
| | | | available Sales Agent as Member object (e.g., |
| | | | “JSmith” Sales Agent as Member object as |
| | | | illustrated in Member object dataset 298B in |
| | | | FIG. 40). |
| | | | The Events that define the new aggregate Sales |
| | | | Order object, Shipment object, Stock Transfer |
| | | | object, and Task object are stored within the |
| | | | SDS, as illustrated in RI [1] through RI [3] in |
| | | | Transaction object dataset 298H in FIG. 38; RI |
| | | | [1] through RI [3] in Transfer Item object dataset |
| | | | 298I and RI [1] through RI [2] in Transaction |
| | | | Container object dataset 298S in FIG. 39; and RI |
| | | | [0] in Message object dataset 298T and RI [0] in |
| | | | Message Recipient object dataset 298U in FIG. |
| | | | 40. |
| | | | A triggered action generates a row in a BEAM |
| | | | Payload for each Task Assignee object related to |
| | | | the aggregate Task object (e.g., RI [0] in |
| | | | Message Recipient object dataset 298U in FIG. |
| | | | 40). Each new row includes a Connection Type, |
| | | | Credentials comprising the “Zebra” Domain |
| | | | object identifier, a Resource Type designating an |
| | | | OEP, and a Statement comprising Events that |
| | | | define a mirrored Task object owned by the |
| | | | Domain object identified by the “Member |
| | | | Domain” attribute value of the Member object |
| | | | identified by the “Member” attribute value of the |
| | | | Task Assignee object. Each new row in the |
| | | | BEAM Payload includes the “IP Address” |
| | | | attribute value of the Domain object identified |
| | | | by the “Owner Domain” attribute value of the |
| | | | mirrored Task object. In this case, a new row |
| | | | includes the IP Address of the “JSmith” Domain |
| | | | object (Machine D). |
| 14.8 | A | Agent | The BEAM Payload is transported via the |
| | | | Connection Type to the Agent on Machine D. |
| 14.9 | D | Agent/SM/ | Upon validating the Credentials within the |
| | | OQP/OEP | BEAM Payload, Events that define a new |
| | | | Session object are stored within the SDS and the |
| | | | Session object identifier (Session ID) is included |
| | | | in a new row within a BEAM Response Payload |
| | | | dataset. |
| | | | The Events within the Statement of the BEAM |
| | | | Payload are submitted to the OEP for |
| | | | processing. |
| 14.10 | D | OEP | The Events that define the mirrored Task object |
| | | | are stored within the SDS as illustrated in RI [0] |
| | | | in Message object dataset 698T in FIG. 40. |
| | | | A triggered action submits the Events to the |
| | | | PAR for processing. |
| 14.11 | D | PAR/ | The events that define the mirrored Task object |
| | | Agent | are processed with the portable application |
| | | | framework to generate a View, representing the |
| | | | current task settings, that is submitted to a |
| | | | Driver for processing. |
| 14.12 | D | Driver | An HTML script is generated from the View and |
| | | | submitted to the machine's display engine to |
| | | | render a user interface (UI) |
| 15.1 | D | PAR | From a UI event related to the “Subject” |
| | | | attribute of the Task object, a first Queries |
| | | | dataset is generated that comprises attribute |
| | | | values from within the portable application |
| | | | framework. |
| | | | A row in a BEAM Payload is generated that |
| | | | includes the IP Address associated with the |
| | | | “Zebra” Domain object (Machine A), a |
| | | | Connection Type designating “HTTP”, a |
| | | | Resource Type designating an OQP, a Statement |
| | | | comprising the first Queries, and Credentials |
| | | | comprising the “JSmith” Domain object |
| | | | identifier. |
| | | | A second Queries dataset is generated from the |
| | | | “Subject” attribute value of the Task object |
| | | | which comprises a Queries dataset (i.e., Queries |
| | | | 673 illustrated in FIG. 40). |
| | | | A second row in a BEAM Payload is generated |
| | | | that includes the IP Address associated with the |
| | | | “Zebra” Domain object (Machine A), a |
| | | | Connection Type designating “HTTP”, a |
| | | | Resource Type designating an OQP, a Statement |
| | | | comprising the second Queries, and Credentials |
| | | | comprising identifiers of the “Machine D” |
| | | | Machine object and “JSmith” Domain object. |
| 15.2 | D | Agent | The BEAM Payload is transported via the |
| | | | Connection Type to the Agent on Machine A. |
| 15.3 | A | Agent/SM/ | Upon validating the Credentials within the |
| | | OQP/OEP | BEAM Payload, Events that define a new |
| | | | Session object are stored within the SDS and the |
| | | | Session object identifier (Session ID) is included |
| | | | in a new row within a BEAM Response Payload |
| | | | dataset. |
| | | | The Queries within the Statement of the two |
| | | | rows of the BEAM Payload are submitted to the |
| | | | OQP for processing. |
| 15.4 | A | OQP/Agent | A first Resultsets is generated, with nested |
| | | | datasets that define a “Zebra Business Manager” |
| | | | portable application, from the query definitions |
| | | | within the first Queries dataset. The first |
| | | | Resultsets comprises identifiers and human- |
| | | | readable names for the Entity and Attribute |
| | | | objects related to the aggregate “Business |
| | | | Manager” Item object, illustrated in Item Entity |
| | | | dataset 598K in FIG. 16. |
| | | | The human-readable names are derived from |
| | | | attribute values of Term objects that are related |
| | | | to the “Language” attribute value of the |
| | | | “JSmith” Domain object”. |
| | | | Another row in a BEAM Response Payload is |
| | | | generated that includes the first Resultsets |
| | | | defining the portable application. |
| | | | A second Resultsets is generated from the |
| | | | second Queries dataset and comprises attribute |
| | | | values of the aggregate Stock Transfer object |
| | | | (i.e., RI [3] in Transaction object dataset 298H |
| | | | in FIG. 38) and related objects within the SDS. |
| | | | Another row in a BEAM Response Payload is |
| | | | generated that includes the second Resultsets. |
| 15.5 | A | Agent | The BEAM Response Payload is returned via |
| | | | the same connection to the Agent on Machine D. |
| 15.6 | D | Agent | The Session ID, first Resultsets defining the |
| | | | “Zebra Business Manager” portable application, |
| | | | and second Resultsets containing attribute values |
| | | | of the aggregate Stock Transfer object, all within |
| | | | the rows of the BEAM Response Payload, are |
| | | | submitted to the PAR for processing. |
| 15.7 | D | PAR/Agent | The “Zebra Business Manager” portable |
| | | | application and second Resultsets are processed |
| | | | with the portable application framework to |
| | | | generate a View, comprising attribute values of |
| | | | the Stock Transfer object, that is submitted to a |
| | | | Driver for processing. |
| 15.8 | D | Driver | An HTML script is generated from the View and |
| | | | submitted to the machine's display engine to |
| | | | render a user interface (UI) |
| 16.1 | D | PAR | From UI events, rows in an Events dataset are |
| | | | generated that set attribute values of the |
| | | | aggregate Stock Transfer object, and includes |
| | | | Entity and Attribute object identifiers from the |
| | | | “Zebra Business Manager” portable application |
| | | | that are paired with the attribute values entered |
| | | | by the user. |
| | | | From a UI event, a row in a BEAM Payload is |
| | | | generated that includes the IP Address |
| | | | associated with the “Zebra” Domain object |
| | | | (Machine A), a Connection Type designating |
| | | | “HTTP”, a Resource Type designating an OEP, |
| | | | a Statement comprising the Events, and |
| | | | Credentials comprising the Session ID. |
| 16.2 | D | Agent | The BEAM Payload is transported via the |
| | | | Connection Type to the Agent on Machine A. |
| 16.3 | A | Agent/SM/ | Upon validating the Credentials, the Events |
| | | OQP | within the Statement of the BEAM Payload are |
| | | | submitted to the OEP for processing. |
| 16.4 | A | OEP | Elements in a row in the submitted Events |
| | | | satisfy a condition defined in RI [5] in the |
| | | | Trigger object dataset illustrated in Table 22, |
| | | | which invokes the triggered actions defined in |
| | | | RI [8] through RI [10] in the Trigger Action |
| | | | object dataset illustrated in Table 23. |
| | | | One of the triggered actions generates a row in |
| | | | Events, as illustrated in RI [0] in Table 31, that |
| | | | sets the “Location” attribute value of the |
| | | | Container object (index location [0][4] in the |
| | | | Container object dataset 298R in FIG. 39), |
| | | | related to the Stock Transfer Container object |
| | | | related to the Stock Transfer object, to the “To |
| | | | Location” attribute value of the Stock Transfer |
| | | | object (i.e., “632C . . . ” at index location [3][8] in |
| | | | the Transaction object dataset 298H in FIG. 38). |
| | | | The Events that set attribute values of the Stock |
| | | | Transfer object, Container object, and Shipment |
| | | | object are stored within the SDS. |
| | | | A triggered action generates rows in Events that |
| | | | define a mirrored aggregate Shipment object, |
| | | | owned by the owner of the “UPS Ground” Item |
| | | | object, as illustrated in RI [2] of Item object |
| | | | dataset 495 in FIG. 37, identified by the |
| | | | “Transport Service” attribute value of the |
| | | | Shipment owned by the “Zebra” Domain object. |
| | | | The mirrored Shipment object identifier is set to |
| | | | the Shipment object identifier (i.e., “D384 . . . ”). |
| | | | The “Member” attribute value of the mirrored |
| | | | Shipment is set to the object identifier (i.e., |
| | | | “94DC . . . ”) of the “UPS” Vendor as Member |
| | | | object owned by the “Zebra” Domain object |
| | | | (i.e., RI [3] in Member object dataset 298B in |
| | | | FIG. 13) which is also the object identifier for a |
| | | | “Zebra” Customer as Member object owned by |
| | | | the “UPS” Domain object. |
| | | | A triggered action generates a row in a BEAM |
| | | | Payload that includes the IP Address of the |
| | | | “UPS” Domain object (Machine B), a |
| | | | Connection Type designating “HTTP”, a |
| | | | Resource Type designating an OEP, a Statement |
| | | | comprising the Events that define the mirrored |
| | | | aggregate “Shipment” object, and Credentials |
| | | | comprising the “Zebra” Domain object |
| | | | identifier. |
| 16.5 | A | Agent | The BEAM Payload is transported via the |
| | | | Connection Type to the Agent on Machine B. |
| 16.6 | B | Agent/SM/ | Upon validating the Credentials within the |
| | | OQP | BEAM Payload, the Events within the Statement |
| | | | of the BEAM Payload are submitted to the OEP |
| | | | for processing. |
| 16.7 | B | OEP | Triggered actions generate rows in Events that |
| | | | set attribute values of the mirrored aggregate |
| | | | Shipment object, including a new Identifier |
| | | | object, owned by the “UPS” Domain object, that |
| | | | defines the “Tracking Number” attribute value |
| | | | of a child Transaction Container object as |
| | | | illustrated in RI [1] through RI [5] in Table 32. |
| | | | The Events that define and update the mirrored |
| | | | aggregate Shipment object are stored within the |
| | | | SDS, as illustrated in RI [1] of Transaction |
| | | | object dataset 498H, RI [1] of Transaction Item |
| | | | object dataset 498I, and RI [0] of Transaction |
| | | | Container object dataset 498S in FIG. 37. |
| | | | A triggered action generates a row in a BEAM |
| | | | Payload that includes the IP Address of the |
| | | | “Zebra” Domain object (Machine A), a |
| | | | Connection Type designating “HTTP”, a |
| | | | Resource Type designating an OEP, a Statement |
| | | | comprising the Events that update the aggregate |
| | | | mirrored Shipment object, and Credentials |
| | | | comprising the Session ID. |
| | | | The BEAM Payload is submitted to the agent for |
| | | | processing. |
| 16.8 | B | Agent | A row in a BEAM Response Payload is |
| | | | generated that includes the BEAM Payload. |
| | | | The BEAM Response Payload is returned via |
| | | | the same connection to the Agent on Machine A. |
| 16.9 | A | Agent | The Events within a row in the BEAM Payload |
| | | | within the BEAM Response Payload are |
| | | | submitted to the OEP for processing. |
| 16.10 | A | OEP | Elements in a row in the submitted Events |
| | | | satisfy a condition defined in RI [8] in the |
| | | | Trigger object dataset illustrated in Table 22, |
| | | | which invokes the triggered action defined in RI |
| | | | [17] in the Trigger Action object dataset 596A |
| | | | illustrated in Table 23. |
| | | | The triggered action generates a row in Events, |
| | | | as illustrated in Table 33, that changes the |
| | | | Owner Domain of the Machine object related to |
| | | | the Item Serial object (i.e., RI [1] in Inventory |
| | | | object dataset 298V illustrated in FIG. 39) |
| | | | related to the Container object related to the |
| | | | Shipment Container object related to the |
| | | | Shipment object to the identifier (i.e., |
| | | | “BC8C . . . ”) of the member Domain object |
| | | | related to the Member object identified by the |
| | | | “Customer” attribute value of the Shipment |
| | | | object (i.e., index location [2][4] in Transaction |
| | | | object dataset 298H illustrated in FIG. 38). |
| | | | The Events that update attribute values of the |
| | | | aggregate Shipment object and Machine object |
| | | | are stored within the SDS. |
| | | | A triggered action submits Queries to an RVG |
| | | | for processing. |
| 16.11 | A | RVG | The Queries are submitted to the OQP for |
| | | | processing. |
| 16.12 | A | OQP | A Resultsets is generated from the submitted |
| | | | Queries that comprises attribute values of |
| | | | aggregate View objects and related objects |
| | | | within the SDS illustrated in the subsets of View |
| | | | object dataset 298A, View Entity object dataset |
| | | | 298L, View Element object dataset 298M, and |
| | | | View Condition object dataset 298N in FIG. 41. |
| | | | A second Queries dataset (i.e., Queries 257 in |
| | | | FIG. 42) is generated from the Resultsets that |
| | | | also includes Domain and Shipment object |
| | | | identifiers from the rows in Events that define |
| | | | the aggregate Shipment object. |
| | | | A second Resultsets (i.e., Resultsets 247 in FIG. |
| | | | 42) is generated from the second Queries dataset |
| | | | and comprises attribute values related to the |
| | | | aggregate Shipment object and identifiers and |
| | | | human-readable names for the corresponding |
| | | | Entity and Attribute objects which are retrieved |
| | | | from the SDS. |
| | | | The human-readable names are derived from |
| | | | attribute values of Term objects that are related |
| | | | to the “Language” attribute value of the “Zebra” |
| | | | Domain object”. |
| | | | The second Resultsets is returned to the RVG. |
| 16.13 | A | RVG | The Queries and Resultsets are processed to |
| | | | generate a Rendered View (i.e., Rendered View |
| | | | 276A) representing a shipping label, as |
| | | | illustrated in FIG. 43. |
| | | | A row in a BEAM Payload is generated that |
| | | | includes the MAC Address or IP Address |
| | | | associated with a printer (Machine E), a |
| | | | Connection Type designating “HTTP”, a |
| | | | Resource Type designating a Driver, a Statement |
| | | | comprising the Rendered View, and Credentials |
| | | | comprising the “Zebra” Domain object |
| | | | identifier. |
| | | | The BEAM Payload (i.e. Payload 246) is |
| | | | returned to the OEP (i.e. OEP 281) as illustrated |
| | | | in FIG. 44. |
| 16.14 | A | OEP | The Payload 246 is returned to the Agent as |
| | | | Payload 261, as illustrated in FIG. 44. |
| 16.15 | A | Agent | The BEAM Payload (i.e., Payload 261) is |
| | | | transported via the Connection Type to the |
| | | | Agent (i.e., Agent 710) on Machine E, as |
| | | | illustrated in FIG. 44. |
| 16.16 | E | Agent/SM/ | Upon validating the Credentials within the |
| | | OQP/OEP | BEAM Payload, Events that define a new |
| | | | Session object are stored within the SDS and the |
| | | | Session object identifier (Session ID) is included |
| | | | in a new row within a BEAM Response Payload |
| | | | dataset. |
| | | | The View (i.e., Rendered View 276A) in the |
| | | | statement in the row of the BEAM Payload is |
| | | | submitted to a Driver (i.e., Driver 786) for |
| | | | processing, as illustrated in FIG. 44. |
| 16.17 | E | Driver | A ZPL (Zebra Printer Language) script is |
| | | | generated from the View and submitted to the |
| | | | machine's printing engine to print a shipping |
| | | | label (e.g., document 786A) as illustrated in |
| | | | FIG. 44. |
| 16.18 | E | OEP | A triggered action generates a row in an Events |
| | | | dataset (i.e., RI [0] in the Events dataset |
| | | | illustrated in Table 34) that sets the “Print |
| | | | Status” attribute value of the Printer object to an |
| | | | enumeration designating “Printing”. |
| | | | Elements in the generated row in the Events |
| | | | satisfy a condition defined in RI [11] in the |
| | | | Trigger object dataset illustrated in Table 22, |
| | | | which invokes the triggered action defined in RI |
| | | | [20] in the Trigger Action object dataset |
| | | | illustrated in Table 23. |
| | | | The triggered action generates a row in an |
| | | | Events dataset (i.e., RI [1] in the Events dataset |
| | | | illustrated in Table 34) that sets the “Motor |
| | | | Power” attribute value of the Printer object to an |
| | | | enumeration designating “On”. |
| 16.19 | E | Driver | During the printing process, a change in the |
| | | | power to a port pin (i.e., Pin 1) within a |
| | | | microcontroller representing a sensor (i.e., |
| | | | Sensor 788) generates a value (i.e., Value 726) |
| | | | of “39” that is submitted to a Driver (i.e., Driver |
| | | | 786), as illustrated in FIG. 33. |
| | | | A row in an Events dataset is generated that |
| | | | comprises an identifier of the pin number (i.e., |
| | | | “1”) as the Object Attribute, and the sensor |
| | | | value (i.e., “39”) as the Attribute Value. |
| | | | A Statement comprising the Events dataset is |
| | | | submitted to the Agent for processing. |
| 16.20 | E | Agent | The Events within the Statement is submitted to |
| | | | the OEP for processing. |
| 16.21 | E | OEP/OQP | A Queries dataset is generated and processed to |
| | | | retrieve the Attribute object identifier (i.e., |
| | | | “71E1 . . . ”) which corresponds to an Item |
| | | | Attribute object (i.e., RI [0] in Item Attribute |
| | | | object dataset 798P in FIG. 33) with an |
| | | | “Element” attribute value that corresponds to the |
| | | | Object Attribute element (i.e., “1”) within the |
| | | | submitted Events dataset. |
| | | | A Queries dataset is generated and processed to |
| | | | retrieve the “Value” attribute value of the |
| | | | Attribute Value object (i.e., “3” at index location |
| | | | [2][8] in Attribute Value object dataset 293B in |
| | | | FIG. 29) that is related to the Item Attribute |
| | | | Value object that has a “Value” attribute value |
| | | | that corresponds to the Attribute Value element |
| | | | (i.e., “39”) within the submitted Events dataset. |
| | | | The Object Attribute element value (i.e., “1”) in |
| | | | the Events dataset is converted to the Attribute |
| | | | object identifier (i.e., “9E28 . . . ” identifying the |
| | | | “Print Status” attribute) and the Attribute Value |
| | | | element (i.e., “39”) is converted to the “Value” |
| | | | attribute value (i.e., “3” designating “Out of |
| | | | Paper”) as illustrated in RI [2] in Table 34. |
| | | | Elements in a row in the generated Events |
| | | | satisfy a condition defined in RI [12] in the |
| | | | Trigger object dataset illustrated in Table 22, |
| | | | which invokes the triggered actions defined in |
| | | | RI [21] and RI [22] in the Trigger Action object |
| | | | dataset illustrated in Table 23. |
| | | | One of the triggered actions generates rows in |
| | | | Events (as illustrated in RI [4] through RI [9] in |
| | | | Table 34) that define an aggregate Alert object, |
| | | | owned by the “Zebra” Domain object, from the |
| | | | row in Events that sets the “Print Status” |
| | | | attribute value of the Printer object representing |
| | | | Machine E. A Queries dataset is generated to |
| | | | retrieve current attribute values of the Printer |
| | | | object, and includes Entity and Attribute object |
| | | | identifiers from the rows in Events that define |
| | | | the Printer object. As illustrated in RI [6] in |
| | | | Table 34, the Subject attribute value of the Alert |
| | | | object is set to the Queries dataset. As |
| | | | illustrated in RI [9] in Table 34, the “Member” |
| | | | attribute value of the Alert Recipient object is set |
| | | | to the “Member” attribute value of the Session |
| | | | object (i.e., index location [0][4] in Session |
| | | | object dataset 798E illustrated in FIG. 40), |
| | | | which is currently set to the identifier (i.e., |
| | | | “C3A6 . . . ”) of the “JSmith” Sales Rep as |
| | | | Member object (i.e., RI [0] in Member object |
| | | | dataset 298B illustrated in FIG. 40). |
| | | | The Events that define the new Alert and set |
| | | | attribute values of the Printer object are stored |
| | | | within the SDS. |
| 16.22 | E | OEP | A triggered action generates a row in a BEAM |
| | | | Payload that includes the IP Address of the |
| | | | “Zebra” Domain object (Machine A), a |
| | | | Connection Type designating “HTTP”, a |
| | | | Resource Type designating an OEP, a Statement |
| | | | comprising compressed Events (as illustrated in |
| | | | Table 35) updating the Printer object (as |
| | | | illustrated in RI [0] through RI [3] in Table 34), |
| | | | and Credentials comprising the Session ID |
| | | | associated with the “Zebra” Domain object. |
| | | | A triggered action generates a row in a BEAM |
| | | | Payload for each Alert Recipient object related |
| | | | to the aggregate Alert object (e.g., RI [7] |
| | | | through RI [9] in Table 34). Each new row |
| | | | includes a Connection Type, Credentials |
| | | | comprising the “Zebra” Domain object |
| | | | identifier, a Resource Type designating an OEP, |
| | | | and a Statement comprising compressed Events |
| | | | (as illustrated in Table 36) that define a mirrored |
| | | | Alert object owned by the Member object |
| | | | identified by the “Member” attribute value of the |
| | | | Alert Recipient object. Each new row in the |
| | | | BEAM Payload includes the “IP Address” |
| | | | attribute value of the Domain object identified |
| | | | by the “Member Domain” attribute value of the |
| | | | Member object. In this case, a new row includes |
| | | | the IP Address of the “JSmith” Domain object |
| | | | (Machine D). |
| 16.23 | E | Agent | A row in the BEAM Payload is transported via |
| | | | the Connection Type to the Agent on Machine A. |
| | | | Another row in the BEAM Payload is |
| | | | transported via the Connection Type to the |
| | | | Agent on Machine D. |
| 16.24 | A | Agent/SM/ | Upon validating the Credentials within the |
| | | OQP | BEAM Payload, the Events within the Statement |
| | | | of the BEAM Payload are submitted to the OEP |
| | | | for processing. |
| 16.25 | A | OEP | The Events that update attribute values of the |
| | | | Printer object representing Machine E are stored |
| | | | within the SDS. |
| 16.26 | D | Agent/SM/ | Upon validating the Credentials within the |
| | | OQP | BEAM Payload received from Machine E, the |
| | | | Events within the Statement of the BEAM |
| | | | Payload are submitted to the OEP for |
| | | | processing. |
| 16.27 | D | OEP | The Events that define the mirrored Alert object |
| | | | are stored within the SDS as illustrated in RI [1] |
| | | | in Message object dataset 698T in FIG. 40. |
| | | | A triggered action submits the Events to the |
| | | | PAR for processing. |
| 16.28 | D | PAR/ | The events that define the mirrored Alert object |
| | | Agent | are processed with the portable application |
| | | | framework to generate a View, representing the |
| | | | current alert settings, that is submitted to a |
| | | | Driver for processing. |
| 16.29 | D | Driver | An HTML script is generated from the View and |
| | | | submitted to the machine's display engine to |
| | | | render a user interface (UI) |

Through an embodiment of the disclosed common data service, the demonstration in Sequence 1.1 through 1.4 in Table 24 illustrates how the booting of the Agent within a smartphone (Machine D) retrieves a portable application framework and portable application from within its SDS which are processed to render a user interface (UI) on the smartphone.

The demonstration in Sequence 2.1 through 2.13 in Table 24 illustrates how a user event on the smartphone (Machine D) generates and transports Queries to a top-level domain (TLD) operator's cloud server (Machine C) to retrieve a “.COM Domain Manager” portable application, based on the user's Member Service subscription, which is processed to render a user interface on the smartphone.

The demonstration in Sequence 3.1 through 3.10 in Table 24 illustrates, with the user interface, how the user on a smartphone (Machine D) creates an aggregate “Printer” Entity object, owned by the “.COM” Domain object, and how this object is transported as Events to the TLD operator's cloud server (Machine C) and stored within its SDS. It further illustrates how automation transports the new aggregate “Printer” Entity object as Events to the cloud server (Machine A) of the “Zebra” Customer as Member of “.COM” based on a subscription, and synchronizes the aggregate object within its SDS.

The demonstration in Sequence 4.1 through 4.7 in Table 24 illustrates, with the user interface, how the user on a smartphone (Machine D) creates an “ADCTech” Domain object, owned by the “.COM” Domain object, and how this object is transported as Events to the TLD operator's cloud server (Machine C). It further illustrates how automation creates an “ADCTech” Customer as Member object, owned by the “.COM” Domain object, and stores the new Domain object and Member object in its SDS. It further illustrates how automation creates a “.COM” Vendor as a mirrored Member object, owned by the “ADCTech” Domain object, and transports the new Domain object and mirrored Member object as Events to a multi-tenant cloud server (Machine B) that stores the Events in its SDS.

The demonstration in Sequence 5.1 through 5.9 in Table 24 illustrates how a user event on a smartphone (Machine D) generates and transports Queries to a printer manufacturer's cloud server (Machine A) to retrieve a “Zebra Business Manager” portable application, based on the user's Member Service subscription, which is processed to render a user interface on the smartphone.

The demonstration in Sequence 6.1 through 6.6 in Table 24 illustrates, with the user interface, how the user on the smartphone (Machine D) creates an aggregate “QL420 Printer” Item object, owned by the “Zebra” Domain object and related to the “Printer” Entity object, and how this aggregate Item object is transported as Events to the cloud server (Machine A) of “Zebra” and stored within its SDS. Further automation synchronizes the new Item object with legacy and remote data stores.

The demonstration in Sequence 7.1 through 7.4 in Table 24 illustrates, with the user interface, how the user on the smartphone (Machine D) creates an aggregate Stock Transfer object owned by the “Zebra” Domain object, and how this Stock Transfer object is transported as Events to the cloud server (Machine A) of “Zebra” and stored within its SDS. The demonstration further illustrates how automation on Machine A creates two serialized production units (i.e., Item Serial objects) of the “QL420 Printer” Item object, two corresponding Machine objects, two Identifier objects of the Machine objects, and two supplemental Printer objects of the base Machine objects. Further automation assigns one of the production units to a new Container object and assigns the other production unit to a new Asset object. The events that define all new objects are stored within the SDS of Machine A.

The demonstration in Sequence 8.1 through 8.15 in Table 24 illustrates how an un-provisioned production unit (Machine E) of the “QL420 Printer” Item object connects to the printer manufacturer's server (Machine A) to retrieve a portable application framework and events that define the printer's Machine object and related objects, based on the printer's MAC Address, and stores them in its SDS. The demonstration further illustrates how re-booting of the provisioned printer (Machine E) utilizes the new content in its SDS to compile a portable application to control the printer and render a user interface on its display.

The demonstration in Sequence 9.1 through 9.10 in Table 24 illustrates how a user event on the smartphone (Machine D) generates and transports Queries to the provisioned printer (Machine E) to retrieve its “Zebra QL420 Printer” portable application which is processed to render a user interface on the smartphone.

The demonstration in Sequence 10.1 through 10.8 in Table 24 illustrates, with the user interface, how a user event on the smartphone (Machine D) generates and transports Queries to the provisioned printer (Machine E) to retrieve the current state of the printer rendered on the user interface.

The demonstration in Sequence 11.1 through 11.6 in Table 24 illustrates, with the user interface, how the user on the smartphone (Machine D) can change the name and current state of the printer by transporting the state changes, as Events, to the printer (Machine E) for processing.

The demonstration in Sequence 12.1 through 12.9 in Table 24 illustrates how a user event on the smartphone (Machine D) generates and transports Queries to the multi-tenant cloud server (Machine B) to retrieve an “ADCTech Business Manager” portable application based on the user's Member Service subscription which is processed to render a user interface on the smartphone.

The demonstration in Sequence 13.1 through 13.11 in Table 24 illustrates, with the user interface, how the user on the smartphone (Machine D) creates a “Zebra” Vendor as Member object, owned by the “ADCTech” Domain object, and how this object is transported as Events to the multi-tenant cloud server (Machine B) of “ADCTech” and stored in its SDS. The demonstration further illustrates how automation on Machine B creates a mirrored “ADCTech” Customer as a Member object, owned by the “Zebra” Domain object and how this object is transported as Events to the cloud server (Machine A) of “Zebra” and stored in its SDS. The demonstration further illustrates how automation on Machine A approves the membership and creates a Member Service subscription that triggers the retrieval of Item objects owned by the “Zebra” Domain object, including the “QL420 Printer” Item object, stored in its SDS, and transports the objects as Events to the multi-tenant cloud server (Machine B) of “ADCTech” which synchronizes these objects within its SDS.

The demonstration in Sequence 14.1 through 14.12 in Table 24 illustrates, with the user interface, how the user on the smartphone (Machine D) creates an aggregate Purchase Order object owned by the “ADCTech” Domain object and related to the “Zebra” Vendor as a Member object and includes a Purchase Order Item object related to the “QL420 Printer” Item object. The demonstration further illustrates how this aggregate Purchase Order object is transported as Events to the multi-tenant cloud server (Machine B) of “ADCTech” and stored in its SDS. The demonstration further illustrates how automation on Machine B creates a mirrored aggregate Sales Order object owned by the “Zebra” Domain object and related to the “ADCTech” Customer as a Member object, and how this aggregate Sales Order object is transported as Events to the cloud server (Machine A) of “Zebra” and stored in its SDS. The demonstration further illustrates how the automation on Machine A creates a derived aggregate Shipment object related to the aggregate Sales Order object, a derived aggregate Stock Transfer object related to the aggregate Shipment object, and a derived aggregate Task object related to the aggregate Stock Transfer object, and stores these new aggregate objects within its SDS. The demonstration further illustrates how automation on Machine A then generates a mirrored Task object that is transported as Events to the smartphone (Machine D) of “JSmith” which is then stored within its SDS. The demonstration also illustrates how the mirrored Task object is processed on Machine D and rendered on its user interface.

The demonstration in Sequence 15.1 through 15.8 in Table 24 illustrates, with the user interface, how a user event on the smartphone (Machine D) retrieves Queries stored as an attribute value of the mirrored Task object and transports the Queries to a cloud server (Machine A) of “Zebra” to retrieve the current state of the Stock Transfer object related to the Task object which is rendered on the user interface.

The demonstration in Sequence 16.1 through 16.29 in Table 24 illustrates, with the user interface, how the user on the smartphone (Machine D) completes the Task by setting attribute values of the aggregate Stock Transfer object which are transported as Events to the cloud server (Machine A) of “Zebra” and stored in its SDS. The demonstration further illustrates how automation on Machine A generates and transports a mirrored Shipment object as Events to the multi-tenant cloud server (Machine B) of “UPS” which is stored in its SDS. The demonstration further illustrates how automation on Machine B generates and returns Shipment updates as Events to Machine A which are processed to update attribute values of Shipment and Machine objects within to its SDS and generate and transport a rendered view to the provisioned printer (Machine E) to print a Shipping label. The demonstration further illustrates how a sensor event on Machine E generates and transports an “Out of Paper” alert as Events to the smartphone (Machine D) of “JSmith” which is rendered on its user interface.

FIG. 37 illustrates the aggregate Purchase Order and Shipment objects, owned by the “ADCTech” Domain object and the “UPS” Domain object, respectively, within the SDS on a multi-tenant cloud server (Machine B) that were generated from the demonstration, according to at least one embodiment. The values of the “Transport Service” Attribute of the Shipment object and the “Item” Attribute of the Purchase Order Item object are set to identifiers of Item objects.

FIG. 38 and FIG. 39 illustrate the aggregate Sales Order, Shipment, and Stock Transfer objects, owned by the “Zebra” Domain object, within the SDS on Machine A that were generated from the demonstration, according to at least one embodiment. The values of “From Location” and “To Location” attributes of Transaction objects are set to identifiers of Location objects within a subset of Location object dataset 298G in FIG. 38. A Location object can represent, without limitation, a postal address or a stock location within the location representing a postal address.

FIG. 40 illustrates the aggregate Task and Alert objects, owned by the “Zebra” Domain object and the “JSmith” Domain object, within the SDS on Machine A, Machine D, and Machine E that were generated from the demonstration, according to at least one embodiment.

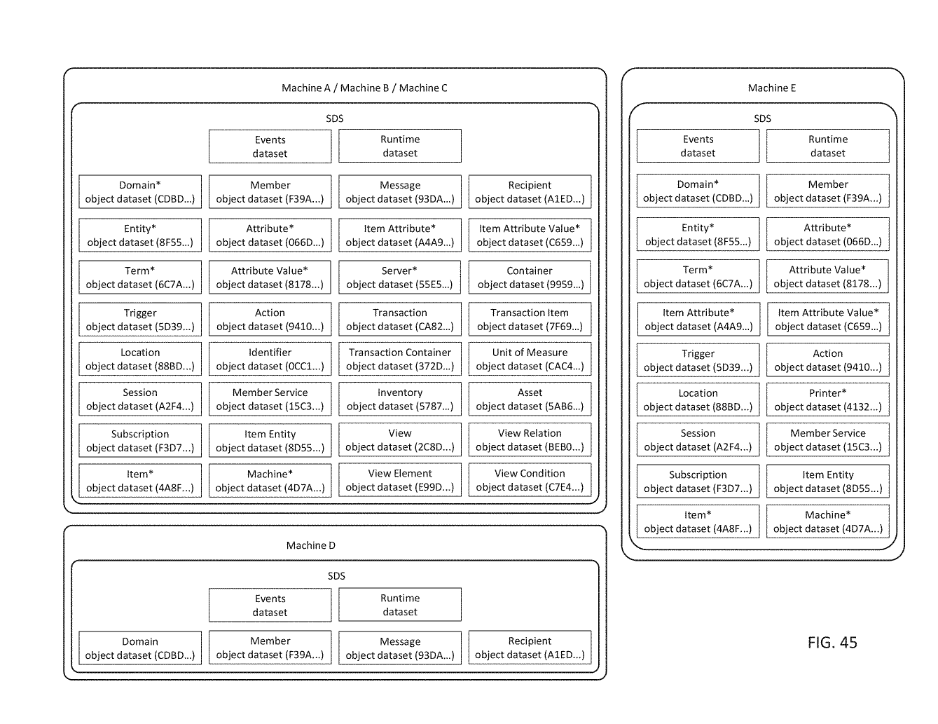

FIG. 45 illustrates the datasets within the SDS within Machines A, B, C, D, and E at the completion of the demonstration, according to at least one embodiment.

A subset of the Events generated in Sequence 6.4 in Table 24 is illustrated in Table 25.

TABLE 25
Events dataset

| | CI | | | | | | | |
|---|---|---|---|---|---|---|---|---|
| | 0 | 1 | 2 | 3 | 4 | 5 | 6 | |
| | Time | Event | Owner | Object | Object | Object | Attribute | 7 |
| RI | Stamp | Type | Domain | Entity | Identifier | Attribute | Value | UOM |
| 0 | 1/1/ . . . | 1 | 0914 . . . | 4A8F . . . | E02B . . . | | | |
| | | (Create) | (Zebra) | (Item) | | | | |
| 1 | 1/1/ . . . | 0 | 0914 . . . | 4A8F . . . | E02B . . . | 1342 . . . | QL420 | |
| | | (Set) | | | | (Name) | | |
| 2 | 1/1/ . . . | 0 | 0914 . . . | 4A8F . . . | E02B . . . | 5482 . . . | 4132 . . . | |
| | | | | | | (Entity) | (Printer) | |
| 3 | 1/1/ . . . | 0 | 0914 . . . | 4A8F . . . | E02B . . . | 5A44 | 95 | 0C6A . . . |
| | | | | | | (Unit | | (Euro) |
| | | | | | | Price) | | |
| 4 | 1/1/ . . . | 0 | 0914 . . . | 4A8F . . . | E02B . . . | 5A44 | 100 | 674E . . . |
| | | | | | | (Unit | | (US |
| | | | | | | Price) | | Dollar) |
| 5 | 1/1/ . . . | 1 | 0914 . . . | 0CC1 . . . | 6EDE . . . | | | |
| | | (Create) | | (Identifier) | | | | |
| 6 | 1/1/ . . . | 0 | 0914 . . . | 0CC1 . . . | 6EDE . . . | 47A5 . . . | 3545 . . . | |
| | | (Set) | | | | (Parent | (12345) | |
| | | | | | | Identifier) | | |
| 7 | 1/1/ . . . | 0 | 0914 . . . | 0CC1 . . . | 6EDE . . . | 4241 . . . | 4A8F . . . | |
| | | | | | | (Entity) | (Item) | |
| 8 | 1/1/ . . . | 0 | 0914 . . . | 0CC1 . . . | 6EDE . . . | 8E9C . . . | E02B . . . | |
| | | | | | | (Object) | (Zebra | |
| | | | | | | | QL420 | |
| | | | | | | | Printer) | |
| 9 | 1/1/ . . . | 0 | 0914 . . . | 0CC1 . . . | 6EDE . . . | 3FC3 . . . | 8YDD . . . | |
| | | | | | | (Attribute) | (GTIN) | |
| 10 | 1/1/ . . . | 0 | 0914 . . . | 0CC1 . . . | 6EDE . . . | 46CD . . . | 67890 | |
| | | | | | | (Value) | | |

A subset of the Events generated, transported, and processed in Sequence 7.4, 8.7, and 8.9 in Table 24 is illustrated in Table 26.

TABLE 26
Events dataset

| | CI | | | | | | | |
|---|---|---|---|---|---|---|---|---|
| | 0 | 1 | 2 | 3 | 4 | 5 | 6 | |
| | Time | Event | Owner | Object | Object | Object | Attribute | 7 |
| RI | Stamp | Type | Domain | Entity | Identifier | Attribute | Value | UOM |
| 0 | 1/1/ . . . | 1 | 0914 . . . | 0CC1 . . . | F257 . . . | | | |
| | | (Create) | (Zebra) | (Identifier) | | | | |
| 1 | 1/1/ . . . | 0 | 0914 . . . | 0CC1 . . . | F257 . . . | 47A5 . . . | 5D37 . . . | |
| | | (Set) | | | | (Parent | (C47D . . . ) | |
| | | | | | | Identifier) | | |
| 2 | 1/1/ . . . | 0 | 0914 . . . | 0CC1 . . . | F257 . . . | 4241 . . . | 4D7A . . . | |
| | | | | | | (Entity) | (Machine) | |
| 3 | 1/1/ . . . | 0 | 0914 . . . | 0CC1 . . . | F257 . . . | 8E9C . . . | 3A79 . . . | |
| | | | | | | (Object) | (Zebra | |
| | | | | | | | QL420 | |
| | | | | | | | Printer 1) | |
| 4 | 1/1/ . . . | 0 | 0914 . . . | 0CC1 . . . | F257 . . . | 3FC3 . . . | 0A54 . . . | |
| | | | | | | (Attribute) | (MAC | |
| | | | | | | | Address) | |
| 5 | 1/1/ . . . | 0 | 0914 . . . | 0CC1 . . . | F257 . . . | 46CD . . . | . . . 00:B0 | |
| | | | | | | (Value) | | |

A subset of the Events generated, transported, and processed in Sequence 11.1, 11.2, and 11.4 in Table 24 is illustrated in Table 27.

TABLE 27
Events dataset

| | CI | | | | | | | |
|---|---|---|---|---|---|---|---|---|
| | 0 | 1 | 2 | 3 | 4 | 5 | 6 | |
| | Time | Event | Owner | Object | Object | Object | Attribute | 7 |
| RI | Stamp | Type | Domain | Entity | Identifier | Attribute | Value | UOM |
| 0 | 1/1/ . . . | 0 | 0914 . . . | 4D7A . . . | 3879 . . . | 8C65 . . . | Machine E | |
| | | (Set) | (Zebra) | (Machine) | (Zebra | (Name) | | |
| | | | | | QL420 | | | |
| | | | | | Printer 1) | | | |
| 1 | 1/1/ . . . | 0 | 0914 . . . | 4132 . . . | 3879 . . . | CA31 . . . | 6 | 8213 . . . |
| | | | | (Printer) | | (Print | | (inches/ |
| | | | | | | Speed) | | second) |

A subset of the Events generated, transported, and processed in Sequence 11.4, 11.5, and 11.6 in Table 24 is illustrated in Table 28.

TABLE 28
Events dataset

| | CI | | | | | | | |
|---|---|---|---|---|---|---|---|---|
| | 0 | 1 | 2 | 3 | 4 | 5 | 6 | |
| | Time | Event | Owner | Object | Object | Object | Attribute | 7 |
| RI | Stamp | Type | Domain | Entity | Identifier | Attribute | Value | UOM |
| 0 | | 0 | | | | 4 | .06 | |

A subset of the Events generated, transported, and processed in Sequence 13.7, 13.9, and 13.11 in Table 24 is illustrated in Table 29.

TABLE 29
Events dataset

| | CI | | | | | | | |
|---|---|---|---|---|---|---|---|---|
| | 0 | 1 | 2 | 3 | 4 | 5 | 6 | |
| | Time | Event | Owner | Object | Object | Object | Attribute | 7 |
| RI | Stamp | Type | Domain | Entity | Identifier | Attribute | Value | UOM |
| 0 | 1/1/ . . . | 0 | 0914 . . . | F39A . . . | 9EFE . . . | DE5A . . . | 1 | |
| | | (Set) | (Zebra) | (Member) | | (Status) | (Approved) | |
| 1 | 1/1/ . . . | 1 | 0914 . . . | 15C3 . . . | 6829 . . . | DBC1 . . . | 9EFE . . . | |
| | | (Create) | | (Member | | (Member) | | |
| | | | | Service) | | | | |
| 2 | 1/1/ . . . | 0 | 0914 . . . | 15C3 . . . | 6829 . . . | F631 . . . | FCD5 . . . | |
| | | (Set) | | | | (Item) | (Business | |
| | | | | | | | Manager) | |

A subset of the Events generated, transported, and processed in Sequence 14.1, 14.2, and 14.4 in Table 24 is illustrated in Table 30.

TABLE 30
Events dataset

| | CI | | | | | | | |
|---|---|---|---|---|---|---|---|---|
| | 0 | 1 | 2 | 3 | 4 | 5 | 6 | |
| | Time | Event | Owner | Object | Object | Object | Attribute | 7 |
| RI | Stamp | Type | Domain | Entity | Identifier | Attribute | Value | UOM |
| 0 | 1/1/ . . . | 1 | BC8C . . . | 39D4 . . . | 6632 . . . | | | |
| | | (Create) | (ADCTech) | (Purchase | | | | |
| | | | | Order) | | | | |
| 1 | 1/1/ . . . | 0 | BC8C . . . | 39D4 . . . | 6632 . . . | E5E4 . . . | 9EFE . . . | |
| | | (Set) | | | | (Member) | (Zebra) | |
| 2 | 1/1/ . . . | 0 | BC8C . . . | 39D4 . . . | 6632 . . . | EC7E . . . | 9241 . . . | |
| | | | | | | (To | (3100 | |
| | | | | | | Location) | East . . . ) | |
| 3 | 1/1/ . . . | 1 | BC8C . . . | 15AD . . . | 5089 . . . | | | |
| | | (Create) | | (Purchase | | | | |
| | | | | Order | | | | |
| | | | | Item) | | | | |
| 4 | 1/1/ . . . | 0 | BC8C . . . | 15AD . . . | 5089 . . . | 9BC5 . . . | 6632 . . . | |
| | | (Set) | | | | (Trans.) | | |
| 5 | 1/1/ . . . | 0 | BC8C . . . | 15AD . . . | 5089 . . . | 562D . . . | 12345 | |
| | | | | | | (Item) | 67890 | |
| 6 | 1/1/ . . . | 0 | BC8C . . . | 15AD . . . | 5089 . . . | C40E . . . | 1 | C89C . . . |
| | | | | | | (Quantity) | | |
| 7 | 1/1/ . . . | 0 | BC8C . . . | 39D4 . . . | 6632 . . . | 82A0 . . . | 1 | |
| | | | | | | (Order | (Released) | |
| | | | | | | Status) | | |

A subset of the Events generated in Sequence 16.4 in Table 24 is illustrated in Table 31.

TABLE 31
Events dataset

| | CI | | | | | | | |
|---|---|---|---|---|---|---|---|---|
| | 0 | 1 | 2 | 3 | 4 | 5 | 6 | |
| | Time | Event | Owner | Object | Object | Object | Attribute | 7 |
| RI | Stamp | Type | Domain | Entity | Identifier | Attribute | Value | UOM |
| 0 | 1/1/ . . . | 0 | 0914 . . . | 9959 . . . | 78A7 . . . | 4352 . . . | 632C . . . | |
| | | (Set) | (Zebra) | (Container) | | (Location) | (2900 . . . ) | |

A subset of the Events generated, transported, and processed in Sequence 16.7, 16.8, and 16.10 in Table 24 is illustrated in Table 32.

TABLE 32
Events dataset

| | CI | | | | | | | |
|---|---|---|---|---|---|---|---|---|
| | 0 | 1 | 2 | 3 | 4 | 5 | 6 | |
| | Time | Event | Owner | Object | Object | Object | Attribute | 7 |
| RI | Stamp | Type | Domain | Entity | Identifier | Attribute | Value | UOM |
| 0 | 1/1/ . . . | 0 | F737 . . . | 4329 . . . | A913 . . . | 742B . . . | 9.55 | 674E . . . |
| | | (Set) | (UPS) | (Shipment | | (Freight | | (US |
| | | | | Container) | | Amount) | | Dollar) |
| 1 | 1/1/ . . . | 1 | F737 . . . | 0CC1 . . . | 68BB . . . | | | |
| | | (Create) | | (Identifier) | | | | |
| 2 | 1/1/ . . . | 0 | F737 . . . | 0CC1 . . . | 68BB . . . | 4241 . . . | 4329 . . . | |
| | | (Set) | | | | (Entity) | (Shipment | |
| | | | | | | | Container) | |
| 3 | 1/1/ . . . | 0 | F737 . . . | 0CC1 . . . | 68BB . . . | 8E9C . . . | A913 . . . | |
| | | | | | | (Object) | | |
| 4 | 1/1/ . . . | 0 | F737 . . . | 0CC1 . . . | 68BB . . . | 3FC3 . . . | FDEB . . . | |
| | | | | | | (Attribute) | (Tracking | |
| | | | | | | | Number) | |
| 5 | 1/1/ . . . | 0 | F737 . . . | 0CC1 . . . | 68BB . . . | 46CD . . . | 097654321 | |
| | | | | | | (Value) | | |
| 6 | 1/1/ . . . | 0 | F737 . . . | 9C12 . . . | D384 . . . | CE9C . . . | 13 | |
| | | | | (Shipment) | | (Shipment | (Pickup | |
| | | | | | | Status) | Sch.) | |

A subset of the Events generated in Sequence 16.10 in Table 24 is illustrated in Table 33.

TABLE 33
Events dataset

| | CI | | | | | | | |
|---|---|---|---|---|---|---|---|---|
| | 0 | 1 | 2 | 3 | 4 | 5 | 6 | |
| | Time | Event | Owner | Object | Object | Object | Attribute | 7 |
| RI | Stamp | Type | Domain | Entity | Identifier | Attribute | Value | UOM |

| | | | | | |
|---|---|---|---|---|---|
| 0 | 1/1/ . . . | 8 | 0914 . . . | 4D7A . . . | AD2D . . . |
| | | (Change | | (Machine) | |
| | | Owner) | | | |

A subset of the Events generated in Sequence 16.18 and 16.21 in Table 24 is illustrated in Table 34.

TABLE 34
Events dataset

| | CI | | | | | | | |
|---|---|---|---|---|---|---|---|---|
| | 0 | 1 | 2 | 3 | 4 | 5 | 6 | |
| | Time | Event | Owner | Object | Object | Object | Attribute | 7 |
| RI | Stamp | Type | Domain | Entity | Identifier | Attribute | Value | UOM |
| 0 | 1/1/ . . . | 0 | 0914 . . . | 4132 . . . | 3A79 . . . | 9E28 . . . | 4 | |
| | | (Set) | (Zebra) | (Printer) | | (Print Status) | (Printing) | |
| 1 | 1/1/ . . . | 0 | 0914 . . . | 4132 . . . | 3A79 . . . | 892B . . . | 1 | |
| | | | | | | (Motor | (On) | |
| | | | | | | Power) | | |
| 2 | 1/1/ . . . | 0 | 0914 . . . | 4132 . . . | 3A79 . . . | 9E28 . . . | 3 | |
| | | | | | | (Print Status) | (Paper | |
| | | | | | | | Out) | |
| 3 | 1/1/ . . . | 0 | 0914 . . . | 4132 . . . | 3A79 . . . | 892B . . . | 0 | |
| | | | | | | (Motor | (Off) | |
| | | | | | | Power) | | |
| 4 | 1/1/ . . . | 1 | 0914 . . . | 8E6E . . . | 29AB . . . | | | |
| | | (Create) | | (Alert) | | | | |
| 5 | 1/1/ . . . | 0 | 0914 . . . | 8E6E . . . | 29AB . . . | 3E19 . . . | 0914 . . . | |
| | | (Set) | | | | (Sender) | (Zebra) | |
| 6 | 1/1/ . . . | 0 | 0914 . . . | 8E6E . . . | 29AB . . . | 2C37 . . . | [Queries] | |
| | | | | | | (Subject) | | |
| 7 | 1/1/ . . . | 1 | 0914 . . . | AF4C . . . | 7986 . . . | | | |
| | | (Create) | | (Alert | | | | |
| | | | | Recipient) | | | | |
| 8 | 1/1/ . . . | 0 | 0914 . . . | AF4C . . . | 7986 . . . | B006 . . . | 29AB . . . | |
| | | (Set) | | | | (Message) | | |
| 9 | 1/1/ . . . | 0 | 0914 . . . | AF4C . . . | 7986 . . . | AC97 . . . | C3A6 . . . | |
| | | | | | | (Member) | (JSmith) | |

The compressed Events included in a row in the BEAM Payload generated in Sequence 16.22 in Table 24 is illustrated in Table 35.

TABLE 35
Events dataset

| | CI | | | | | | | |
|---|---|---|---|---|---|---|---|---|
| | 0 | 1 | 2 | 3 | 4 | 5 | 6 | |
| | Time | Event | Owner | Object | Object | Object | Attribute | 7 |
| RI | Stamp | Type | Domain | Entity | Identifier | Attribute | Value | UOM |
| 0 | 1/1/ . . . | 0 | 0914 . . . | 4132 . . . | 3A79 . . . | 9E28 . . . | 4 | |
| 1 | | | | | | 892B . . . | 1 | |
| 2 | | | | | | 9E28 . . . | 3 | |
| 3 | | | | | | 892B . . . | 0 | |
| 4 | | 1 | | 8E6E . . . | 29AB . . . | | | |
| 5 | | 0 | | | 29AB . . . | 3E19 . . . | 0914 . . . | |
| 6 | | | | | 29AB . . . | 2C37 . . . | [Queries] | |
| 7 | | 1 | | AF4C . . . | 7986 . . . | | | |
| 8 | | 0 | | | | B006 . . . | 29AB . . . | |
| 9 | | | | | | AC97 . . . | C3A6 . . . | |

The compressed Events included in another row in the BEAM Payload generated in Sequence 16.22 in Table 24 is illustrated in Table 36.

TABLE 36
Events dataset

| | CI | | | | | | | |
|---|---|---|---|---|---|---|---|---|
| | 0 | 1 | 2 | 3 | 4 | 5 | 6 | |
| | Time | Event | Owner | Object | Object | Object | Attribute | 7 |
| RI | Stamp | Type | Domain | Entity | Identifier | Attribute | Value | UOM |
| 0 | 1/1/ . . . | 1 | AFD8 . . . | 8E6E . . . | 29AB . . . | | | |
| 1 | | 0 | | | | 3E19 . . . | 0914 . . . | |
| 2 | | | | | | 2C37 . . . | [Queries] | |

### 13. Example Processing Device

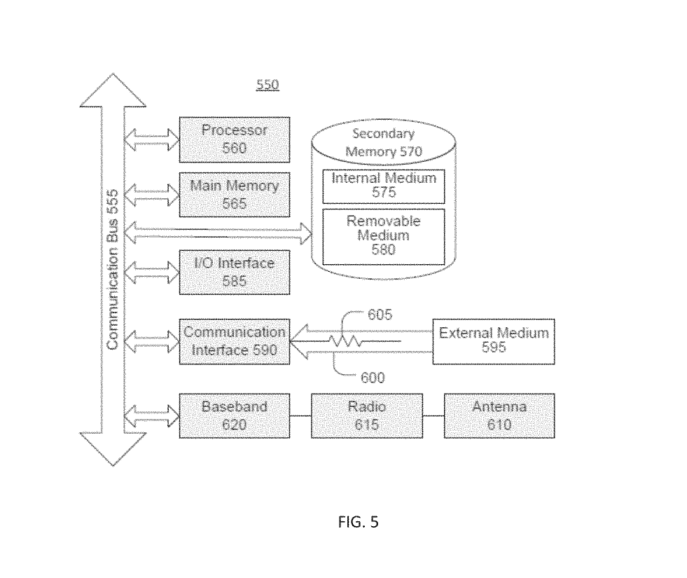

FIG. 5 is a block diagram illustrating an example wired or wireless system 550 that may be used in connection with various embodiments described herein. For example the system 550 may be used as or in conjunction with one or more of the mechanisms, processes, methods, or functions (e.g., to store and/or execute the application or one or more software modules of the application) described above, and may represent components of server(s), user system(s), and/or other devices described herein. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Perl, Visual Basic, .NET, and the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer-executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block-oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g., printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (i.e., computer programs or software, such as the disclosed application) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the disclosed embodiments as previously described.

In this description, the term “computer-readable medium” is used to refer to any non-transitory computer-readable storage media used to provide computer-executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer-readable mediums are means for providing executable code, programming instructions, and software to the system 550.

In an embodiment that is implemented using software, the software may be stored on a computer-readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 550 also includes optional wireless communication components that facilitate wireless communication over a voice and over a data network. The wireless communication components comprise an antenna system 610, a radio system 615, and a baseband system 620. In the system 550, radio frequency (RF) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the disclosed embodiments as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit, or step is for ease of description. Specific functions or steps can be moved from one module, block, or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA, or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such that the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method comprising using at least one hardware processor to:
create, update, and delete digital representations of objects while processing an events dataset by,
from a first resource on a first machine, accessing an events dataset, wherein the events dataset represents a two-dimensional structure having one or more rows and a plurality of columns, wherein each of the one or more rows represented in the events dataset comprises one of a plurality of event types, an identification of an entity, and an identification of an object, and wherein the identified object is a data representation of a unique instance of the identified entity, and
processing each of the one or more rows in the events dataset by
accessing the event type of the row, and
processing one or more elements in the row based on the event type of the row, wherein processing one or more elements in the row based on the event type of the row comprises, when the event type is a predetermined type, performing one or more of
creating a new object in an object dataset,
setting an attribute value of an object in an object dataset, wherein elements in the row of the events dataset comprise an identification of the attribute and the attribute value,
deleting an existing object in an object dataset, and,
for elements in the row that satisfy a defined condition, creating one or more additional rows in the events dataset for processing,
wherein an object dataset represents a two-dimensional structure having one or more rows and a plurality of columns,
wherein each of the one or more rows of an object dataset represents an object, as a unique instance of an entity, wherein an entity is a category of objects sharing the same attributes, and
wherein, for each of the one or more rows of an object dataset, each of one or more of the plurality of columns in the row represents an element of the object represented by that row and an attribute of the entity of which the object represented by that row is a unique instance, the plurality of columns collectively represent a current state of the object represented by that row, and at least one of the plurality of columns comprises an attribute value that represents an identification of the object represented by that row.

2. The method of claim 1, wherein each of the identification of an entity, the identification of an object, and the identification of the attribute comprises a universally unique identifier.

3. The method of claim 1,
wherein each object, represented by a row within the object dataset, represents an attribute of an entity,
wherein, for each of the one or more rows of the object dataset, one of the plurality of columns comprises an identification of an entity, and
wherein processing at least one of the one or more rows in the events dataset comprises creating an attribute object in the object dataset and setting one or more attribute values of the attribute object in the object dataset.

4. The method of claim 1,
wherein each object, represented by a row within the object dataset, represents a machine,
wherein an object, represented by a row within the object dataset, represents the first machine,
wherein processing at least one of the one or more rows in the events dataset comprises updating one or more attribute values of a machine object in the object dataset, and
wherein the one or more attribute values of the machine object represent the current state of the first machine.

5. The method of claim 1,
wherein each of the one or more rows, represented in the events dataset, additionally comprises an identification of a domain object,
wherein, for each of the one or more rows of the object dataset, one of the plurality of columns comprises an identification of a domain object,
wherein a domain object represents an administrative authority of each object represented by a row within the object dataset and comprises a representation of an Internet domain or an email address associated with an Internet domain, and
wherein one or more domain objects are maintained in an object dataset.

6. The method of claim 5, wherein each object, represented by a row within the object dataset, represents a domain object, and wherein processing at least one of the one or more rows in the events dataset comprises creating a domain object in the object dataset and setting one or more attribute values of the domain object in the object dataset.

7. The method of claim 5,
wherein each object, represented by a row within the object dataset, represents an email message exchanged between a first party and a second party,
wherein the identification of a domain object represents the first party,
wherein, for each of the one or more rows of the object dataset, one of the plurality of columns comprises an identification of a second domain object that represents the second party,
wherein processing at least one of the one or more rows in the events dataset comprises creating a first message object in the object dataset and setting attribute values of the first message object in the object dataset,
wherein processing each of the one or more rows in the events dataset comprises processing the one or more additional rows in the events dataset, created for elements satisfying the defined condition, by creating a second message object in the object dataset and setting attribute values of the second message object in the object dataset,
wherein setting attribute values of the second message object in the object dataset comprises
setting an attribute value of the second message object representing the identification of a domain object to an attribute value of the first message object representing the identification of a second domain object,
setting an attribute value of the second message object representing the identification of a second domain object to an attribute value of the first message object representing the identification of a domain object,
setting an attribute value of the second message object representing the identification of the second message object to an attribute value of the first message object representing the identification of the first message object, and
setting one or more additional attribute values of the second message object, representing attributes of the second message object, to one or more attribute values of the first message object, representing the same attributes of the first message object.

8. The method of claim 5,
wherein each object, represented by a row within the object dataset, represents a business transaction between a first party and a second party,
wherein the identification of a domain object represents the first party in the business transaction,
wherein, for each of the one or more rows of the object dataset, one of the plurality of columns comprises an identification of a second domain object that represents the second party in the business transaction,
wherein processing at least one of the one or more rows in the events dataset comprises creating a first order object in the object dataset and setting attribute values of the first order object in the object dataset,
wherein processing each of the one or more rows in the events dataset comprises processing the one or more additional rows in the events dataset, created for elements satisfying the defined condition, by creating a second order object in the object dataset and setting attribute values of the second order object in the object dataset,
wherein setting attribute values of the second order object in the object dataset comprises
setting an attribute value of the second order object representing the identification of a domain object to an attribute value of the first order object representing the identification of a second domain object,
setting an attribute value of the second order object representing the identification of a second domain object to an attribute value of the first order object representing the identification of a domain object,
setting an attribute value of the second order object representing the identification of the second order object to an attribute value of the first order object representing the identification of the first order object, and
setting one or more additional attribute values of the second order object,
representing attributes of the second order object, to one or more attribute values of the first order object, representing the same attributes of the first order object.

9. The method of claim 8,
wherein each object, represented by a row within a second object dataset comprising order item objects, represents an item that is traded between the first party and the second party of the business transaction,
wherein, for each of the one or more rows in the second object dataset, one of the plurality of columns comprises an identification of an order object and one of the plurality of columns comprises an identification of an item object,
wherein the order object represents the business transaction,
wherein the item object represents a manufacturer's model of an entity object,
wherein the entity object represents an entity that represents a type of machine,
wherein the item object represents a manufacturer's model of the type of machine, and
wherein processing at least one of the one or more rows in the events dataset comprises creating an order item object in the second object dataset and setting attribute values of the order item object in the second object dataset.

10. The method of claim 1, wherein the defined condition is represented by a trigger object within an object dataset, and wherein each the one or more defined actions is represented by an action object within an object dataset.

11. The method of claim 10, wherein processing at least one of the one or more rows in the events dataset comprises creating a trigger object within an object dataset and setting one or more attribute values of the trigger object in the object dataset.

12. The method of claim 10, wherein processing at least one of the one or more rows in the events dataset comprises creating an action object within an object dataset and setting one or more attribute values of the action object in the object dataset.

13. The method of claim 1,
wherein each of the one or more rows represented in the events dataset further comprises a timestamp,
wherein the timestamp represents when an event, represented by the row in the events dataset, occurred, and
wherein setting an attribute value of an object represented by a row within the object dataset comprises deriving the attribute value from an attribute value in the row of the events dataset that identifies the object and identifies the attribute and has a most recent timestamp.

14. The method of claim 1 wherein the attribute value within a first row of the events dataset comprises the identification of an object in a second row of the events dataset, and wherein the attribute value in the first row represents a relationship between the object identified in the first row and the object identified in the second row.

15. The method of claim 5,
wherein each object, represented by a row within the object dataset, represents a relationship between a first party and a second party,
wherein the identification of a domain object represents the first party,
wherein, for each of the one or more rows of the object dataset, one of the plurality of columns comprises an identification of a second domain object that represents the second party,
wherein processing at least one of the one or more rows in the events dataset comprises creating a first member object in the object dataset and setting attribute values of the first member object in the object dataset,
wherein processing each of the one or more rows in the events dataset comprises processing the one or more additional rows in the events dataset, created for elements satisfying the defined condition, by creating a second member object in the object dataset and setting attribute values of the second member object in the object dataset,
wherein setting attribute values of the second member object in the object dataset comprises
setting an attribute value of the second member object representing the identification of a domain object to an attribute value of the first member object representing the identification of a second domain object,
setting an attribute value of the second member object representing the identification of a second domain object to an attribute value of the first member object representing the identification of a domain object, and
setting an attribute value of the second member object representing the identification of the second member object to an attribute value of the first member object representing the identification of the first member object.

16. The method of claim 1, wherein accessing the events dataset comprises receiving a contents of the events dataset from a second machine, wherein the one or more rows of the events dataset represent a current state of one or more objects in a second object dataset on the second machine, and wherein processing each of the one or more rows in the events dataset by the first resource on the first machine synchronizes the current state of one or more objects in the object dataset on the first machine with the current state of the one or more objects in the second object dataset on the second machine.

17. The method of claim 16, wherein the second object dataset on the second machine is embodied in one or more port pin collections within one or more microcontrollers on the second machine, and wherein the current state of one or more objects in the object dataset on the first machine is embodied in one or more tables in one or more databases on the first machine.

18. The method of claim 4, wherein the object dataset is embodied in one or more port pin collections within one or more microcontrollers on the first machine.

19. A method comprising using at least one hardware processor to:
retrieve a current state of digital representations of objects while processing a queries dataset by,
from a first resource on a first machine, accessing a queries dataset, wherein the queries dataset comprises a two-dimensional structure having one or more rows and a plurality of columns, wherein each of the one or more rows represented in the queries dataset comprises one or more nested datasets, wherein each of the one or more nested datasets represents a two-dimensional data structure having one or more rows and a plurality of columns, wherein each of the one or more rows represented in the queries dataset comprises one of a plurality of query types, an identification of one or more related entities, an identification of one or more attributes of the one or more related entities, and one or more conditions that identify one or more objects, wherein each of the one or more objects is a data representation of a unique instance of one of the identified one or more related entities; and
processing each of the one or more rows in the queries dataset by
accessing the query type of the row, and
processing one or more elements in the row based on the query type of the row, wherein processing one or more elements in the row based on the query type of the row comprises, when the query type is a predetermined type, performing one or more of
generating a row in a results dataset, wherein the results dataset represents a two-dimensional structure having one or more rows and a plurality of columns, wherein the row in the results dataset comprises one or more attribute values of the one or more objects in one or more object datasets, and,
generating one or more rows in a view dataset, wherein a view dataset represents an encapsulated description of a fixed-layout flat document, including text elements and one or more of elements describing the appearance of the text elements when the document is displayed or printed, wherein the view dataset represents a two-dimensional structure having one or more rows and a plurality of columns, wherein a row in the view dataset comprises one or more attribute values of the one or more objects in one or more object datasets, wherein at least one of the one or more attribute values represents a text element and at least one of the one or more attribute values represents an element describing the appearance of the text element,
wherein each of the one or more object datasets represents a two-dimensional structure having one or more rows and a plurality of columns,
wherein each of the one or more rows of each of the one or more object datasets represents an object, as a unique instance of an entity, wherein an entity is a category of objects sharing the same attributes, and
wherein, for each of the one or more rows of each of the one or more object datasets, each of one or more of the plurality of columns in the row represents an element of the object represented by that row and an attribute of the entity of which the object represented by that row is a unique instance, the plurality of columns collectively represent a current state of the object represented by that row, and at least one of the plurality of columns comprises an attribute value that represents an identification of the object represented by that row.

20. The method of claim 19, wherein each of the identification of the one or more related entities, the identification of one or more attributes of the one or more related entities, and the identification of the object comprises a globally unique identifier.

21. The method of claim 19, wherein, for at least one of the one or more rows represented in the queries dataset, one of the one or more related entities comprises shared attributes of attribute objects, wherein an attribute object represents an attribute of one of the one or more related entities, and wherein a row generated in the results dataset when processing a row in the queries dataset comprises one or more attribute values of one or more attribute objects.

22. The method of claim 19, wherein, for at least one of the one or more rows represented in the queries dataset, one of the one or more related entities comprises shared attributes of machine objects, wherein a machine object represents a current state of a machine, and wherein a row generated in the results dataset from processing a row in the queries dataset comprises one or more attribute values of a machine object representing the current state of the first machine.

23. The method of claim 19, wherein a queries dataset is generated from a results dataset.

24. The method of claim 19,
wherein a row generated in the results dataset from processing a row in the queries dataset comprises one or more attribute values each comprising a queries dataset that can be processed.

25. The method of claim 19,
wherein a row generated in the results dataset from processing a row in the queries dataset comprises one or more attribute values each comprising a view dataset that can be processed.

26. The method of claim 19,
wherein accessing the queries dataset comprises receiving a contents of the queries dataset from a second machine.

27. The method of claim 19,
wherein accessing the queries dataset comprises receiving a contents of the queries dataset from a second resource on the first machine.
